(19) United States
(12) Patent Application Publication
(10) Pub. No.: US 2026/0005802 A1
(43) Pub. Date: Jan. 1, 2026

(54) Transport Block Size

(71) Applicant: Ofinno, LLC, Reston, VA (US)

(72) Inventors: Mohammad Ghadir Khoshkholgh Dashtaki, Reston, VA (US); Ali Cagatay Cirik, Chantilly, VA (US); Esmael Hejazi Dinan, McLean, VA (US); Hua Zhou, Vienna, VA (US); Hyoungsuk Jeon, Centreville, VA (US); Gautham Prasad, Herndon, VA (US); Muhammad Ali Kazmi, Reston, VA (US)

(21) Appl. No.: 19/249,230

(22) Filed: Jun. 25, 2025

Related U.S. Application Data
(60) Provisional application No. 63/665,808, filed on Jun. 28, 2024.

(51) Int. Cl. H04L 1/1812; H04L 1/1867; H04W 8/22

(52) U.S. Cl. CPC H04L 1/1812; H04L 1/1874; H04W 8/22

(57) ABSTRACT

A wireless device receives one or more configuration parameters comprising a parameter indicating that a retransmission of a transport block (TB) with a different TB size (TBS) than an initial transmission of the TB are new transmissions. The wireless device receives a first TB with a first TBS. The wireless device receives a retransmission of the first TB with a second TBS based on combining the first TB with the retransmission of the first TB in response to the first TBS being the same as the second TBS or decoding the retransmission of the first TB as a new transmission in response to the first TBS being different from the second TBS.

### CROSS-REFERENCE TO RELATED APPLICATIONS

This application claims the benefit of U.S. Provisional Application No. 63/665,808, filed Jun. 28, 2024, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates an aspect of an example embodiment according to the present disclosure.

FIG. 18 illustrates an aspect of an example embodiment according to the present disclosure.

FIG. 19A, FIG. 19B, and FIG. 19C illustrate aspects of example embodiments according to the present disclosure.

FIG. 20 illustrates an aspect of an example embodiment according to the present disclosure.

FIG. 21A and FIG. 21B illustrate aspects of example embodiments according to the present disclosure.

FIG. 22 illustrates an aspect of an example embodiment according to the present disclosure.

FIG. 23 illustrates an aspect of an example embodiment according to the present disclosure.

FIG. 24 illustrates an aspect of an example embodiment according to the present disclosure.

FIG. 25A and FIG. 25B illustrate aspects of example embodiments according to the present disclosure.

FIG. 26 illustrates an aspect of an example embodiment according to the present disclosure.

FIG. 27A and FIG. 27B illustrate aspects of example embodiments according to the present disclosure.

FIG. 28 illustrates an aspect of an example embodiment according to the present disclosure.

FIG. 29A and FIG. 29B illustrate aspects of example embodiments according to the present disclosure.

FIG. 30 illustrates an aspect of an example embodiment according to the present disclosure.

FIG. 31 illustrates an aspect of an example embodiment according to the present disclosure.

FIG. 32 illustrates an aspect of an example embodiment according to the present disclosure.

FIG. 33 illustrates an aspect of an example embodiment according to the present disclosure.

FIG. 34 illustrates an aspect of an example embodiment according to the present disclosure.

FIG. 35 illustrates an aspect of an example embodiment according to the present disclosure.

FIG. 36 illustrates an aspect of an example embodiment according to the present disclosure.

FIG. 37 illustrates an aspect of an example embodiment according to the present disclosure.

FIG. 38 illustrates an aspect of an example embodiment according to the present disclosure.

FIG. 39 illustrates an aspect of an example embodiment according to the present disclosure.

FIG. 40A and FIG. 40B illustrate aspects of example embodiments according to the present disclosure.

FIG. 41A and FIG. 41B illustrate aspects of example embodiments according to the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect or implement the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

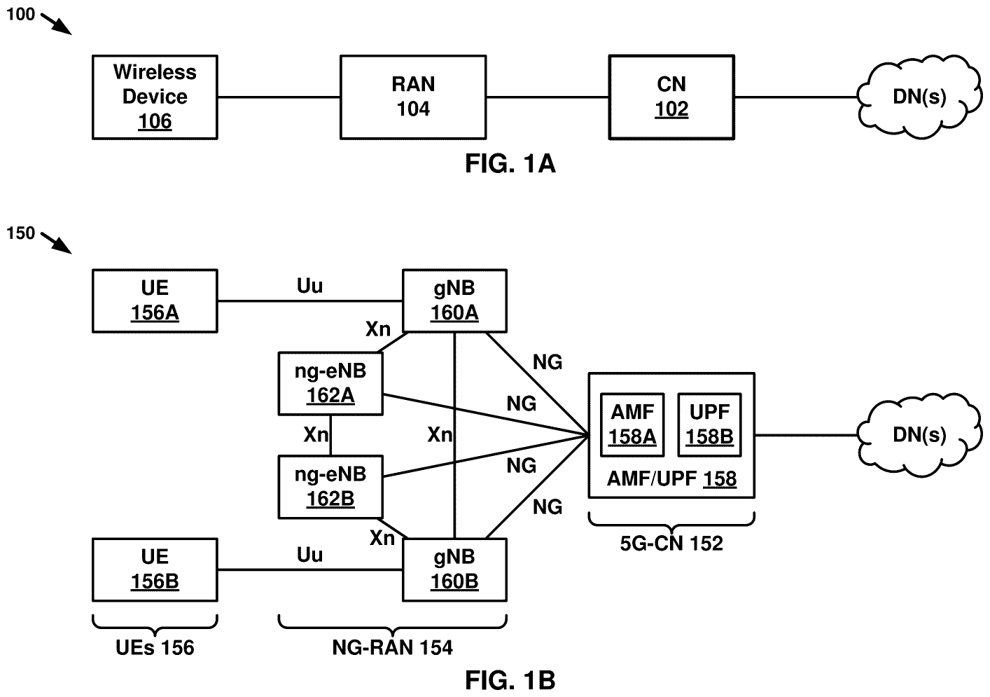

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

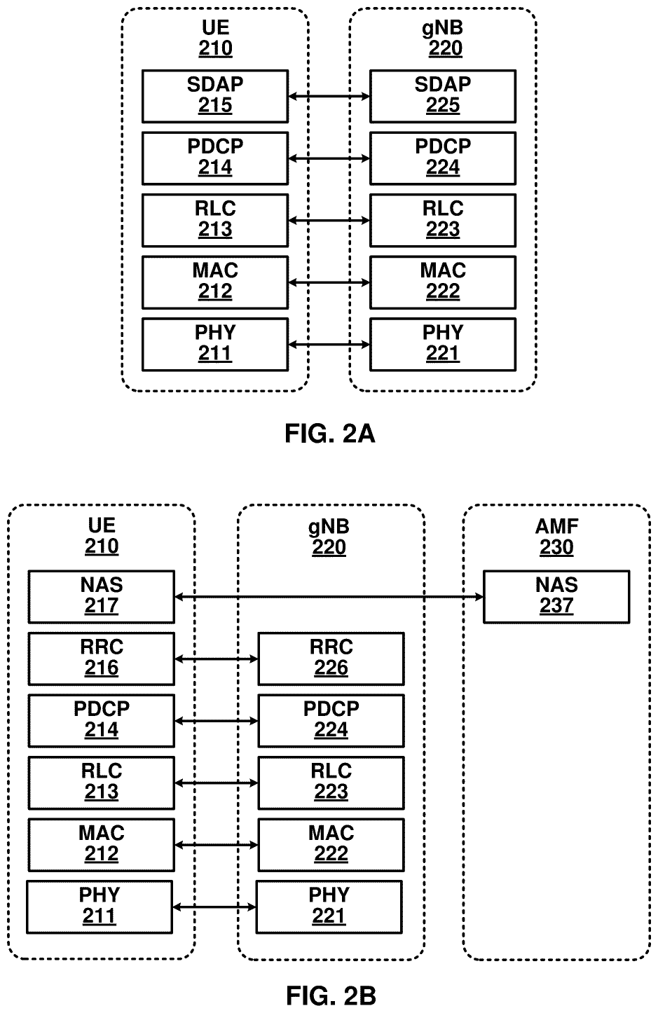

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

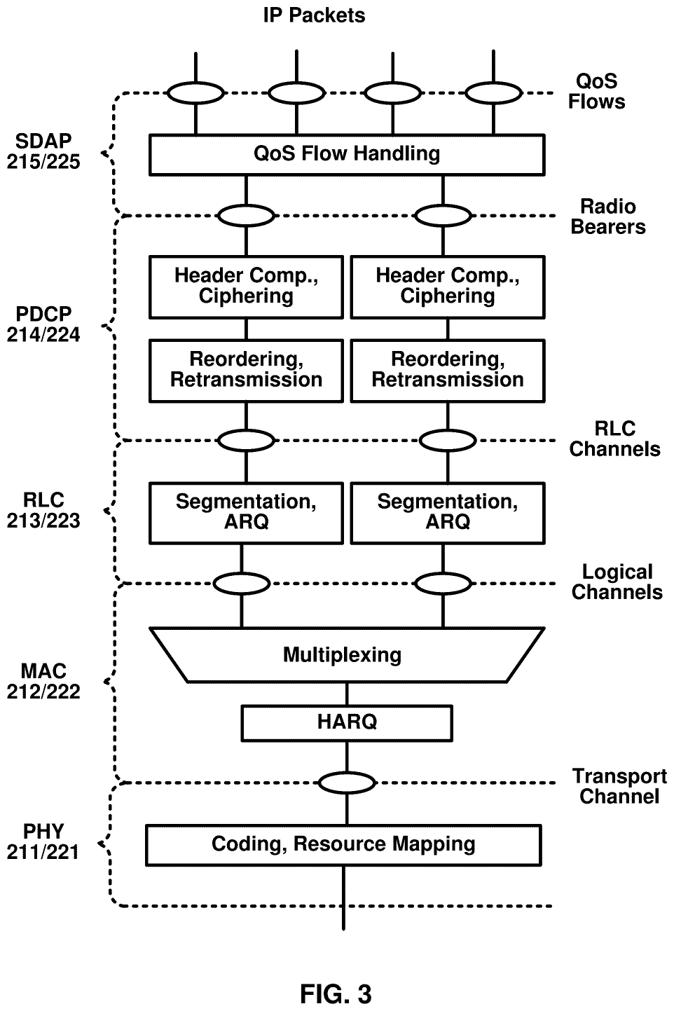

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

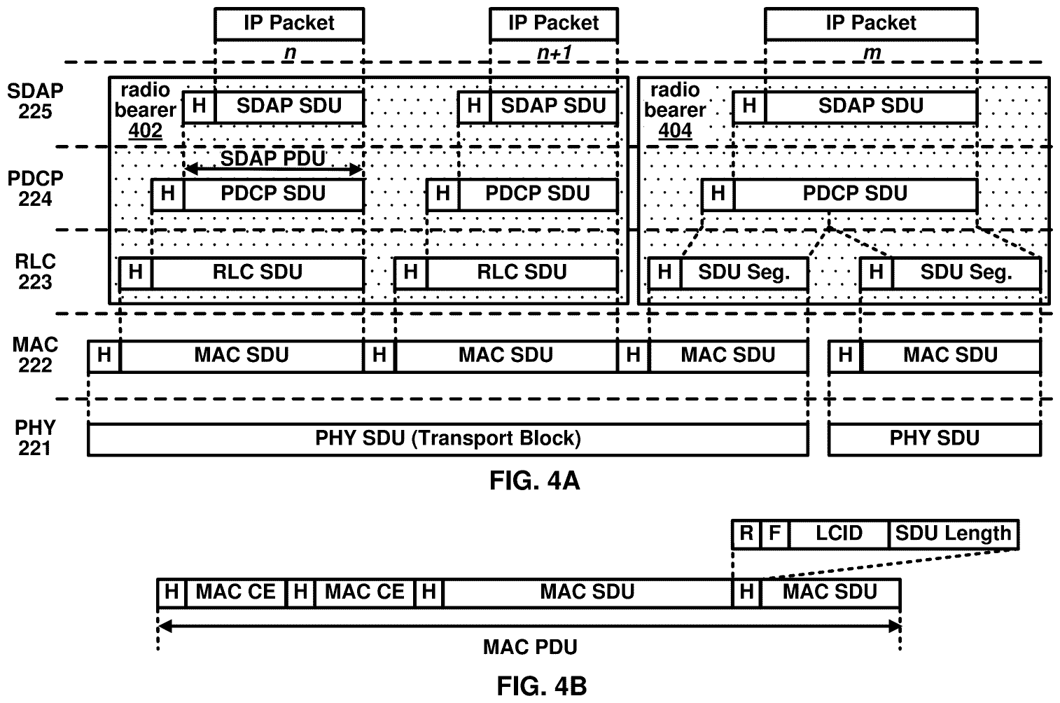

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

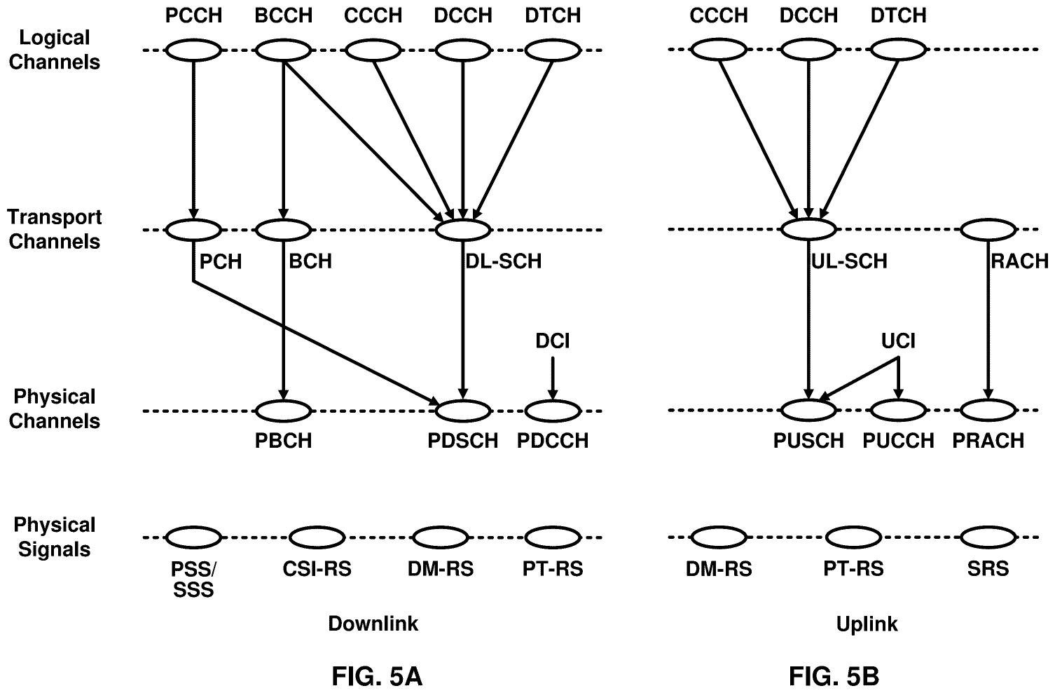

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

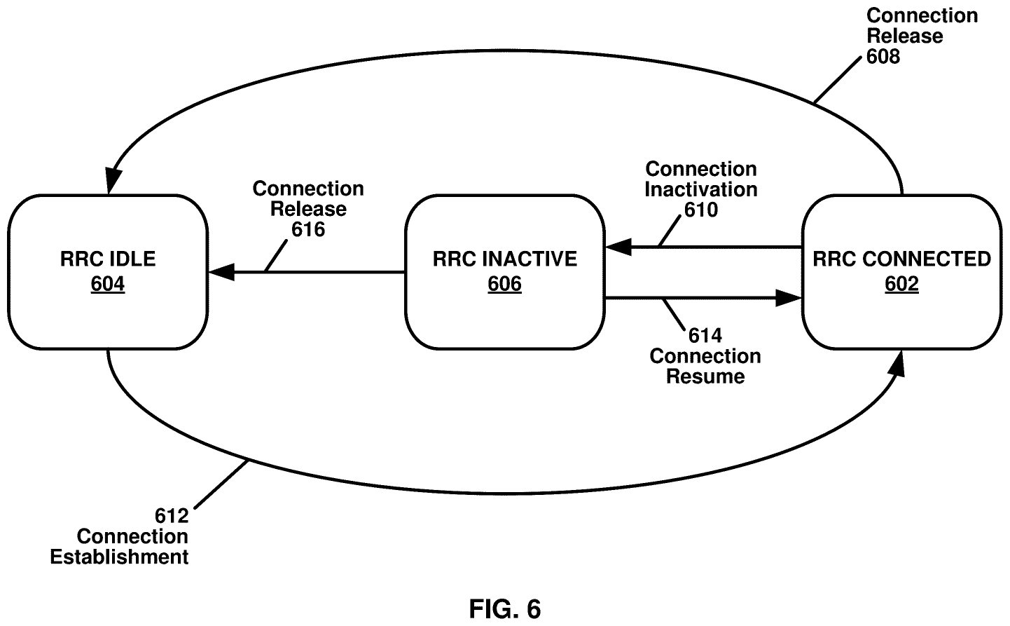

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

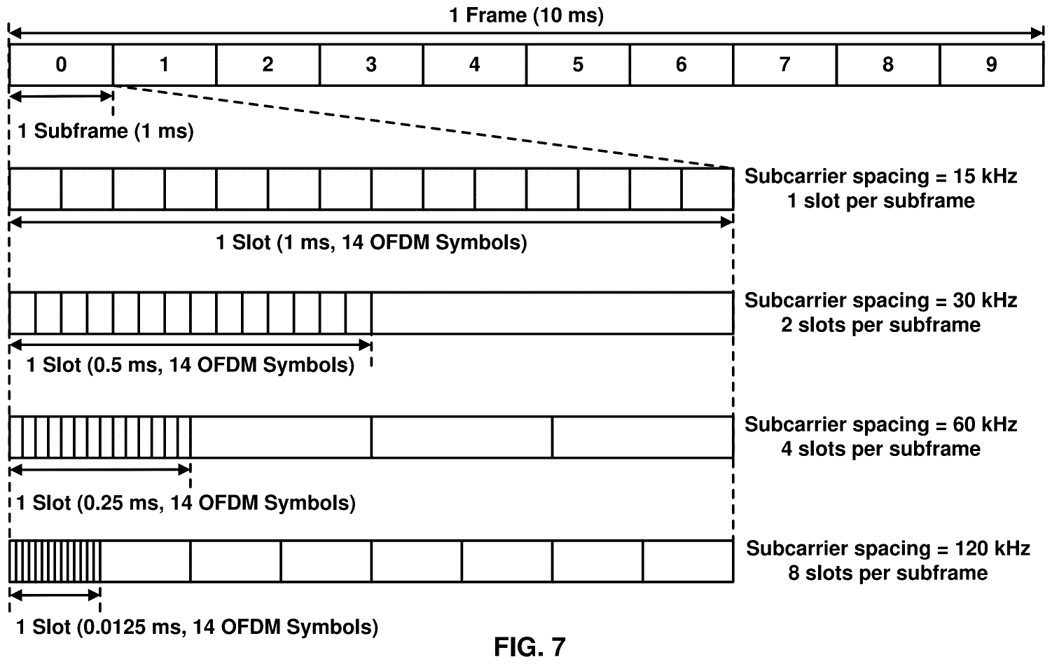

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

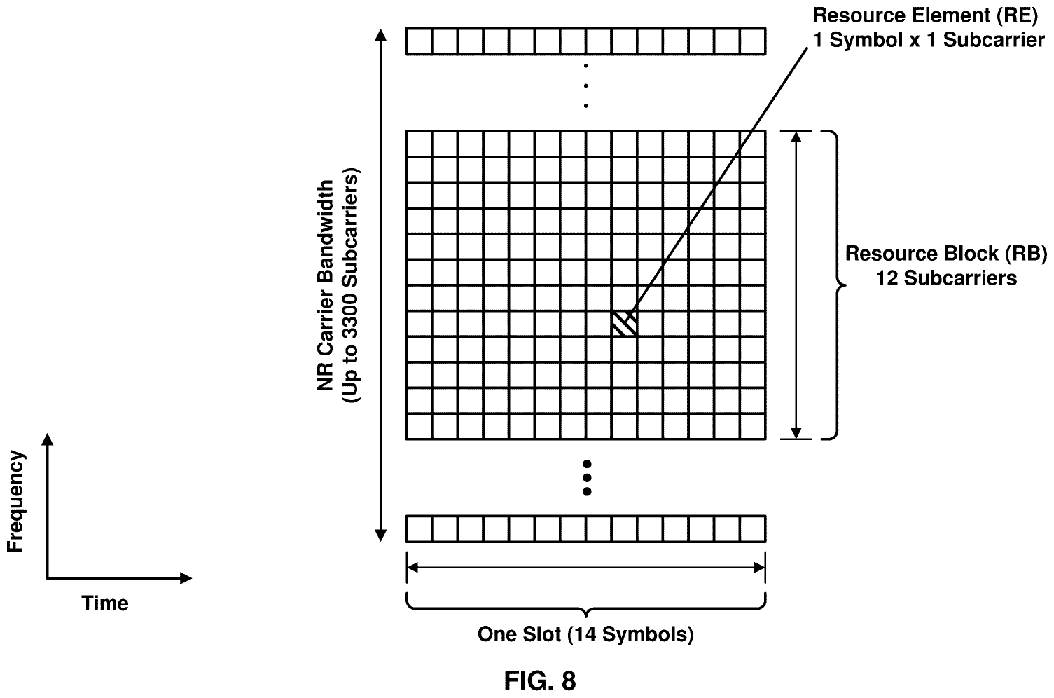

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

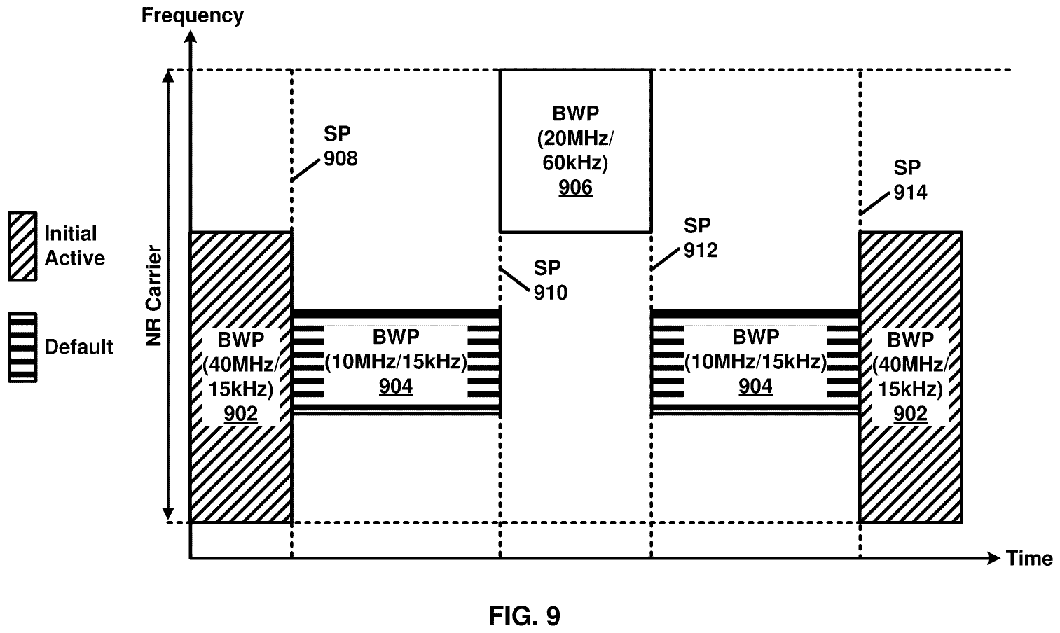

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

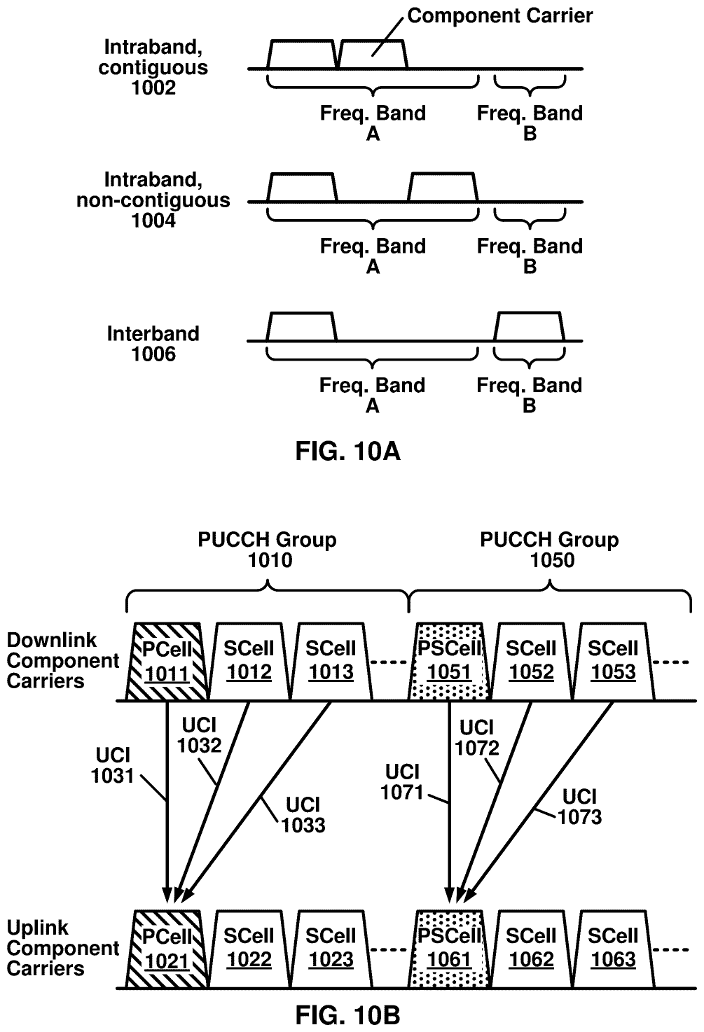

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

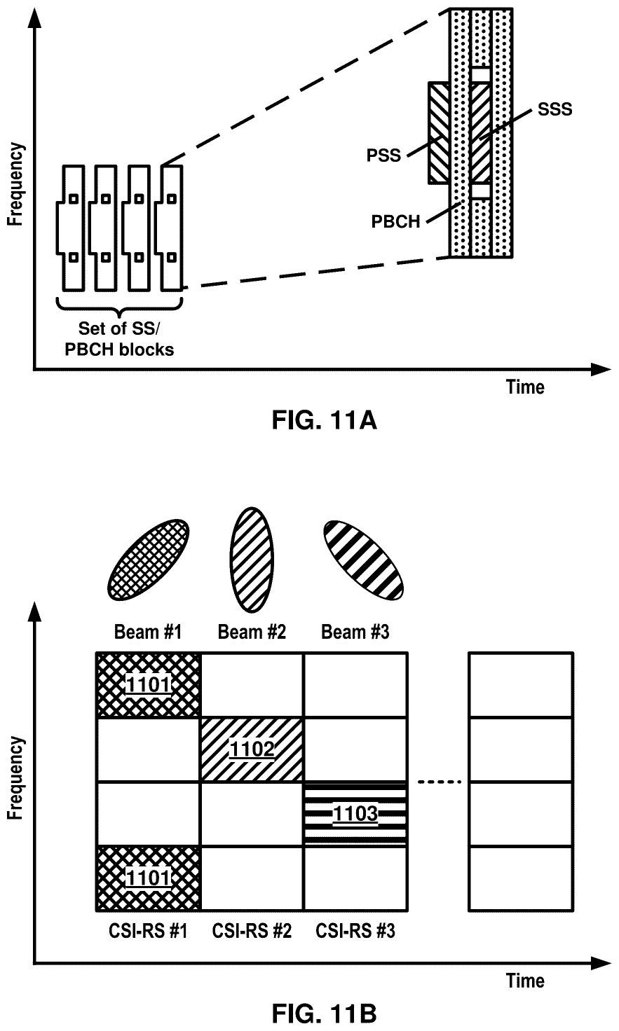

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g., a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g., maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter.

For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

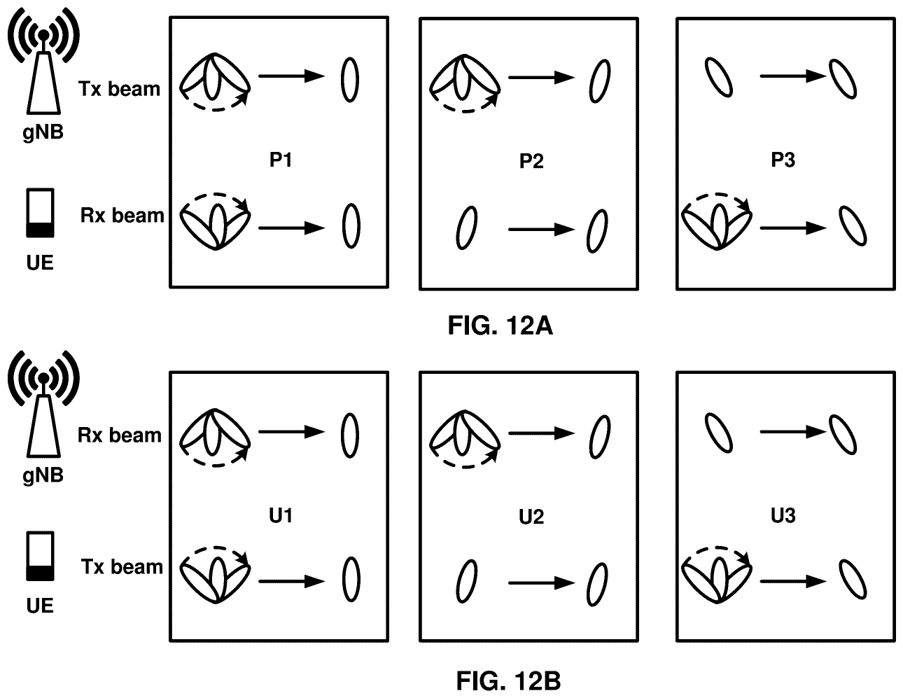

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

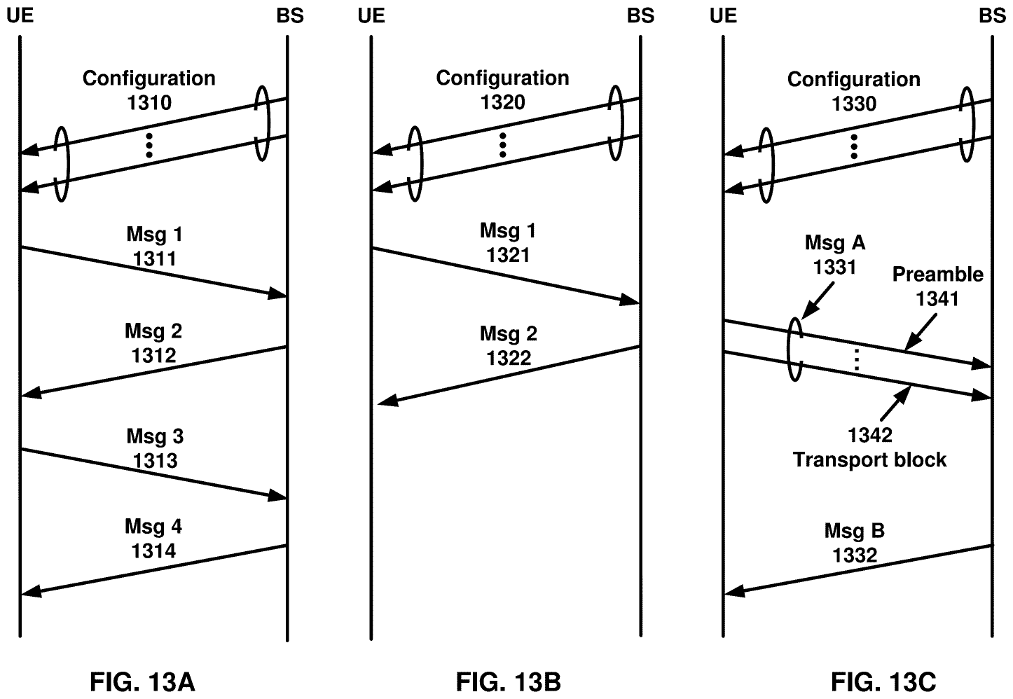

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 31313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-Response Window) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

$$RA\_RNTI = 1 + s\_id + 14 \times t\_id + 14 \times 80 \times f\_id + 14 \times 80 \times 8 \times ul\_carrier \_id ,$$

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 31313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 31313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

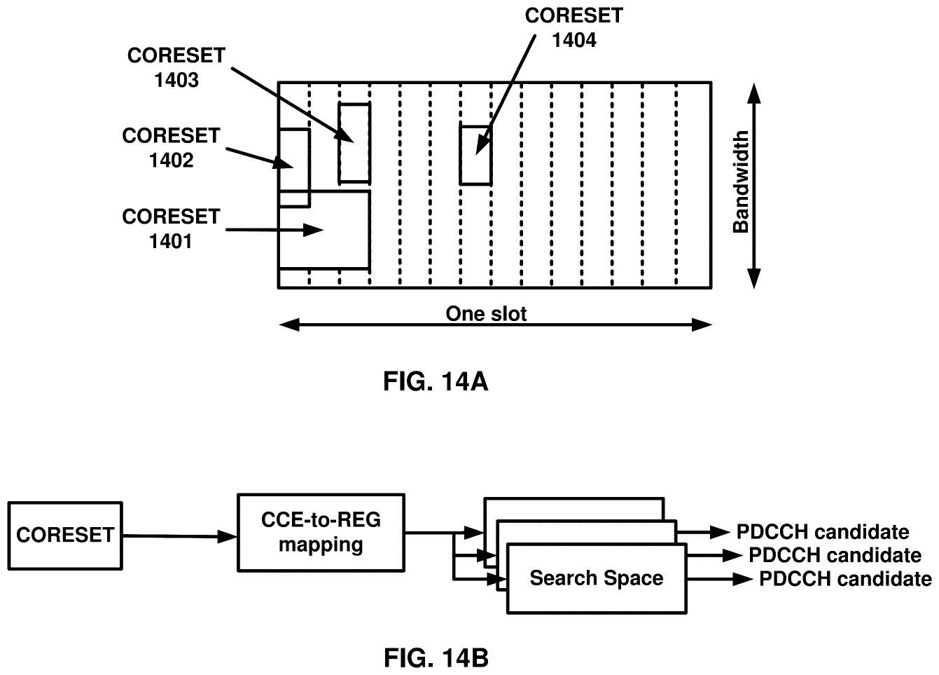

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g., a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

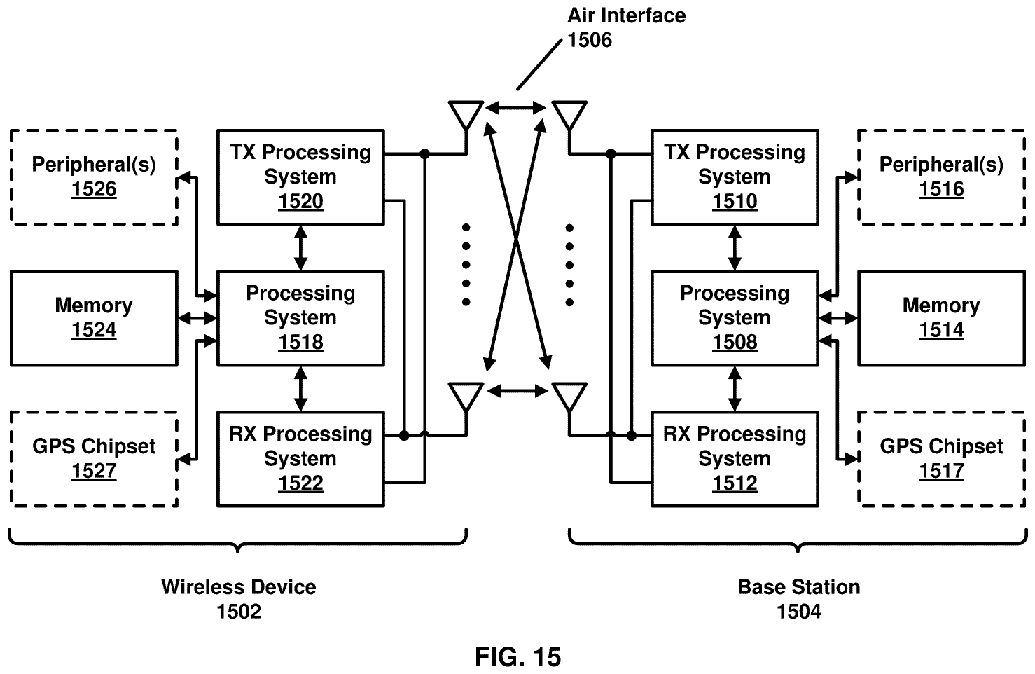

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

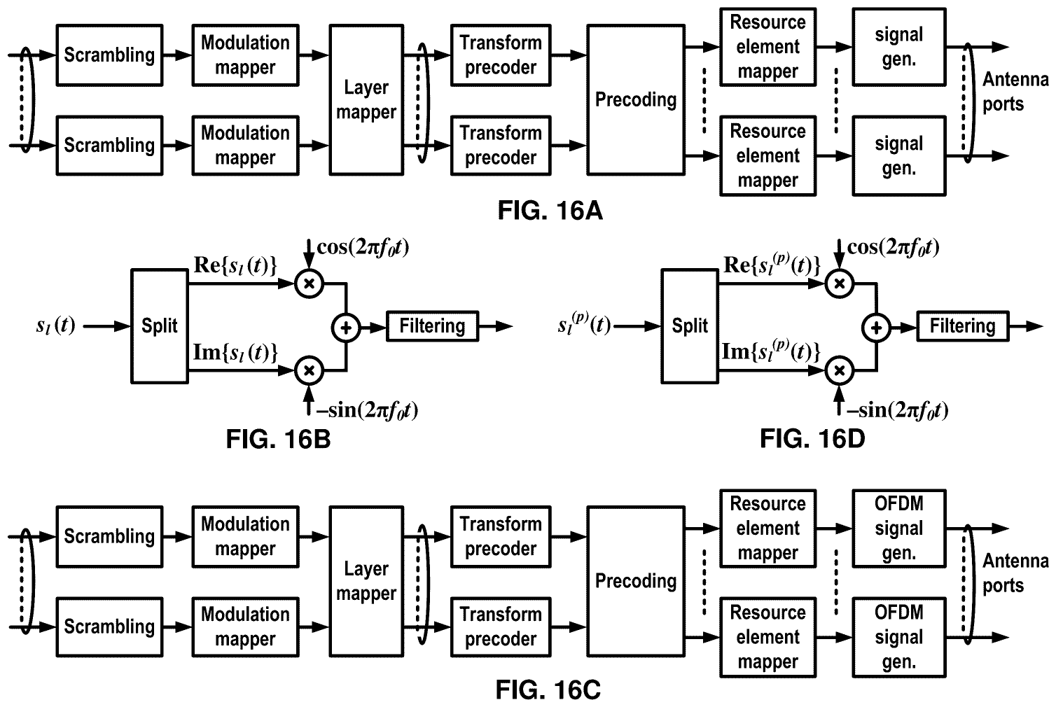

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g., RRC messages) comprising configuration parameters of a plurality of cells (e.g., primary cell, secondary cell). The wireless device may communicate with at least one base station (e.g., two or more base stations in dual connectivity) via the plurality of cells. The one or more messages (e.g., as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g., the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry (or expiration) of a random access response window timer, the time difference between two time stamps may be used. When a timer is restarted, a process for measurement of time window may be restarted. Other example implementations may be provided to restart a measurement of a time window.

A base station may transmit one or more MAC PDUs to a wireless device. In an example, a MAC PDU may be a bit string that is byte aligned (e.g., aligned to a multiple of eight bits) in length. In an example, bit strings may be represented by tables in which the most significant bit is the leftmost bit of the first line of the table, and the least significant bit is the rightmost bit on the last line of the table. More generally, the bit string may be read from left to right and then in the reading order of the lines. In an example, the bit order of a parameter field within a MAC PDU is represented with the first and most significant bit in the leftmost bit and the last and least significant bit in the rightmost bit.

In an example, a MAC SDU may be a bit string that is byte aligned (e.g., aligned to a multiple of eight bits) in length. In an example, a MAC SDU may be included in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. In an example, a MAC subheader may be placed immediately in front of a corresponding MAC SDU, MAC CE, or padding. A MAC entity may ignore a value of reserved bits in a DL MAC PDU.

In an example, a MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, or a combination thereof. The MAC SDU may be of variable size. A MAC subheader may correspond to a MAC SDU, a MAC CE, or padding.

In an example, when a MAC subheader corresponds to a MAC SDU, a variable-sized MAC CE, or padding, the MAC subheader may comprise: a Reserve field (R field) with a one bit length; an Format filed (F field) with a one-bit length; a Logical Channel Identifier (LCID) field with a multi-bit length; a Length field (L field) with a multi-bit length, indicating the length of the corresponding MAC SDU or variable-size MAC CE in bytes, or a combination thereof. In an example, F field may indicate the size of the L field.

In an example, a MAC entity of the base station may transmit one or more MAC CEs (e.g., MAC CE commands) to a MAC entity of a wireless device. The one or more MAC CEs may comprise at least one of: a SP ZP CSI-RS Resource Set Activation/Deactivation MAC CE, a PUCCH spatial relation Activation/Deactivation MAC CE, a SP SRS Activation/Deactivation MAC CE, a SP CSI reporting on PUCCH Activation/Deactivation MAC CE, a TCI State Indication for UE-specific PDCCH MAC CE, a TCI State Indication for UE-specific PDSCH MAC CE, an Aperiodic CSI Trigger State Subselection MAC CE, a SP CSI-RS/CSI-IM Resource Set Activation/Deactivation MAC CE, a UE contention resolution identity MAC CE, a timing advance command MAC CE, a DRX command MAC CE, a Long DRX command MAC CE, an SCell activation/deactivation MAC CE (1 Octet), an SCell activation/deactivation MAC CE (4 Octet), and/or a duplication activation/deactivation MAC CE. In an example, a MAC CE, such as a MAC CE transmitted by a MAC entity of the base station to a MAC entity of the wireless device, may have an LCID in the MAC subheader corresponding to the MAC CE. In an example, a first MAC CE may have a first LCID in the MAC subheader that may be different than the second LCID in the MAC subheader of a second MAC CE. For example, an LCID given by 111011 in a MAC subheader may indicate that the MAC CE associated with the MAC subheader is a Long DRX command MAC CE.

In an example, the MAC entity of the wireless device may transmit to the MAC entity of the base station one or more MAC CEs. The one or more MAC CEs may comprise at least one of: a short buffer status report (BSR) MAC CE, a long BSR MAC CE, a C-RNTI MAC CE, a configured grant confirmation MAC CE, a single entry PHR MAC CE, a multiple entry PHR MAC CE, a Short truncated BSR, and/or a Long truncated BSR. In an example, a MAC CE may have an LCID in the MAC subheader corresponding to the MAC CE. In an example, a first MAC CE may have a first LCID in the MAC subheader that may be different than the second LCID in the MAC subheader of a second MAC CE. For example, an LCID given by 111011 in a MAC subheader may indicate that a MAC CE associated with the MAC subheader is a short-truncated command MAC CE.

A base station may transmit one or more messages to a wireless device. The one or more messages may comprise the one or more MAC PDUs. The wireless device may receive at least one message of the one or more messages via/using one or more PDSCHs/TBs.

The one or more messages may comprise one or more RRC messages. The one or more RRC messages may comprise at least one RRC connection/establishment/configuration/setup message. The one or more RRC messages may comprise at least one RRC reconnection/reestablishment/reconfiguration message. The one or more RRC messages may comprise at least one RRC release message.

The one or more messages may comprise one or more MAC CEs.

The one or more messages may comprise one or more DCIs.

The one or more messages may comprise one or more downlink information for control.

The one or more messages may comprise one or more commands (e.g., control commands) for UL/DL communications. The one or more messages may comprise one or more configuration parameters. The one or more configuration parameters may correspond to one or more signals/channels. The one or more channels/signals may comprise one or more DL signals/channels, e.g., PDSCH/CSI-RS/PDCCH/SSB/WUS (wake up signal) or the like. The one or more channels/signals may comprise one or more UL signals/channels, e.g., PUSCH/SRS/PUCCH/WUS or the like.

The one or more messages may configure the wireless device with a carrier aggregation (CA) operation. In the carrier aggregation (operation), two or more component carriers (CCs) may be aggregated. Each carrier may be also referred to by/as a cell (e.g., serving cell). The cell may be a secondary cell (SCell). The wireless device may, using the technique of CA, simultaneously receive or transmit on one or more CCs, depending on capabilities of the wireless device. The one or more configuration parameters may configure/indicate the one or more CCs. In an example, the wireless device may support CA for contiguous CCs and/or for non-contiguous CCs. In some implementations, the one or more CCs may be organized into one or more cells. For example, the one or more CCs may be organized into a combination of a primary cell (PCell) and one or more secondary cells (SCells).

The one or more configuration parameters may, for example via one or more serving cell configuration parameters, comprise/configure/indicate the one or more cells (e.g., ServingCellConfigCommon, ServingCellConfigCommonSIB, and/or ServingCellConfig). The one or more cells may comprise one or more serving cell (e.g., the one or more Serving Cells). The one or more serving cell configuration parameters may be for configuring one or more cells (e.g., the one or more Serving Cells). For example, the one or more cells may comprise a master (or primary) cell group (MSG) and/or a secondary cell group (SCG).

In some cases, a cell of the one or more cells may be a primary secondary cell (PSCell), or a primary cell (PCell), or a secondary cell (SCell), or a special cell (SpCell). In some other cases, a cell of the one or more cells may belong to a first cell group corresponding to a primary TAG (pTAG) or a second cell group corresponding to a secondary TAG (sTAG). For example, the one or more configuration parameters may configure the wireless device for multi-cell communication and/or carrier aggregation.

In an example, the one or more cells may comprise a plurality of one or more SCells, depending on capabilities of the wireless device. When configured with CA, the base station and/or the wireless device may employ an activation/deactivation mechanism of an SCell to improve battery or power consumption of the wireless device. When the wireless device is configured with the one or more SCells, the base station may activate or deactivate (e.g., via MAC CE or DCI) at least one of the one or more SCells. Upon configuration of an SCell (e.g., via the one or more serving cell configuration parameters), the SCell may be deactivated unless the SCell state associated with the SCell is set to “activated” or “dormant”, via a DCI or MAC CE. The wireless device may activate/deactivate the SCell in response to receiving an SCell Activation/Deactivation MAC CE.

For example, the base station may configure (e.g., via the one or more RRC messages/configuration parameters) the wireless device with uplink (UL) bandwidth parts (BWPs) and downlink (DL) BWPs to enable bandwidth adaptation (BA) on a PCell. If carrier aggregation (CA) is configured, the base station may further configure the wireless device with at least one DL BWP (i.e., there may be no UL BWP in the UL) to enable BA on an SCell. For the PCell, an initial active BWP may be a first BWP used for initial access. In paired spectrum (e.g., FDD), the base station and/or the wireless device may independently switch a DL BWP and an UL BWP. In unpaired spectrum (e.g., TDD), the base station and/or the wireless device may simultaneously switch the DL BWP and the UL BWP.

In an example, the one or more configuration parameters may comprise configuration parameters of one or more BWPs (e.g., one or more BWP configuration parameters). The one or more BWP configuration parameters may comprise parameters of the cell and one or more BWPs associated with the cell. Among the one or more BWPs, at least one BWP may be configured as the first active BWP (e.g., BWP 1), one BWP as the default BWP (e.g., BWP 0). In some cases, the wireless device may receive a command (e.g., an RRC message, a MAC CE or a DCI) to activate the cell at a slot. In some other cases (e.g., when the cell is a PCell), the wireless device may activate the cell (e.g., PCell) once the wireless device receives the command (e.g., the RRC message) comprising configuration parameters of the PCell. The wireless device may start monitoring a PDCCH (e.g., monitoring PDCCH candidates) on BWP 1, e.g., in response to activating the cell.

A wireless device may start (or restart) a BWP inactivity timer (e.g., bwp-InactivityTimer) at an m-th slot in response to receiving a DCI indicating DL assignment on BWP 1. The wireless device may switch back to the default BWP (e.g., BWP 0) as an active BWP when the BWP inactivity timer expires, at s-th slot. The wireless device may deactivate the cell and/or stop the BWP inactivity timer when the sCellDeactivationTimer expires (e.g., if the cell is a SCell). In response to the cell being a PCell, the wireless device may not deactivate the cell and may not apply the sCellDeactivationTimer on the PCell.

A MAC entity may apply normal operations on an active (or activated) BWP for an activated serving cell (e.g., the cell). For example, on the activated BWP and via the cell the wireless device may perform at least one of the following: transmitting on UL-SCH (PUSCH transmission); transmitting on RACH (preamble transmission); monitoring a PDCCH; transmitting PUCCH; receiving DL-SCH (PDSCH reception); and/or (re-) initializing configured uplink grants of configured grant Type 1 or Type 2 according to a stored configuration. The one or more configuration parameters may configure/provide configured uplink grants of configured grant Type 1 or Type 2.

On an inactive (or deactivated or dormant) BWP of the cell (or for each activated serving cell configured with a BWP), the wireless device may perform at least one of the following: not transmit on UL-SCH; not transmit on RACH; not monitor a PDCCH; not transmit PUCCH; not transmit SRS, not receive DL-SCH; clear any configured downlink assignment and configured uplink grant of configured grant Type 2; and/or suspend any configured uplink grant of configured Type 1.

A DCI addressed to an RNTI may comprise a CRC of the DCI being scrambled with the RNTI. The wireless device may monitor PDCCH addressed to (or for) the RNTI for detecting the DCI. For example, the PDCCH may carry (or be with) the DCI. In an example, the PDCCH may not carry the DCI.

The one or more configuration parameters may comprise one or more PDCCH configuration parameters for configure/indicate a set of PDCCH candidates for the wireless device to monitor via/in terms of one or more search space sets. For example, the one or more PDCCH configuration parameters may configure/indicate the one or more search space sets. The one or more PDCCH configuration parameters may comprise at least PDCCH-ConfigCommon and/or pdcch-ConfigSIB1 and/or PDCCH-Config.

A search space set of the one or more search space sets may comprise a common search space (CSS) set, or a UE-specific search space (USS) set. The wireless device may monitor one or more PDCCH candidates (of the set of PDCCH candidates) in one or more of the search space sets.

A search space set may be a Type0-PDCCH CSS set configured by the pdcch-ConfigSIB1 (e.g., in MIB) or by searchSpaceSIB1 in the PDCCH-ConfigCommon or by searchSpaceZero in the PDCCH-ConfigCommon.

A search space set may be a Type0A-PDCCH CSS set configured by searchSpaceOtherSystemInformation in the PDCCH-ConfigCommon for a DCI format with CRC scrambled by the SI-RNTI on the primary cell of the MCG.

A search space set may be a Type1-PDCCH CSS set configured by ra-SearchSpace in the PDCCH-ConfigCommon for a DCI format with CRC scrambled by a RA-RNTI, a MSGB-RNTI, or a TC-RNTI on the primary cell.

A search space set may be a Type2-PDCCH CSS set configured by pagingSearchSpace in the PDCCH-ConfigCommon for a DCI format with CRC scrambled by a P-RNTI on the primary cell of the MCG.

A search space set may be a Type3-PDCCH CSS set configured by SearchSpace in the PDCCH-Config with searchSpaceType=common for DCI formats with CRC scrambled by at least one RNTI. The at least one RNTI may comprise one of the following: an INT-RNTI, an SFI-RNTI, a TPC-PUSCH-RNTI, a TPC-PUCCH-RNTI, a TPC-SRS-RNTI, a CI-RNTI, or a power saving RNTI (PS-RNTI) and, only for the primary cell, a C-RNTI, an MCS-C-RNTI, or a CS-RNTI(s).

A search space set may be a USS set configured by SearchSpace in the PDCCH-Config with searchSpaceType=ue-Specific for DCI formats with CRC scrambled by the C-RNTI, the MCS-C-RNTI, a SP-CSI-RNTI, the CS-RNTI(s), a SL-RNTI, a SL-CS-RNTI, or a SL-L-CS-RNTI.

The wireless device may monitor the one or more PDCCH candidates in one or more CORESETs for detecting one or more DCIs. The one or more PDCCH configuration parameters may configure/indicate the one or more CORESETs. Monitoring the one or more PDCCH candidates may comprise decoding at least one PDCCH candidate of the one or more PDCCH candidates according to the monitored DCI formats. For example, monitoring the one or more PDCCH candidates may comprise decoding (e.g., blind decoding) a DCI content of the at least one PDCCH candidate via possible (or configured) PDCCH location(s), possible (or configured) PDCCH format(s), e.g., number of CCEs, number of PDCCH candidates in CSS set(s), and/or number of PDCCH candidates in the USS(s), and/or possible (or configured) DCI format(s).

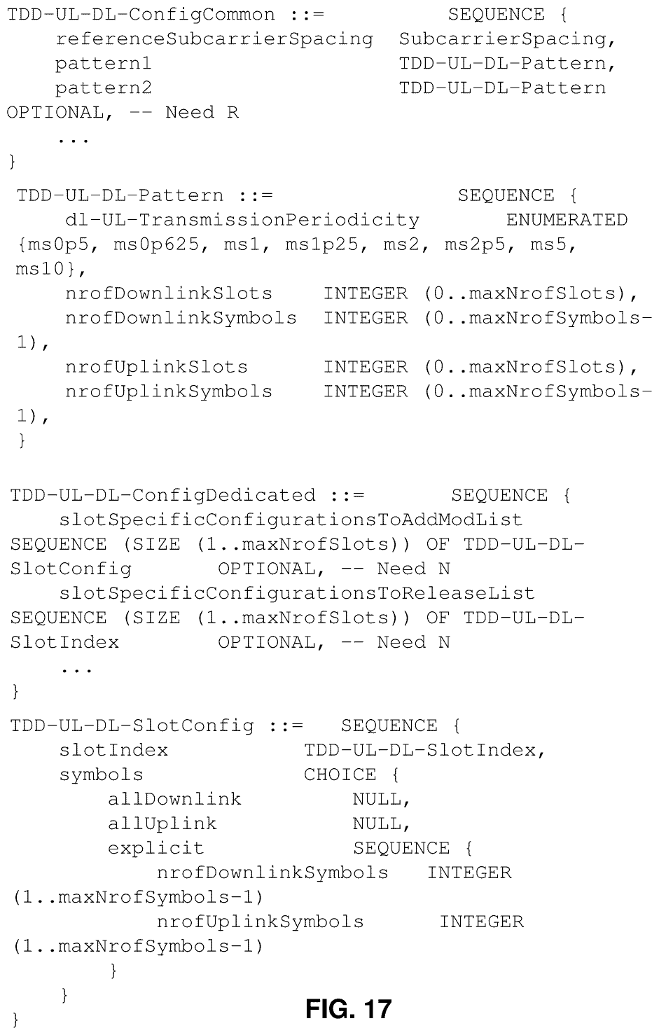

FIG. 17 illustrates an example of UL/DL TDD configuration as per an aspect of an embodiment of the present disclosure. The UL/DL TDD configuration may be (or comprise) a cell-specific UL/DL TDD configuration (e.g., TDD-UL-DL-ConfigCommon). The UL/DL TDD configuration may be (or comprise) a UE-specific UL/DL TDD configuration (e.g., TDD-UL-DL-ConfigDedicated).

As shown in FIG. 17, the one or more configuration parameters may comprise one or more TDD configuration parameters. The one or more TDD configuration parameters may be/comprise the UL/DL TDD configuration. The one or more TDD configuration parameters may comprise one or more common TDD configuration parameters (e.g., TDD-UL-DL-ConfigCommon).

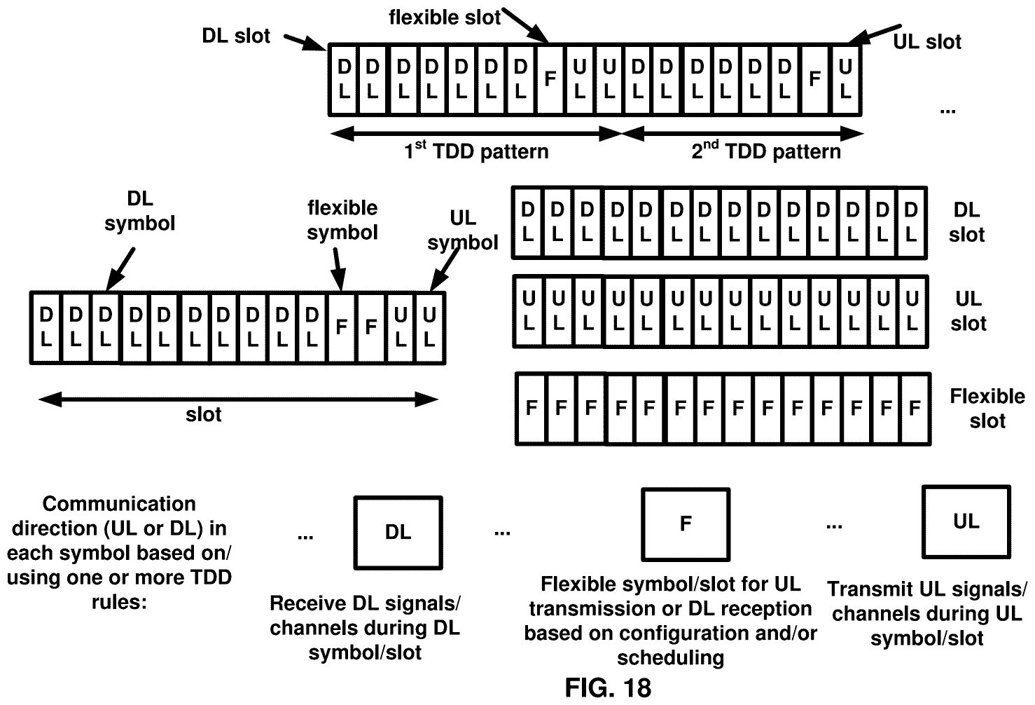

For a serving cell (of the one or more serving cells), one or more common TDD configuration parameters may indicate/configure slot format(s) of a plurality of slots. FIG. 18 shows examples of a slot format in a TDD carrier.

The one or more TDD configuration parameters may indicate/configure the plurality of slots. The plurality of slots may comprise one or more consecutive slots. The plurality of slots may comprise one or more DL slots/symbols. The plurality of slots may comprise one or more UL slots/symbols. The plurality of slots may comprise one or more flexible slots/symbols.

A first symbol/slot of the plurality of slots may be an Uplink (‘U’/UL) symbol. An UL symbol may be used by the wireless device for uplink transmission(s), e.g., via the serving cell. The one or more DL slots/symbols may comprise the first symbol/slot.

A second symbol/slot of the plurality of slots may be a downlink (‘D’/DL). A DL symbol may be used by the wireless device for downlink reception(s), e.g., via the serving cell. The one or more DL slots/symbols may comprise the second symbol/slot.

In some implementations, a third symbol in a slot of the plurality of slots may be a flexible (‘F’) symbol. The one or more flexible slots/symbols may comprise the third symbol/slot. Slot format/direction of the flexible symbol may be determined (by the wireless device and/or the base station) by other signaling, e.g., DCI format 2_0 and/or UL/DL grants and/or the one or more UE-specific TDD configuration parameters. The format ‘F’ is used by the network to control UL/DL transmission/reception of each wireless device flexibly. For example, the network may assign a symbol with ‘F’ for a wireless device not to transmit to or receive from a base station, e.g., for interference control and/or power saving purposes. For example, the network may use a slot format ‘F’ on one or more symbols to selectively initiate/trigger random access (RA) for a particular wireless device. Other wireless devices may not be allowed to transmit or receive on the one or more symbols, resulting in reduced interference for the wireless device.

The one or more common TDD configuration parameters may comprise at least one of: a reference subcarrier spacing (SCS) μ_{ref}; and/or at least one TDD pattern. As shown in FIG. 18, the at least one TDD pattern may comprise a first TDD pattern (e.g., pattern1) and/or a second TDD pattern (e.g., pattern2). A TDD pattern of the at least one TDD pattern may be a TDD-UL-DL pattern

A TDD pattern (e.g., the first TDD pattern or the second TDD pattern) of the at least one TDD pattern may comprise at least one of: a slot configuration period of P msec (e.g., a TDD periodicity); a number of slots [symbol] with only downlink symbols (e.g., DL slot(s)); a number of downlink symbols [symbol] (e.g., DL symbol(s)); a number of slots [symbol] with only uplink symbols (e.g., UL slot(s)); a number of uplink symbols [symbol] (e.g., UL symbol(s)). The one or more DL symbols/slots may comprise the number of slots [symbol] and/or the number of downlink symbols [symbol] . The one or more UL symbols/slots may comprise the number of slots [symbol] and/or the number of uplink symbols [symbol] .

FIG. 18 also shows a DL slot, an UL slot, and a slot comprising both UL symbol(s) and DL symbol(s). For example, the rest of slots/symbols in the TDD pattern (withing the slot configuration period P) not indicated by the TDD pattern as DL/UL slots/symbols may be flexible slots/symbols. The one or more flexible slots/symbols may comprise the rest of slots/symbols in the TDD pattern (withing the slot configuration period P) not indicated by the TDD pattern as DL/UL slots/symbols.

Corresponding to each TDD pattern of the at least one TDD pattern, a TDD periodicity (e.g., the corresponding slot configuration period of the TDD pattern) may comprise S=P·2^{μ}^{_{ref}} (consecutive) slots with SCS configuration [symbol] . The one or more consecutive slots may comprise S₁=P₁· [symbol] (consecutive) slots (of the first TDD pattern) and/or S₂=P₂· [symbol] (consecutive) slots (of the second TDD pattern). The TDD periodicity P may be a summation of a first TDD periodicity P₁ (of the first TDD pattern) and a second TDD periodicity P₂ (of the first TDD pattern), e.g., P₁=P₁+P₂.

From Sᵢ slots (i=1 corresponding to the first TDD pattern or i=2 corresponding to the second TDD pattern), a first/initial/starting/earliest [symbol] slots may comprise the one or more DL slots/symbols. From Sᵢ slots, a last/final/ending/latest [symbol] slots may comprise the one or more UL slots/symbols. A [symbol] symbols after the first [symbol] slots may comprise the one or more DL symbols. A [symbol] symbols before the last [symbol] slots may comprise the one or more UL symbols. A remaining

$$( S - {d}_{▯▯▯▯▯} - {u}_{▯▯▯▯▯} ) . {N}_{symb}^{slot} - {d}_{sym} - {u}_{sym}$$

symbols may comprise the one or more flexible symbols/slots.

The one or more TDD configuration parameters may comprise one or more UE-specific TDD configuration parameters (e.g., TDD-UL-DL-Configdedicated). The one or more UE-specific TDD configuration parameters may overwrite the one or more flexible symbols/slots of the one or more consecutive slots configured by the TDD-UL-DL-ConfigCommon.

As shown in FIG. 17, the one or more UE-specific TDD configuration parameters may comprise at least one of: one or more UE-specific slot configurations (e.g., slotSpecificConfigurationsToAddModList and/or slotSpecificConfigurationsToReleaseList); and/or a slot index for a slot (e.g., slotIndex).

As shown also in FIG. 17, a UE-specific slot configuration (e.g., TDD-UL-DL-SlotConfig) of the one or more UE-specific slot configurations may configure/indicate one or more symbols (e.g., symbols) of a slot with the slot index. The one or more symbols (N symbols) may be configured as flexible symbols by the one or more common TDD configuration parameters. The one or more flexible symbols/slots may comprise the one or more symbols (e.g., symbols) indicated by the UE-specific slot configuration.

The UE-specific slot configuration may indicate whether the one or more symbols are all DL symbols (e.g., al/Down/ink) or all UL symbols (e.g., allUplink). The UE-specific slot configuration may (via nrofDown/inkSymbols) indicate one or more first symbols (N1 symbols) of the one or more symbols are DL symbols. The UE-specific slot configuration may (via nrofUplinkSymbols) indicate one or more second symbols (N2 symbols) of the one or more symbols are UL symbols. For example, N-N1-N2 remining symbols may be flexible symbols. The one or more DL symbols/slots may comprise the one or more first symbols (N1 symbols). The one or more UL symbols/slots may comprise the one or more second symbols (N2 symbols). The one or more flexible symbols/slots may comprise N-N1-N2 remining symbols.

Using/based on the one or more TDD configuration parameters, the wireless device may determine the slot format of each slot/symbol of the plurality of slots. Using/based on the one or more UE-specific TDD configuration parameters, the wireless device may determine a symbol format of each symbol of the plurality of slots. The symbol format may be the slot format.

In some implementations, the one or more configuration parameters may comprise/indicate a slot format indicator (e.g., SlotFormatIndicator). The one or more configuration parameters may comprise/indicate an SFI-RNTI by sfi-RNTI and with a payload size of DCI format 2_0 by dci-PayloadSize. The one or more configuration parameters may configure a plurality of slot format combinations (e.g., slotFormatCombToAddModList and slotFormatCombToReleaseList) of a cell.

A base station may indicate a slot format combination of the plurality of slot format combinations via a DCI format 2_0 with a CRC scrambled the SFI-RNTI. The DCI format 2_0 may notify a group of wireless devices one or more slot formats (corresponding to the plurality of slot format combinations). In an example, a slot format may be identified by a corresponding format index. Each symbol in the slot may be a downlink (‘D’) symbol and/or an uplink (‘U’) symbol and/or a flexible (‘F’) symbol. A slot format 0 may comprise of all downlink (‘D’) symbols. For example, a slot format 1 may comprise of all uplink (‘U’) symbols. For example, A slot format 55 may comprise of two downlink (‘D’) symbols, followed by three flexible (‘F’) symbols, followed by three uplink (‘U’) symbols, followed by six downlink (‘D’) symbols.

The one or more slot formats may be predefined for the wireless device.

The one or more configuration parameters may configure/indicate the one or more slot formats.

An SFI-index field value in the DCI format 2_0 may indicate to a wireless device a slot format for a slot of the one or more consecutive slots. For each serving cell (of the one or more serving cells), the one or more configuration parameters may further indicate at least one of the following: an identity of the serving cell; and/or a location of an SFI-index field in the DCI format 2_0; and/or at least one slot format combination (e.g., slotFormatCombinations) of the plurality of slot format combinations.

For example, a slot format combination may comprise at least one of: at least one slot format of the one or more slot formats (e.g., slotFormats) for the slot format combination; and/or a mapping for the slot format to a corresponding SFI-index field value in the DCI format (e.g., slotFormatCombinationId); and/or at least one reference SCS configuration.

The wireless device may use one or more TDD rules when communicating with a base station in a TDD carrier/spectrum (e.g., during the one or more consecutive slots). FIG. 18 also shows some examples of the one or more TDD rules.

According to/based on the one or more TDD rules, a wireless device may consider (DL) symbols in a DL slot of the plurality of slots to be available/allowable for DL receptions. The wireless device may receive DL signals/channels (e.g., PDSCH/SSB/PDCCH or CSI-RS) during/in the DL symbols of the DL slot. The wireless device may not transmit UL signals/channels (even partially) during/in DL symbols of the DL slot.

According to/based on the one or more TDD rules, a wireless device may consider (UL) symbols in an UL slot of the plurality of slots to be available/allowable for UL transmissions. The wireless device may transmit UL signals/channels (e.g., PUSCH, PUCCH, PRACH, or SRS) during/in the UL symbols of the slot. The wireless device may not receive DL signals/channels (even partially) during/in the UL symbols of the UL slot.

The one or more configuration parameters may not configure a wireless device to monitor PDCCH for the DCI format 2_0. According to/based on the one or more TDD rules, for a set of (flexible) symbols of a slot (flexible slot) of the plurality of slots, the wireless device may receive DL signals/channels (e.g., PDSCH or CSI-RS) in the set of symbols of the slot. For example, the wireless device receives a DCI scheduling/indicating/triggering the reception of the DL signals/channels in during the set of flexible symbols.

The one or more configuration parameters may not configure a wireless device to monitor PDCCH for the DCI format 2_0. According to/based on the one or more TDD rules, for a set of (flexible) symbols of a slot (flexible slot) of the plurality of slots, the wireless device may transmit UL signals/channels (e.g., PUSCH, PUCCH, PRACH, or SRS) in the set of symbols of the slot. For example, the wireless device may receive a DCI, a RAR UL grant, fallbackRAR UL grant, or successRAR scheduling/indicating/triggering the transmission of the UL signals/channels in during the set of flexible symbols.

According to/based on the one or more TDD rules, if a wireless device is configured by higher layers (e.g., RRC/MAC) to receive a DL signal/channel (e.g., PDCCH, or a PDSCH, or a CSI-RS, or a DL PRS) in a set of symbols of the plurality of slots, the wireless device may receive the DL signal/channel based on not detect/receive a DCI format scheduling/triggering/indicating a transmission of an UL signal/channel (e.g., a PUSCH, a PUCCH, a PRACH, or a SRS) in at least one symbol of the set of symbols. Based on detecting/receiving the DCI format scheduling/triggering/indicating the transmission of the UL signal/channel in at least one symbol of the set of symbols of the slot, the wireless device may not receive the DL signal/channel (e.g., PDCCH, or a PDSCH, or a CSI-RS, or a DL PRS) in the set of symbols of the slot. The wireless device may transmit the UL signal/channel (e.g., a PUSCH, a PUCCH, a PRACH, or an SRS) in at least one symbol of the set of symbols of the slot.

According to/based on the one or more TDD rules, for a set of flexible symbols of a flexible slot of the plurality of slots that are indicated, the wireless device may not expect to receive both dedicated higher layer parameters configuring transmission from the wireless device (e.g., Type1/2 CG PUSCH, PRACH, MsgA PUSCH, SRS, PUCCH) in the set of flexible symbols and dedicated higher layer parameters configuring reception by the wireless device (e.g., SPS PDSCH, P/SP CSI-RS, SSB, CORESET) in the set of flexible symbols. For example, the one or more configuration parameters may not configure CG-PUSCH transmission occasions and SPS PDSCH reception occasions in the set of flexible symbols.

According to/based on the one or more TDD rules, for a set of symbols of a slot (of the plurality of slots) indicated to a wireless device for reception of SS/PBCH blocks (SSBs), the wireless device may not transmit UL signals/channels (e.g., PUSCH, PUCCH, PRACH) in the slot if the transmission occasion of the UL signal/channel overlaps with any symbol from the set of symbols. The wireless device may not transmit SRS in the set of symbols of the slot. For example, the one or more TDD configuration parameters do not indicate the set of symbols of the slot as uplink. The set of symbols for receiving the SSB may be configured by the one or more configuration parameters (e.g., by ssb-PositionsInBurst in SIB1 or by ssb-PositionsInBurst in ServingCellConfigCommon).

According to/based on the one or more TDD rules, for a set of symbols of a slot (of the plurality of slots) corresponding to a valid PRACH occasion and N_gap symbols before the valid PRACH occasion, the wireless device may not receive the DL signals/channels (e.g., PDCCH, PDSCH, or CSI-RS) in the slot if the reception of the DL signal/channel overlaps with any symbol from the set of symbols. According to/based on the one or more TDD rules, the one or more TDD configuration parameters may not configure the set of symbols of the slot as downlink.

According to/based on the one or more TDD rules, for a set of symbols of a slot (of the plurality of slots) indicated to a wireless device by the pdcch-ConfigSIB1 in MIB for a CORESET for Type0-PDCCH CSS set, the wireless device does not expect the set of symbols to be indicated as uplink by the one or more TDD configuration parameters.

According to/based on the one or more TDD rules, if a DCI schedules/configures/indicates PDSCH reception(s) over multiple slots (e.g., multi-PDSCH receptions or repetitions of a PDSCH), the wireless device may not receive a PDSCH (of the multi-PDSCHs) in a slot of the multiple slots the plurality of slots. The wireless device may not receive a repetition of the PDSCH in the slot. For example, the one or more consecutive slots comprise the multiple slots. The slot may comprise at least one UL symbol configured/indicated by the one or more TDD configuration parameters.

According to/based on the one or more TDD rules, if a DCI schedules/configures/indicates PUSCH transmission(s) over multiple slots (e.g., multi-PUSCH transmissions or repetitions of a PUSCH), the wireless device may not transmit a PUSCH (of the multi-PUSCHs) in a slot of the multiple slots the plurality of slots. The plurality of slots may comprise a plurality of symbols. The wireless device may not transmit a repetition of the PUSCH in the slot. For example, the one or more consecutive slots comprise the multiple slots. The slot may comprise at least one DL symbol configured/indicated by the one or more TDD configuration parameters.

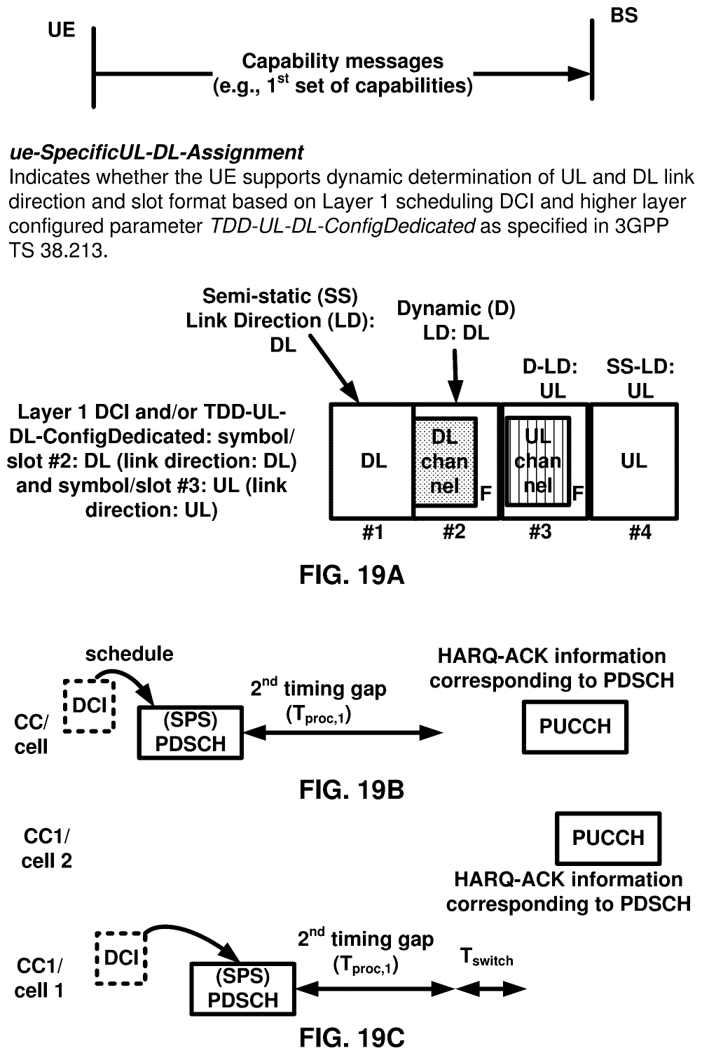

FIG. 19A shows an example of UE-capability report per an aspect of the present disclosure. The wireless device may transmit one or more capability messages to a base station. The one or more UE capability messages may also referred to by one or more UE-capability messages. The one or more UE capability messages may comprise at least one set of capabilities. The at least one set of capabilities may comprise a first set of capabilities. The first set of capabilities may comprise the UE capabilities. The UE capabilities may allow the base station to properly configure the wireless device via the one or more configuration parameters. The first set of capabilities may correspond to/applicable for a TDD carrier or a FDD carrier. Some capabilities of the first set of capabilities may correspond to/applicable for a sub-band fullduplex (SBFD) operation withing/in the TDD carrier/spectrum.

FIG. 19A also shows one example of a capability of the first set of capabilities. For example, the one or more first capabilities may comprise a first capability (e.g., ue-SpecificUL-DL-Assignment). FIG. 19A provides an example definition of the first capability. The first capability may indicate whether the wireless device supports dynamic determination of UL and DL link direction and slot format (e.g., of a flexible slot/symbol of the one or more consecutive slots), e.g., based on Layer 1 scheduling DCI and the UE-specific UL/DL configurations (TDD-UL-DL-ConfigDedicated). For example, the one or more TDD configuration parameters may comprise the one or more UE-specific TDD configuration parameters based on the first set of capabilities comprising the first capability.

When the first set of capabilities do not comprise the first capability, the wireless device may not expect to receive the one or more UE-specific TDD configuration parameters.

When the first set of capabilities do not comprise the first capability, the wireless device may not expect to dynamically determine UL and DL link direction and slot format (e.g., of a flexible slot/symbol of the one or more consecutive slots), e.g., based on Layer 1 scheduling DCI (e.g., DCI format 2_0 and/or scheduling DCI) and the UE-specific UL/DL configurations (TDD-UL-DL-ConfigDedicated).

FIG. 19A also shows an example of a semi-static UL/DL link direction and a dynamic UL/DL link direction in existing technologies. The semi-static UL/DL link direction may be based on the one or more cell-specific TDD configuration parameters. In the example of FIG. 19B, the one or more cell-specific TDD configuration parameters may (in a semi-static (SS) manner/approach) indicate a slot/symbol #1 as DL (SS-DL), a slot/symbol #2 as flexible (SS-F), a slot/symbol #3 as flexible (SS-F), and slot/symbol #4 as UL (SS-UL).

The dynamic UL/DL link direction (e.g., D-LD) may be based on the one or more UE-specific TDD configuration parameters. In the example of FIG. 19A, the one or more UE-specific TDD configuration parameters may indicate the slot/symbol #2 as DL (e.g., D-LD: DL). The wireless device may, based on the first set of capabilities indicating the first capability, determine a link direction corresponding to the slot/symbol #2 being DL. The wireless device may, in response to the one or more UE-specific TDD configuration parameters indicating the slot/symbol #2 as DL, receive a DL signal/channel during the slot/symbol #2 using RBs of an active DL BWP. The receiving the DL signal/channel may further be based on the one or more TDD rules.

In the example of FIG. 19A, when the first set of capabilities do not comprise the first capability, the wireless device may, in response to the UE-specific TDD configuration parameters indicating the slot/symbol #2 as DL, may avoid determining the link direction of the slot/symbol #2 as DL.

The dynamic UL/DL link direction may further be based on the DCI. The DCI may be a DCI format 2_0, indicating the one or more slot formats (e.g., via one or more slot format indicators). In the example of FIG. 19B, the DCI may indicate the slot/symbol #3 as UL (e.g., indicated based on a slot format of the one or more slot formats). The wireless device may determine D-LD as UL. The DCI may, for example, be the scheduling DCI. The scheduling DCI may indicate/trigger/schedule a transmission during the slot/symbol #3. The wireless device may, based on the first set of capabilities indicating the first capability, determine a link direction corresponding to the slot/symbol #3 being UL. The wireless device may, in response to the DCI indicating the slot/symbol #3 as UL, transmit an UL signal/channel during the slot/symbol #3 using RBs of an active UL BWP. The transmitting the UL signal/channel may further be based on the one or more TDD rules.

In the example of FIG. 19A, when the first set of capabilities do not comprise the first capability, the wireless device may, in response to the DCI indicating the slot/symbol #3 as UL, may avoid determining the link direction of the slot/symbol #3 as UL.

For example, the first set of capabilities may comprise a second capability (e.g., partialCancellationPUCCH-PUSCH-PRACH-TX-r16). The second capability may indicate whether the wireless device support a partial cancellation of the configured PUCCH or PUSCH or PRACH transmission in set of symbols of a slot (of the one or more consecutive slots) due to at least one of the following: a detection of a DCI format 2_0 with a slot format value other than 255 that indicates a slot format with a subset of symbols from the set of symbols as downlink or flexible; and/or a DCI format 2_0 being configured but not detected, when either a subset of symbols from the set of symbols are indicated as flexible by the one or more TDD configuration parameters; and/or a detection of a scheduling DCI indicating to the UE to receive CSI-RS or PDSCH in a subset of symbols from the set of symbols. The scheduling DCI may be at least one of DCI format 1_0, DCI format 1_1, DCI format 1_2 or DCI format 01 and DCI format 0_2.

For example, the one or more configuration parameters configure a wireless device to transmit configured SRS, or PUCCH, or PUSCH, or PRACH in the set of symbols of the slot. The wireless device detects the scheduling DCI (indicating CSI-RS/PDSCH reception) in the subset of symbols.

According to/based on the one or more TDD rules and the first set of capabilities not comprising the second capability (e.g., partial cancellation), the wireless device may not cancel the transmission of the PUCCH or PUSCH or PRACH in the set of symbols if a first/initial/starting symbol in the set occurs within a first timing gap (e.g., T_{proc,2}) relative to a last/final/ending/latest symbol of a PDCCH reception providing/carrying the scheduling DCI. Based on the first set of capabilities not comprising the second capability and the first/initial/starting symbol in the set occurs before the first timing gap from the last/final/ending/latest symbol of the PDCCH reception, the wireless device may cancel the PUCCH, or the PUSCH, or an actual repetition of the PUSCH or the PRACH transmission in the set of symbols. For example, the first timing gap may be T_{proc,2}. The first timing gap may be based on a PUSCH preparation time.

According to/based on the one or more TDD rules and the first set of capabilities comprising the second capability (e.g., partial cancellation), the wireless device may not cancel the transmission of the PUCCH or PUSCH or PRACH in symbols from the set of symbols that occur within the first timing gap relative to the last/final/ending/latest symbol of the PDCCH reception. Based on the first set of capabilities comprising the second capability the first/initial/starting symbol in the set occurs before the first timing gap from the last/final/ending/latest symbol of the PDCCH reception, the wireless device may cancel the PUCCH, or the PUSCH, or an actual repetition of the PUSCH or the PRACH transmission in remaining symbols from the set of symbols.

According to/based on the one or more TDD rules, the wireless device may not cancel the transmission of SRS in symbols from the subset of symbols that occur within the first timing gap relative to the last symbol of the PDCCH reception. The wireless device may cancel the SRS transmission in the remaining symbols from the subset of symbols.

The first set of capabilities may comprise of a third capability (e.g., pdsch-ProcessingType2) of the first set of capabilities. The third capability (e.g., pdsch-ProcessingType2) may indicate whether the wireless device supports a PDSCH processing capability 2.

The wireless device may support/indicate the third capability only if all serving cells (of the one or more serving cells) are self-scheduled and if all the serving cells in one band on which the network configured processingType2 use the same subcarrier spacing. The third capability may comprise at least one the following parameters: fallback and/or differentTB-PerSlot.

The parameter fallback of the third capability may indicate whether the wireless device supports the PDSCH processing capability 2 when the number of configured carriers (CCs) is larger than a threshold (e.g., numberOfCarriers) for a reported value of differentTB-PerSlot of the third capability. If fallback=‘sc’, the wireless device may support the PDSCH processing capability 2 on a lowest cell index among the configured carriers (e.g., one or more cells) in the band where the value is reported. If fallback=‘cap1-only’, the wireless device may support may only the PDSCH processing capability 1, in the band where the value is reported.

The parameter differentTB-PerSlot of the third capability may indicate whether the wireless device supports the PDSCH processing type 2 for 1, 2, 4 and/or 7 unicast PDSCHs for different transport blocks per slot per CC. When the wireless device supports the PDSCH processing type 2 for 1, 2, 4 and/or 7 unicast PDSCHs for different transport blocks per slot per CC, the parameter differentTB-PerSlot of the third capability may further indicate up to which number of CA serving cells (e.g., which cell or CC) the wireless device supports that number of unicast PDSCHs for different TBs. The wireless device may include at least one of numberOfCarriers for 1, 2, 4 or 7 transport blocks per slot in this field if pdsch-ProcessingType2 is indicated.

FIG. 19B and FIG. 19C show examples of PDSCH processing per an aspect of the present disclosure. For example, the wireless device may receive, via a serving cell (e.g., cell 1 or CC1), a PDSCH. The scheduling DCI may indicate/schedule the PDSCH. The wireless device may receive the scheduling DCI via the serving cell.

The scheduling DCI may indicate a HARQ-ACK timing K1 (e.g., via a field PDSCH-to-HARQ_feedback timing indicator of the scheduling DCI). The wireless device may, based on the HARQ-ACK timing K1 and one or more PUCCH resources (configured by the one or more configuration parameters), determine a PUCCH (transmission occasion) for transmitting a HARQ-ACK information correspond to the PDSCH.

As shown in FIG. 19B, the transmission of the PUCCH is via the serving cell (e.g., the cell 1 of the one or more cells or the CC1 of the one or more CCs).

As shown in FIG. 19C, the transmission of the PUCCH is via a second serving cell (e.g., a cell 2 of the one or more cells or a CC2 of the one or more CCs).

A PDSCH processing time may be considered (by the wireless device and/or the base station) to determine a first/initial/starting/earliest uplink symbol of the PUCCH comprising the HARQ-ACK information of the PDSCH. In an example, the first uplink symbol of the PUCCH may be after (or not start earlier than) a second timing gap (e.g., T_{proc,1}) after a last/final/ending/latest symbol of the PDSCH reception associated with the HARQ-ACK information. In an example, the first uplink symbol of the PUCCH carrying the HARQ-ACK information may start no earlier than at/in symbol L1. Symbol L1 may be a next uplink symbol with its Cyclic Prefix (CP) starting after the second time gap T_{proc,1} after the end of the last symbol of the PDSCH.

The wireless device may determine the second timing gap T_{proc,1} based on the PDSCH processing capability 2 and/or a PDSCH processing capability 1. The PDSCH processing capability 1 may indicate a first value (in a number of symbols) associated with a numerology (e.g., of the serving cell or a DL carrier or a DL BWP or a PDSCH). The first value may be 8 or 10 or 17 or 20 or 80 or 160 respectively for numerology μ (e.g., μ_{PDSCH}) of 0, 1, 2, 3, 5, 6. The PDSCH processing capability 2 may indicate a second value (in a number of symbols) associated with a numerology (e.g., of the serving cell or a DL carrier or a DL BWP or a PDSCH). The second value may be 3 or 4.5 or 9 respectively for numerology μ (e.g., μ_{PDSCH}) of 0, 1, 2.

When the first set of capabilities comprise the third capability (e.g., for the wireless device that supports the PDSCH processing capability 2 on a given cell), the processing time according to the PDSCH processing capability 2 is applied for processing the PDSCH if the one or more configuration parameters (e.g., PDSCH-ServingCellConfig) set/indicate parameter processingType2Enabled to ‘enable’.

The wireless device may not expect to transmit the PUCCH carrying the HARQ-ACK information for the PDSCH if an uplink switching gap is triggered for the PUCCH and the first uplink symbol of the PUCCH starts earlier than the duration of T_{switch}+T_{proc,1} from the last symbol of the PDCCH. In an example, T_{switch} may equal to a switching gap duration (e.g., N_{Tx1-Tx2}) for switching an uplink switching. For example, the uplink switching may comprise switching from a first CC (the CC1) to a second CC (the CC2). For example, the uplink switching may comprise switching from the service cell (the cell 1) to a second serving cell (the cell 2).

The first set of capabilities may comprise a fourth capability (e.g., pdsch-ProcessingType2-Limited) of the first set of capabilities. The fourth capability may indicate whether the wireless device supports the PDSCH processing capability 2 (e.g., the third capability) with a scheduling limitation for SCS 30 kHz (e.g., μ_{PDSCH}=1). The fourth capability may indicate differentTB-PerSlot-SCS-30 kHz. The differentTB-PerSlot-SCS-30 kHz may indicate the number of different TBs per slot (for the SCS 30 kHz).

The wireless device may support/indicate the fourth capability (e.g., the limited processing capability 2) only if one carrier (e.g., the CC1) is configured in the band, independent of the number of carriers configured in the other bands; 2) a maximum bandwidth of the PDSCH is 136 PRBs; 3) N1 (e.g., the second value) be 3.5 symbols for SCS 30 kHz, or μ_{PDSCH}=1.

When the first set of capabilities comprise the fourth capability (e.g., the limited processing capability 2 with scheduling limitation when μ_{PDSCH}=1), if the scheduled RB allocation of the PDSCH exceeds 136 RBs, the wireless device may default to the PDSCH processing capability 1 (e.g., capability 1 processing time) for processing the PDSCH. The wireless device may skip decoding first PDSCHs with last symbol within 10 symbols before the start of a PDSCH that is scheduled to follow the PDSCH processing capability 2, if any of the first PDSCHs are scheduled with more than 136 RBs with 30 kHz SCS and following the PDSCH processing capability 1 (e.g., Capability 1 processing time).

For example, the first set of capabilities may comprise a fifth capability (e.g., pdsch-ProcessingType1-DifferentTB-PerSlot). The fifth capability may indicates/defines whether the wireless device capable of the PDSCH processing time capability 1 supports reception of up to two, four or seven unicast PDSCHs for several transport blocks with PDSCH scrambled using C-RNTI, TC-RNTI, MCS-C-RNTI or CS-RNTI in one serving cell within the same slot per CC that are multiplexed in time domain only.

For example, the first set of capabilities may comprise a sixth capability (e.g., cbgPDSCH-Processing Type2-DifferentTB-PerSlot-r16). The sixth capability may indicate/defines whether the wireless device capable of the PDSCH processing time capability 2 (e.g., the third capability) supports code block group (CBG) based reception with one or with up to two or with up to four or with up to seven unicast PDSCHs per slot per CC.

For example, the first set of capabilities may comprise a seventh capability (e.g., cbgPDSCH-ProcessingType1-DifferentTB-PerSlot-r16). The seventh capability may indicate/defines whether the wireless device capable of the PDSCH processing time capability 1 supports code block group (CBG) based reception with one or with up to two or with up to four or with up to seven unicast PDSCHs per slot per CC.

The one or more configuration parameters (e.g., via BWP-Down/inkDedicated) may comprise one or more semi-persistent scheduling (SPS) configuration parameters. For example, the one or more SPS configuration parameters may comprise at least one (e.g., 8) SPS configuration (SPS-Config).

A SPS configuration of the at least one SPS configurations may be a unicast SPS configuration or a multicast SPS configuration. The SPS configuration configures the wireless device for receiving DL SPS (e.g., SPS PDSCH) in downlink.

A SPS configuration may comprise at least one of the following: SPS configuration ID/index; and/or a periodicity of the corresponding DL SPS; and/or a HARQ codebook ID indicating a HARQ-ACK codebook index for a corresponding HARQ-ACK codebook for SPS PDSCH and ACK for SPS PDSCH release; and/or a modulation and coding scheme table corresponding to the DL SPS; a number of repetitions for the SPS PDSCH (e.g., pdsch-AggregationFactor); and/or nrofHARQ-Processes indicating a number of HARQ processes for the DL SPS.

A base station may transmit to the wireless device a DCI (e.g., an activating DCI) with a CS-RNTI (or a G-CS-RNTI) for activating the SPS configuration. The wireless device may receive a PDCCH providing/with the DCI. For example, the wireless device may validate the DCI/PDCCH to determine the DCI activating the SPS configuration. An NDI field of the DCI may set to 0. A DFI flag field of the DCI may set to 0. The activating DCI may be the scheduling DCI.

When the one or more SPS configuration parameters configure at least two SPS configurations, a HARQ process number/ID field of the DCI may indicate a SPS configuration index of the SPS configuration of the at least two SPS configurations.

After the SPS configuration being activated (based on the DCI), the wireless device may receive DL data via/using configured DL assignments configured by the SPS configuration and the DCI. The DCI may indicate frequency resources (e.g., “Frequency domain resource assignment” field of the DCI) and/or VRB-to-PRB mapping and/or rate matching indicator for receiving the SPS PDSCH(s). The DCI may indicate time domain resources (e.g., via a ‘Time domain resource assignment’ field of the activating DCI). The time domain resources may indicate a row of a time domain resource allocation table (TDRA) configured by the one or more configuration parameters.

When the SPS configuration is activated, the wireless device may receive a first SPS PDSCH, e.g., a PDSCH scheduled by DCI format 1_1 or 1_2 in PDCCH with CRC scrambled by CS-RNTI with NDI=0. The wireless device may receive SPS PDSCHs after the first SPS PDSCH PDSCH(s), e.g., PDSCHs scheduled without corresponding PDCCH transmission using the SPS configuration (e.g., sps-Config) and activated by the activating DCI.

The wireless device may receive SPS PDSCH (comprising the first SPS PDSCH and the SPS PDSCHs after the first SPS PDSCH PDSCH(s)) using/via a same symbol allocation across the pdsch-AggregationFactor. The wireless device may use the pdsch-AggregationFactor indicated by the SPS configuration or by pdsch-config of the one or more configuration parameters. The wireless device may expect that a TB is repeated within each symbol allocation among each of the pdsch-AggregationFactor consecutive slots and the PDSCH is limited to a single transmission layer.

For example, the first set of capabilities may comprise an eights capability (e.g., downlinkSPS). The eights capability may indicate whether the wireless device supports PDSCH reception based on SPS. For example, based on the first set of capabilities comprising the eight capability, the base station may configure the at least one SPS configuration for the wireless device. Based on the first set of capabilities comprising the eight capability, the base station may not configure the at least one SPS configuration for the wireless device. Based on the first set of capabilities comprising the eight capability, the base station may not configure more than one SPS configuration for the wireless device.

The first set of capabilities may comprise a ninth capability (e.g., sps-Multicast-r17) indicating whether the wireless device supports SPS group-common PDSCH for multicast on PCell. The ninth capability may comprise the following functional components: support one SPS group-common PDSCH configuration for multicast; Supports {2, 4, 8} times semi-static slot-level repetition for SPS group-common PDSCH; Supports group-common PDCCH/PDSCH with CRC scrambled by G-CS-RNTI(s) for multicast; Supports DCI format 4_1 with CRC scrambled with G-CS-RNTI for multicast; Supports ACK/NACK-based HARQ-ACK feedback for SPS release associated with G-CS-RNTI.

When the first set of capabilities comprise the ninth capability, the one or more SPS configuration parameters may configure at least one multicast SPS configuration for receiving SPS group-common PDSCH (e.g., group-common PDCCH configuration for MBS multicast). When the first set of capabilities does not comprise the ninth capability, the one or more SPS configuration parameters may not configure the at least one multicast SPS configuration for receiving SPS group-common PDSCH.

The first set of capabilities may comprise a tenth capability (e.g., sps-r16) indicating whether the wireless device supports of up to 8 configured SPS configurations in a BWP of a serving cell and up to 32 configured SPS configurations in a cell group. The tenth capability may comprise at least one of the following: maxNumberConfigsPerBWP-r16 indicating a maximum number of active SPS configurations in the BWP of the serving cell; and/or maxNumberConfigsAllCC-r16 indicating a maximum number of active SPS configurations across all serving cells in a MAC entity, and across an MCG and a SCG in case of NR-DC.

The wireless device may include the tenth capability (or feature) only if the wireless device indicates the support of downlinkSPS (e.g., the eights capability).

The cell group may be a Master cell group (MSG) or a secondary cell group (SCG).

The one or more configuration parameters may comprise one or more PDSCH configuration parameters (e.g., PDSCH-ConfigCommon and/or PDSCH-Config). The one or more PDSCH configuration parameters may comprise one or more cell-specific PDSCH configuration parameters and/or one or more UE-specific PDSCH configuration parameters. The one or more PDSCH configuration parameters may configure a resource allocation in frequency domain (resourceAllocation and/or resourceAllocationDCI-1-2).

The one or more PDSCH configuration parameters may indicate/comprise a DL resource allocation scheme (resourceAllocation and/or resourceAllocationDCI-1-2) for receiving (SPS) PDSCHs. The DL resource allocation (scheme) may be a resource allocation type 0 (e.g., resourceAllocationType0 or a type 0 resource allocation) or a resource allocation type 1 (e.g., resourceAllocationType1 or a type 1 resource allocation). The wireless device may receive, during a symbol/slot of a plurality of symbols/slots, (SPS) PDSCHs based on the configured/indicated resource allocation scheme. For example, a DCI scheduling/activating/triggering the (SPS) PDSCHs may not comprise a ‘Frequency domain resource assignment’ field (e.g., FDRA field). The wireless device may assume that when the scheduling grant is received with DCI format 1_0, 4_0 or 4_1, the downlink resource allocation type 1 is used for receiving the corresponding PDSCHs.

For example, the one or more PDSCH configuration parameters may indicate/comprise the resource allocation scheme (resourceAllocation and/or resourceAllocationDCI-1-2) as a dynamic switch (dynamicSwitch). The wireless device may receive a DCI scheduling/triggering a (SPS) PDSCH reception. The DCI (e.g., with a DCI format 1_1, or DCI format 1_2, or DCI format 4_2 or DCI format 1_3) may comprise a ‘Frequency domain resource assignment’ field (e.g., FDRA field) indicating whether the DL resource allocation is the downlink resource allocation type 0 or type 1. The wireless device may, in response to the DCI indicating the downlink resource allocation type 0, receive the PDSCH based on the downlink resource allocation type 0. The wireless device may, in response to the DCI indicating the downlink resource allocation type 1, receive the PDSCH based on the downlink resource allocation type 1.

In/for the downlink resource allocation of type 0 (e.g., the type 0 resource allocation), the one or more configuration parameters may indicate/configure a first resource block assignment information. The first resource block assignment information may comprise a bitmap indicating a set of Resource Block Groups (RBGs). An RBG of the set of RBGs may comprise a set of consecutive virtual resource blocks (e.g., rbg-Size configured by PDSCH-Config or rbg-SizeDCI-1-3 configured by PDSCH-ConfigDCI-1-3 for DCI format 1_3) and a size of the active DL BWP.

In/for the downlink resource allocation of type 1 (e.g., the type 1 resource allocation), the one or more configuration parameters may indicate/configure a second resource block assignment information. The second resource block assignment information may indicate/configure a set of contiguously allocated non-interleaved or interleaved virtual resource blocks within the active bandwidth part of size N PRBs. For the case when DCI format 1_0 is decoded in a common search space, N is the size of CORESET 0.

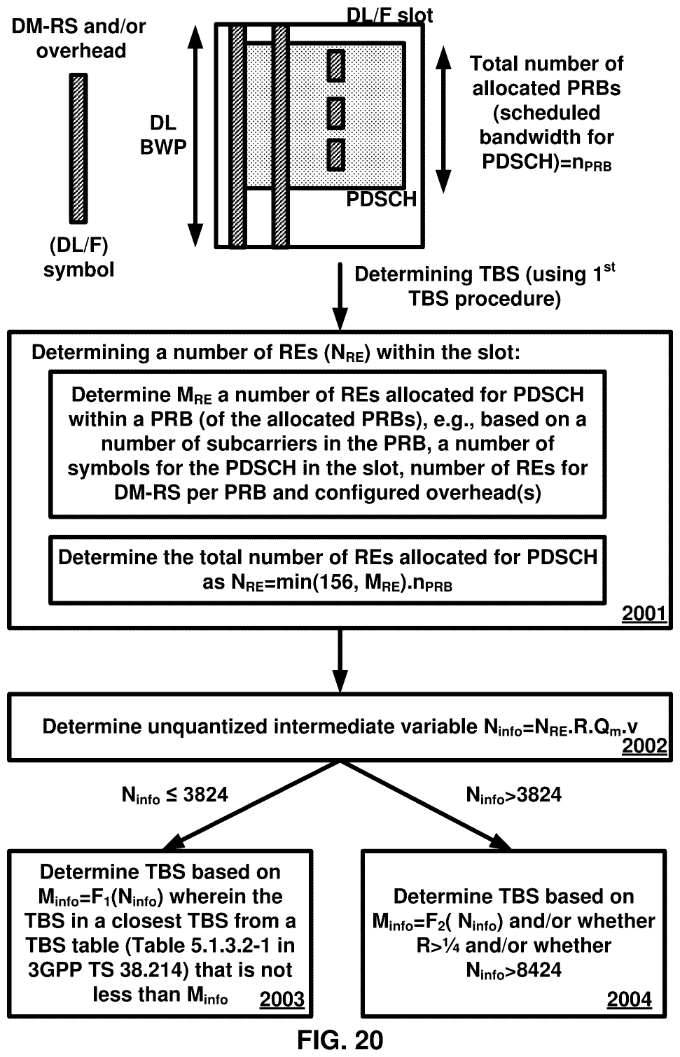

FIG. 20 shows an example flowchart of a procedure for determining a transport block size per an aspect of an embodiment of the present disclosure. Embodiment of FIG. 20 may also show an example of receiving a PDSCH in time/frequency domain. The wireless device may receive the PDSCH in an active DL BWP, e.g., in/during a slot (DL/F slot). For example, the PDSCH reception may comprise/carry a TB.

The TB may comprise a MAC PDU. The TB may comprise one or more packets. The TB may comprise data of the wireless device.

The wireless device may (for receiving the TB) determine a corresponding TB size (TBS) of the TB based on the procedure (e.g., a first TBS procedure) shown in FIG. 20.

The PDSCH reception may be scheduled/triggered/indicated by a first DCI (not shown in FIG. 20).

The wireless device may receive the first DCI comprising a scheduling grant (a DL assignment) for receiving the PDSCH. The PDSCH may be an SPS PDSCH (e.g., the first DCI activates the SPS PDSCH reception), e.g., the PDSCH scheduled without corresponding PDCCH transmissions using the one or more SPS configuration parameters (e.g., SPS-Config). The DCI and/or the one or more one or more PDSCH configuration parameters (e.g., PDSCH-ConfigCommon and/or PDSCH-Config and/or pdsch-ConfigMulticast and/or pdsch-ConfigMCCH and pdsch-ConfigMTCH) may indicate the resource allocation in frequency domain (resourceAllocation and/or resourceAllocationDCI-1-2), e.g., the resource allocation scheme.

For example, for receiving the TB/PDSCH, the wireless device may (corresponding to the TB) determine at least one of the following: a modulation order (Qₘ), a target code rate (R), a redundancy version (RV), the TBS (based on the first TBS procedure). A modulation and coding scheme (MCS) field of the first DCI may indicate the modulation order and/or the target code rate. For example, the MCS field of the first DCI may indicate an MCS index I_{MCS}. An RV field of the first DCI may indicate the RV used for receiving the TB/PDSCH. The wireless device may, for the indicated MCS index, determine the TBS.

The one or more PDSCH configuration parameters (e.g., PDSCH-ConfigCommon and/or PDSCH-Config) may comprise at least one MCS table, e.g., mcs-Table and/or mcs-TableDCI-1-2. For example, the wireless device may determine the modulation order (Qₘ) and the target code rate (R) based on the MCS index I_{MCS} and/or the at least one MCS table.

The first TBS procedure may comprise determining a total number of allocated PRBs n_{PRB} for receiving the PDSCH. Based on the first DCI (e.g., FDRA field of the first DCI) and/or the resource allocation scheme, the wireless device may determine allocated PRBs (e.g., the total number of allocated PRBs), e.g., no in FIG. 20. The allocated PRBs are within the active DL BWP. The wireless device may receive the PDSCH using/based on the allocated PRBs. The allocated PRBs may comprise a plurality of PRBs, e.g., for receiving the PDSCH. The allocated PRBs may be scheduled bandwidth for receiving the PDSCH. [symbol] may be a size of (e.g., a number of PRBs in) the plurality of PRBs allocated for the PDSCH.

As shown in FIG. 20, the first TBS procedure may comprise determining a number of REs within the slot (e.g., for receiving PDSCH) N_{RE}. N_{RE} may be a total number of REs allocated for the PDSCH. The wireless device may determine the TBS based on N_{RE}.

As shown in FIG. 20 2001 (e.g., Step 1 of the first TBS procedure), the wireless device may determine the total number of REs allocated for the PDSCH as [symbol] =min(156, M_{RE})·n_{PRB}· [symbol] may be a total number of REs allocated for the PDSCH within a PRB of the plurality of PRBs. The wireless device may determine the [symbol] as

$${M}_{▯▯} = {N}_{sc}^{RB} \cdot {N}_{symb}^{sh} - {N}_{DMRS}^{PRB} - {N}_{oh}^{PRB} . {N}_{▯▯}^{RB}$$

may be a number of subcarriers in a physical resource block, e.g.,

$${N}_{▯▯}^{RB} = 12. {N}_{▯▯▯▯}^{sh}$$

may be a number of symbols of the PDSCH allocation within the slot.

$${N}_{▯▯▯▯}^{PRB}$$

may be a number of REs for DM-RS per PRB in a scheduled duration of the PDSCH

$${N}_{▯▯▯▯}^{PRB}$$

may comprise an overhead of the DM-RS CDM groups without data.

$${N}_{oh}^{PRB}$$

may be an overhead indicated by xOverhead in the one or more PDSCH configuration parameters (e.g., PDSCH-ServingCellConfig and/or pdsch-ConfigMulticast). In some examples, the wireless device may set

$${N}_{oh}^{PRB}$$

to 0, e.g., if the xOverhead in PDSCH-ServingCellconfig is not configured (a value from 6, 12, or 18), the

$${N}_{oh}^{PRB}$$

may be 0. If the DCI scheduling the PDSCH is with a CRC scrambled by SI-RNTI, RA-RNTI, MSGB-RNTI or P-RNTI.

As shown in FIG. 20 (e.g., Step 2 of the first TBS procedure 2002), the wireless device may determine unquantized intermediate variable N_{info} based on at least the N_{RE}, the target code rate (R), the modulation order (Qₘ), an/or a number of layers (v), e.g., N_{info}=N_{RE}·R·Qₘ·v. Based on whether the unquantized intermediate variable N_{info} is greater/larger than a first value (e.g., 3824) or not, the wireless device may perform Step 3 of the first TBS procedure 2003 or Step 4 of the first TBS procedure 2004.

If N_{info}≤3824, the wireless device may determine (as part of performing Step 3 of the first TBS procedure 2003) the TBS based on [symbol] =F₁(N_{info}). [symbol] is a quantized intermediate number of information bits. For example,

$${F}_{1} ( {N}_{info} ) = max ( 24 , {2}^{n} \cdot ⌊ \frac{{N}_{info}}{{2}^{n}} ⌋ ) where n = max ( 3 , ⌊ {log}_{2} ( {N}_{info} ) ⌋ - 6 ) .$$

The wireless device may use a pre-defined/pre-configured TBS table (e.g., Table 5.1.3.2-1 of 3GPP TS 38.214) for determining the TBS. In an example, the TBS is a closest TBS in the pre-defined/pre-configured TBS table that is not less than (or is larger than or equal to) [symbol] .

If N_{info}>3824, the wireless device may determine (as part of performing Step 4 of the first TBS procedure 2004) the TBS based on [symbol] =F₂(N_{info}) and/or whether (the target code rate) R≤¼ and/or whether N_{info}>8424. M_{info} is the quantized intermediate number of information bits. For example,

$${F}_{2} ( {N}_{info} ) = max ( 3840 , {2}^{n} \times round ( \frac{{N}_{info} - 24}{{2}^{n}} ) )$$

where n=└log₂(N_{info}−24)┘−5. For example, if R≤¼,

$$TBS = 8 \cdot C \cdot ⌈ \frac{{N}_{info}^{′} + 24}{8 \cdot C} ⌉ - 24 , where C = ⌈ \frac{{N}_{info}^{′} + 24}{3816} ⌉ .$$

### If R>¼ and N_{info}<8424

$$TBS = 8 \cdot C \cdot ⌈ \frac{{N}_{info}^{′} + 24}{8 \cdot C} ⌉ - 24 , where C = ⌈ \frac{{N}_{info}^{′} + 24}{8424} ⌉ .$$

### If R>¼ and

$${N}_{info} \leq 8424 , TBS = 8 \cdot ⌈ \frac{{N}_{info}^{′} + 24}{8} ⌉ - 24$$

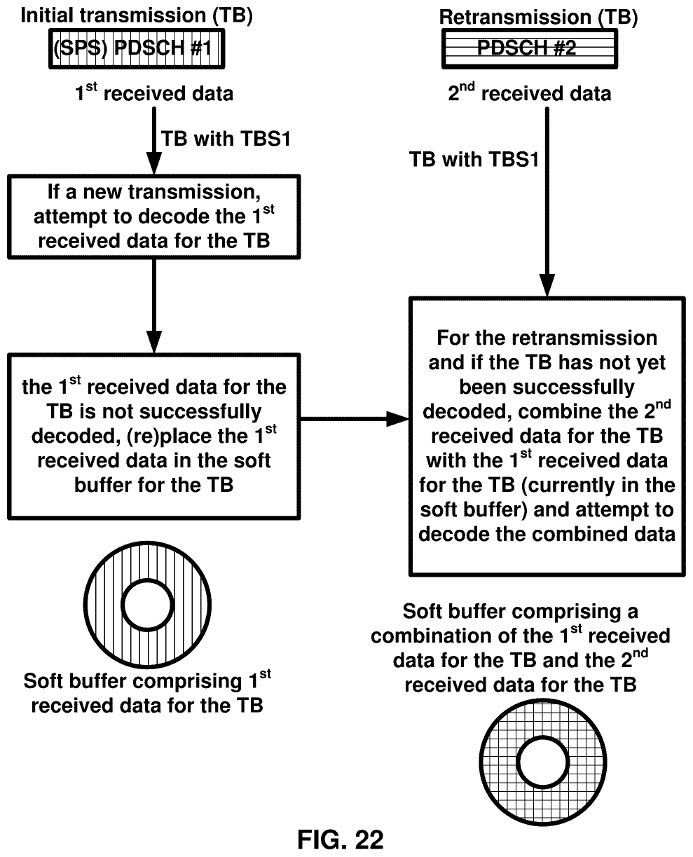

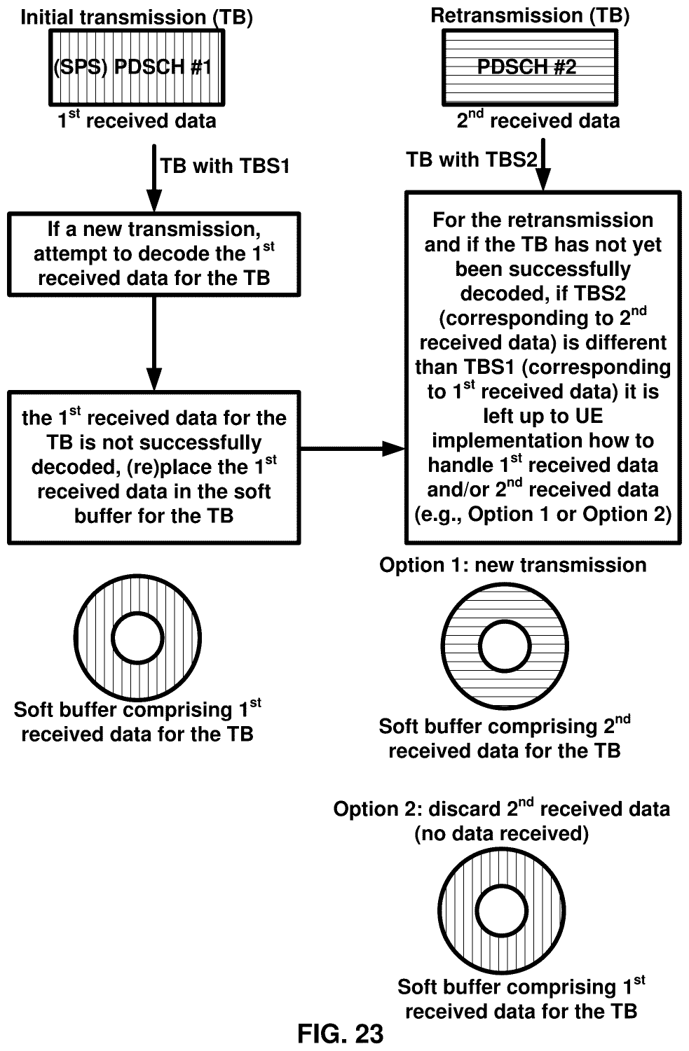

Based on determining the TB size (using the first TBS procedure), the wireless device may determine a HARQ information corresponding to the TB and indicate the HARQ information to higher layers (e.g., MAC layer) of the wireless device. The HARQ information may comprise the TBS size of the TB, corresponding HARQ process ID, and NDI (whether it is an initial transmission or retransmission). The higher layers of the wireless device attempt to decode data received by the TB as also shown in FIG. 22 and/or FIG. 23.

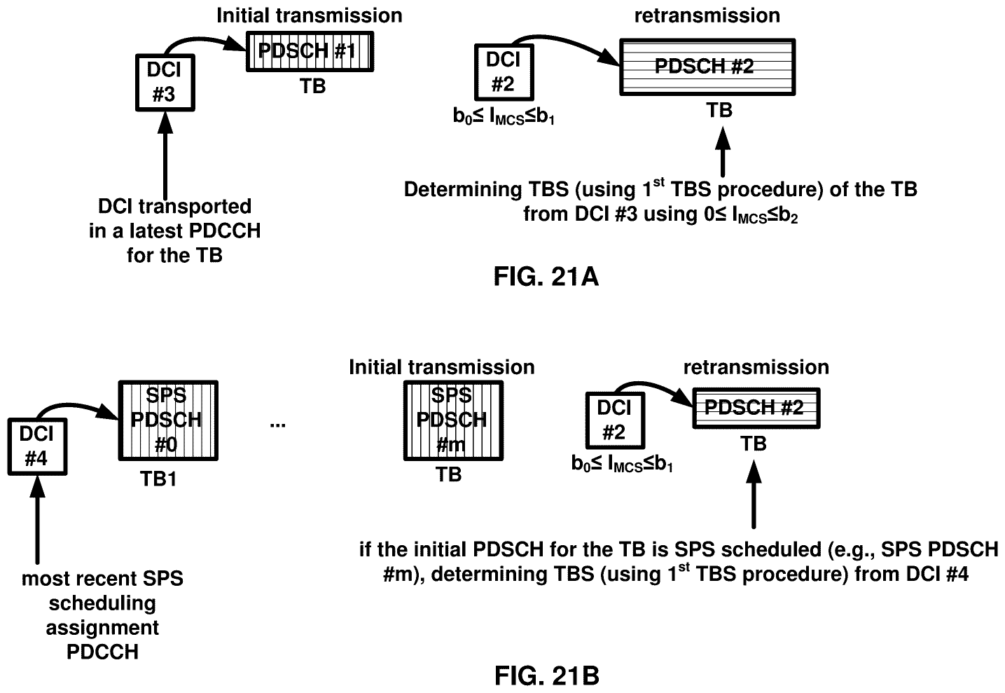

FIG. 21A and FIG. 21B show examples of transport block (TB) size determination for DL receptions. For example, the wireless device may use the first TBS procedure (discussed in embodiment of FIG. 20 above) for determining the TBS. In some aspects, embodiments of FIG. 21A and FIG. 21B may provide enhancement(s) for the transport block (TB) size determination discussed above, e.g., when a MCS index is larger than a threshold and/or for retransmission of the TB (provided by the PDSCH in FIG. 20).

For example, when the MCS index is smaller than or equal to the threshold, the wireless device may use the first TBS procedure for determining the TB size of the second TB. When the MCS index is smaller than or equal to the threshold, the wireless device may determine a first MCS condition not being satisfied.

When the MCS index is larger than the threshold, the wireless device may use embodiments of FIG. 21A and FIG. 21B. When the MCS index is larger than the threshold (e.g., using embodiments of FIG. 21A and FIG. 21B), the wireless device may determine the first MCS condition being satisfied.

As shown in FIG. 21A, the wireless device may receive a second DCI scheduling PDSCH #2. The PDSCH #2 may carry/be with the TB. For example, the second DCI may schedule a retransmission of the TB transmitted via a PDSCH #1, e.g., the PDSCH #1 and the PDSCH #2 carry the same TB (e.g., the TB). The PDSCH #1 may be the PDSCH shown in FIG. 20. The wireless device may, corresponding to the PDSCH #2, determine the first MCS condition being satisfied.

The wireless device may determine the first MCS condition not being satisfied based on at least one of the following being fulfilled/met: 0≤ [symbol] ≤27 and when a first MCS table (e.g., 3GPP TS 38.214 Table 5.1.3.1-2, e.g., MCS table 2 for PDSCH) of the at least one MCS table is used for the PDSCH #2; and/or 0≤ [symbol] ≤26 and a second MCS table (e.g., 3GPP TS 38.214 Table 5.1.3.1-4, e.g., MCS index table 4 for PDSCH) of the at least one MCS table is used for the PDSCH #2; and/or 0≤ [symbol] ≤28 and a third MCS table of the at least one MCS table is used for the PDSCH #2. The third MCS table is different than the first MCS table and the second MCS table. Based on the first MCS condition not being satisfied, the wireless device may determine the TBS of the TB (received via the PDSCH #2) using the first TBS procedure.

For example, the wireless device may determine the first MCS condition being satisfied based on an MCS index corresponding to the PDSCH #2 with the (retransmission of) TB satisfying b₀≤I_{MCS}<b₁.

The wireless device may determine the first MCS condition being satisfied based on at least one of the following being fulfilled/met: (Case 1) b₀=28, b₁=31 and when a first MCS table (e.g., 3GPP TS 38.214 Table 5.1.3.1-2, e.g., MCS table 2 for PDSCH) of the at least one MCS table is used for the PDSCH #2; or (Case 2) b₀=27, b₀=31 and a second MCS table (e.g., 3GPP TS 38.214 Table 5.1.3.1-4, e.g., MCS index table 4 for PDSCH) of the at least one MCS table is used for the PDSCH #2.

The wireless device may determine the first MCS condition being satisfied based on none of the following being fulfilled/met: the first MCS table is used for the PDSCH #2 and b₀=0, b₁=27; and the second MCS table is used for the PDSCH #2 and b₀=0, b₁=26; and (Case 3) a third MCS table (a table other than 3GPP TS 38.214 Table 5.1.3.1-2 and 3GPP TS 38.214 Table 5.1.3.1-4) of the at least one MCS table is used for the PDSCH #2 and b₀=0, b₁=28.

As shown in FIG. 21A, based on the first MCS condition being satisfied, the wireless device for determining the TBS of the TB of the PDSCH #2 uses/considers a third DCI (DCI #3 in FIG. 21A) for the initial transmission of the TB using 0≤ [symbol] ≤b₂. Based on the first MCS condition being satisfied, the wireless device for determining the TBS of the (retransmission of the) TB of the PDSCH #2 uses the first TBS procedure and the third DCI (using 0≤ [symbol] ≤b₂). For Case 1, b₂=27. For Case 2, b₂=26. For Case 3, b₂=28. Other values may be possible.

The third DCI may be the first DCI. The third DCI may schedule/indicate the PDSCH #1 reception. The wireless device may receive the third DCI in a latest PDCCH (monitoring occasion) for the (same) TB, e.g., the initial transmission of the TB that is retransmitted in the PDSCH #2. The third DCI may be transported in the latest PDCCH for the same TB. The third DCI may schedule/indicate reception of the PDSCH #1 with/carrying the (initial transmission of the) TB. For example, the third DCI and the second DCI may indicate the same NDI value. In some cases, the third DCI and the second DCI may indicate the same HARQ process number.

As shown in FIG. 21B, the wireless device may receive the second DCI scheduling PDSCH #2. The PDSCH #2 may carry/be with the TB. For example, the second DCI may schedule the retransmission of the TB transmitted via an SPS PDSCH #m, e.g., the SPS PDSCH #m and the PDSCH #2 carry the same TB (e.g., the TB). The SPS PDSCH #m may be the PDSCH shown in FIG. 20. The wireless device may, corresponding to the PDSCH #2, determine the first MCS condition being satisfied. For example, receiving the SPS PDSCH #1 may be based on the SPS configuration (SPS-Config) of the at least one SPS configuration. The at least one SPS configuration may be configured by the one or more SPS configuration parameters.

As shown in FIG. 21B, the wireless device may receive (prior to receiving the second DCI and/or the PDSCH #2) a fourth DCI activating the SPS configuration. After the SPS configuration being activated (based on the fourth DCI), the wireless device may receive DL data via/using configured DL assignments configured by the SPS configuration and the fourth DCI. The fourth DCI may indicate frequency resources (e.g., “Frequency domain resource assignment” field of the fourth DCI) and/or VRB-to-PRB mapping and/or rate matching indicator for receiving the SPS PDSCH(s) (e.g., SPS PDSDH #0, . . . , SPS PDSCH #m, m=1, 2, . . . ). The fourth DCI may indicate time domain resources (e.g., via a ‘Time domain resource assignment’ field of the activating fourth DCI). The fourth DCI may be CRC scrambled by a CS-RNTI. The fourth DCI may comprise an NDI field with NDI=0.

The wireless device may receive the fourth DCI in a most recent semi-persistent scheduling assignment PDCCH (e.g., activating the SPS configuration). For example, if the wireless device received a fifth DCI prior to receiving the fourth DCI that activates a second SPS configuration of the at least one SPS configuration, the wireless device may ignore the fifth DCI for determining the TBS size of the TB transported in (carried by) the PDSCH #2. For example, the wireless device may determine there is no DCI after the receiving the fourth DCI that activates a third SPS configuration of the at least one SPS configuration.

The second SPS configuration may be different than the SPS configuration.

The second SPS configuration may be the SPS configuration (e.g., re-initializing a DL assignment of the SPS configuration).

The third SPS configuration may be different than the SPS configuration.

The third SPS configuration may be the SPS configuration (e.g., re-initializing a DL assignment of the SPS configuration).

When the SPS configuration is activated (by the fourth DCI), the wireless device may receive a first/starting/earliest/initial SPS PDSCH (the SPS PDSCH #0). The wireless device may receive SPS PDSCHs (e.g., the SPS PDSCH #m) after the first SPS PDSCH. The SPS PDSCHs are received by the wireless device without corresponding PDCCH transmission using the SPS configuration.

The wireless device may determine the first MCS condition being satisfied based on an MCS index corresponding to the PDSCH #2 with the (retransmission of) TB satisfying b₀≤I_{MCS}≤b₁.

Corresponding to Case 1 (e.g., b₀=28, b₁=31 and when the first MCS table is used for the PDSCH #2), the wireless device may determine the first MCS condition being satisfied based on determining that there is no sixth DCI/PDCCH for the TB using 0≤ [symbol] ≤27.

Corresponding to Case 2 (e.g., b₀=27, b₁=31 and when the first MCS table is used for the PDSCH #2), the wireless device may determine the first MCS condition being satisfied based on determining that there is no sixth DCI/PDCCH for the TB using 0≤ [symbol] ≤26.

For example, the wireless device may determine the first MCS condition being satisfied based on determining that there is no sixth DCI/PDCCH for the TB using 0≤ [symbol] ≤28, e.g., excluding Case 1 (e.g., b₀=28, b₁=31 and when the first MCS table is used for the PDSCH #2) and Case 2 (e.g., b₀=27, b₁=31 and when the first MCS table is used for the PDSCH #2).

The wireless device may determine the first MCS condition being satisfied based on determining that there is no sixth DCI/PDCCH for the TB using 0≤ [symbol] ≤28; and based on none of the following being fulfilled/met: the first MCS table is used for the PDSCH #2 and b₀=0, b₁=27; and the second MCS table is used for the PDSCH #2 and b₀=0, b₁=26; and (Case 3) the third MCS table (a table other than 3GPP TS 38.214 Table 5.1.3.1-2 and 3GPP TS 38.214 Table 5.1.3.1-4) of the at least one MCS table is used for the PDSCH #2 and b₀=0, b₁=28.

Optionally, the SPS configuration may correspond to a first symbol/slot type. The first symbol/slot type may be SBFD symbol/slot type or non-SBFD symbol/slot type.

As shown in FIG. 21B, in response to the first MCS condition being satisfied, the wireless device may determine the TBS of the TB of the PDSCH #2 based on/using the fourth DCI (DCI #4 in FIG. 21B) activating the SPS configuration. In response to the first MCS condition being satisfied, the wireless device may determine the TBS of the (retransmission of the) TB of the PDSCH #2 based on/using the first TBS procedure and the fourth DCI. For Case 1, b₂=27. For Case 2, b₂=26. For Case 3, b₂=28. Other values may be possible.

FIG. 22 and FIG. 23 shows examples of downlink receptions in communication systems. Embodiments of FIG. 22 and FIG. 23 may provide examples of a first DL reception procedure. The first DL reception procedure may comprise a decoding procedure for receiving data in DL. Embodiments of FIG. 22 and FIG. 23 may provide one or more details with respect to FIG. 20, FIG. 21A, or FIG. 21B discussed above. Embodiments of FIG. 22 and FIG. 23 may use the first TBS procedure discussed in FIG. 20 for decoding the TB (received data). Embodiments of FIG. 22 and FIG. 23 may use the embodiments discussed in relation with FIG. 21A, or FIG. 21B for decoding the TB (received data) using the retransmitted TBs.

In the example of FIG. 22, the first DL reception procedure comprises decoding procedure when TB size across retransmission(s) and/or initial transmission of the TB is the same, e.g., a TB size of a retransmission of the TB is the same as a TB size of a last (e.g., initial transmission) received data for the TB.

In the example of FIG. 23, the first DL reception procedure comprises decoding procedure when TB size across retransmission(s) and/or initial transmission of the TB is different, e.g., a TB size of a retransmission of the TB is different than a TB size of a last (e.g., initial transmission) received data for the TB.

As shown in FIG. 22 and FIG. 23, the wireless device may receive a first PDSCH (PDSCH #1) with a TB. The first PDSCH may be the PDSCH shown in FIG. 20. The first PDSCH may be the PDSCH #1 shown in FIG. 21A. The first PDSCH may be the SPS PDSCH #m shown in FIG. 21B. Other examples are also possible. The first PDSCH may include/comprise an initial transmission of TB. The TB may comprise a first received data (for the wireless device). The received data may comprise a first MAC PDU and/or a first packet.

The wireless device may determine a first HARQ information corresponding to the first PDSCH (the TB). The first HARQ information comprise a first NDI value, a first HARQ process (with a first HARQ process ID), and a first TBS.

The wireless device may determine the first TBS (TBS 1 in FIG. 22) based on the first TBS procedure as discussed in FIG. 20. In some cases, the wireless device may determine the first TBS using embodiments of FIG. 21A, or FIG. 21B discussed above.

The wireless device may determine there is no previous NDI for the TB (e.g., the received data). Based on the first HARQ information, the wireless device may determine the receiving the first PDSCH corresponding to/associated with a new transmission. For example, the wireless device may determine the received TB (the first received data) being a very first (or earliest/starting/initial) transmission of the TB.

As shown in FIG. 22 and FIG. 23, based on the first received data (for the TB) being the new transmission of the TB, the wireless device may attempt to decode the first received data.

If the wireless device successfully (correctly) decodes the first received data (for the TB), the wireless device may disassemble/demultiplex the (decoded) MAC PDU of the first received data and/or deliver the (decoded) MAC PDU of the first received data to higher layers (e.g., RLC/PDCP) layer. For example, based on successfully (correctly) decoding the first received data (for the TB), the wireless device may instruct the lower layers (e.g., PHY layer) of the wireless device to generate acknowledgment (e.g., ACK) for the TB (e.g., only when the first HARQ process is feedback enabled). For example, the wireless device may (e.g., only when the first HARQ process is feedback enabled) transmit a HARQ-ACK with positive value (the acknowledgment) corresponding to the HARQ process of the TB.

Alternatively or additionally, the wireless device may determine the first received data for the TB not being successfully (correctly) decoded. The wireless device may, based on the first received data for the TB not being successfully (correctly) decoded, (re-)place (or put) the first received data (of the TB) in a first soft buffer. The first soft buffer may be for the TB. For example, based on unsuccessfully (incorrectly) decoding the first received data (for the TB), the wireless device may instruct the lower layers (e.g., PHY layer) of the wireless device to generate acknowledgment (NACK) for the TB (e.g., only when the first HARQ process is feedback enabled). For example, the wireless device may transmit the HARQ-ACK with a negative value (NACK) corresponding to the HARQ process of the TB (e.g., only when the first HARQ process is feedback enabled).

The first soft buffer may store/hold the first received data for the TB. The first soft buffer may correspond to the first HARQ information. The first soft buffer may correspond to (or associated with) the TB. As shown in FIG. 22, the first soft buffer comprises the first received data for the TB. In some cases, the wireless device may, prior to placing/replacing the first received data in the first soft buffer and based on the received TB (the first received data) being the very first (or earliest/starting/initial) transmission of the TB, flush the first soft buffer. By flushing the first soft buffer, the wireless device may delete/remove/discard any data in the soft buffer.

As shown in FIG. 22, the wireless device may receive a second PDSCH (after receiving the first PDSCH). The second PDSCH may comprise/be with a retransmission of the TB. For example, the wireless device may determine the second PDSCH not being the very first received transmission for the TB. The second PDSCH may comprise a second received data for the TB. The second PDSCH may be the PDSCH #2 in FIG. 21A or FIG. 21B. For example, the second PDSCH may correspond to the first HARQ information. The NDI corresponding to the second PDSCH may not being toggled with respect to the NDI corresponding to the first PDSCH. The wireless device may determine the first HARQ information comprise the NDI.

As shown in FIG. 22, the wireless device may (based on the first TBS procedure) determine a TB size corresponding to the retransmitted TB. For example, the TB size corresponding to the retransmitted TB may be the first TBS. The wireless device may use the embodiments of FIG. 21A and/or FIG. 21B to determine the TB size corresponding to the retransmitted TB.

For example, corresponding to the retransmission of the TB (e.g., the second received data) and based on the TB not been successfully decoded, the wireless device may instruct the physical layer to combine the second received data with the first received data currently in the first soft buffer (for the TB). As shown in FIG. 22, the first soft buffer may comprise the combination of the second received data and the first received data. The wireless device may attempt to decode the combined data (e.g., the combination of the second received data and the first received data).

If the wireless device successfully (correctly) decodes the combined data (e.g., the combination of the second received data and the first received data), the wireless device may disassemble/demultiplex the (decoded) MAC PDU of the TB and/or deliver the (decoded) MAC PDU of the TB to higher layers (e.g., RLC/PDCP) layer. For example, based on successfully (correctly) decoding the combined data (for the TB), the wireless device may instruct the lower layers (e.g., PHY layer) of the wireless device to generate acknowledgment (e.g., ACK) for the TB (e.g., only when the first HARQ process is feedback enabled). For example, the wireless device may (e.g., only when the first HARQ process is feedback enabled) transmit the HARQ-ACK with positive value (the acknowledgment) corresponding to the HARQ process of the TB.

Alternatively or additionally, the wireless device may determine the combined data for the TB not being successfully (correctly) decoded. The wireless device may, based on the combined data for the TB not being successfully (correctly) decoded, (re-)place (or put) the second received data (of the TB) in the first soft buffer. For example, based on unsuccessfully (incorrectly) decoding the combined data (for the TB), the wireless device may instruct the lower layers (e.g., PHY layer) of the wireless device to generate acknowledgment (NACK) for the TB (e.g., only when the first HARQ process is feedback enabled). For example, the wireless device may transmit the HARQ-ACK with a negative value (NACK) corresponding to the HARQ process of the TB (e.g., only when the first HARQ process is feedback enabled).

In the example of FIG. 23, the wireless device may (based on the first TBS procedure) determine the TB size corresponding to the retransmitted TB. For example, the TB size corresponding to the retransmitted TB may be a second TBS. The second TBS may be different than the first TBS. The second TBS may be larger than the first TBS. The second TBS may be smaller than the first TBS.

In the existing technologies, when the second TBS (corresponding to the retransmission of the TB) is different than the first TBS (corresponding to the initial transmission of the TB), handing the TB is left up to UE implementation. For the retransmission of the TB, based on the TB not being successfully decoded and the second TBS (corresponding to the second received data) being different than the first TBS (corresponding to the first received data), the wireless device may perform Option 1 or Option 2.

According to Option 1, the wireless device may consider the retransmission of the TB as a new transmission of the TB. In Option 1, as shown in FIG. 23, the wireless device may (based on the TB not been successfully decoded) (re-)place the second received data in the first soft buffer for the TB. The wireless device may (prior to placing the second received data in the first soft buffer), flush the first soft buffer for the TB (e.g., delete/remove the first received data in the first soft buffer).

In Option 1, the wireless device may avoid combining the second received data with the first received data in the soft buffer for the TB. In Option 1, corresponding to the retransmission of the TB (e.g., the second received data) and based on the TB not been successfully decoded, the wireless device may avoid instructing the physical layer to combine the second received data with the first received data currently in the first soft buffer (for the TB). As shown in FIG. 22, In Option 1, the first soft buffer may comprise the second received data.

In Option 1, the wireless device may attempt to decode the second received data. If the wireless device successfully (correctly) decodes the second received data, the wireless device may disassemble/demultiplex the (decoded) MAC PDU of the TB and/or deliver the (decoded) MAC PDU of the TB to higher layers (e.g., RLC/PDCP) layer. For example, based on successfully (correctly) decoding the second received data, the wireless device may instruct the lower layers (e.g., PHY layer) of the wireless device to generate acknowledgment (e.g., ACK) for the TB (e.g., only when the first HARQ process is feedback enabled). For example, the wireless device may (e.g., only when the first HARQ process is feedback enabled) transmit the HARQ-ACK with positive value (the acknowledgment) corresponding to the HARQ process of the TB.

Alternatively or additionally, in Option 1, the wireless device may determine the second received data for the TB not being successfully (correctly) decoded. The wireless device may, based on the second received data for the TB not being successfully (correctly) decoded, instruct the lower layers (e.g., PHY layer) of the wireless device to generate acknowledgment (NACK) for the TB (e.g., only when the first HARQ process is feedback enabled). For example, the wireless device may transmit the HARQ-ACK with a negative value (NACK) corresponding to the HARQ process of the TB (e.g., only when the first HARQ process is feedback enabled).

According to Option 2, the wireless device may discard the second received data (e.g., assume no data is received for the TB). For example, the wireless device may ignore the second PDSCH and/or the second received data for the TB. In Option 2, as shown in FIG. 23, the first soft buffer for the TB comprises the first received data. The wireless device may (based on the TB not been successfully decoded) instruct the lower layers (e.g., PHY layer) of the wireless device to generate acknowledgment (NACK) for the TB (e.g., only when the first HARQ process is feedback enabled). For example, the wireless device may transmit the HARQ-ACK with a negative value (NACK) corresponding to the HARQ process of the TB (e.g., only when the first HARQ process is feedback enabled).

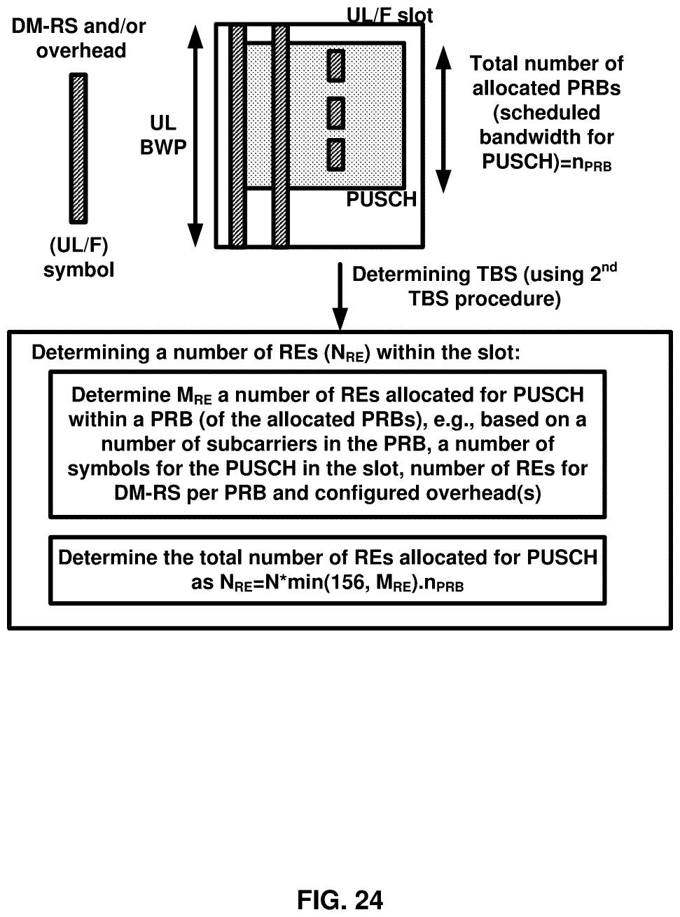

FIG. 24 shows an example flowchart of a procedure for determining a transport block size per an aspect of an embodiment of the present disclosure. Embodiment of FIG. 24 may also show an example of transmitting a PUSCH in time/frequency domain. The wireless device may transmit the PUSCH in an active UL BWP (corresponding to the active DL BWP), e.g., in/during a slot (UL/F slot). For example, the PUSCH transmission may comprise/carry a second TB (or a second MAC PDU), e.g., the PUSCH transmission may be with the second TB.

The second TB may comprise a second MAC PDU. The second TB may comprise one or more packets. The second TB may comprise data of the wireless device.

The wireless device may (for transmitting the second TB) determine a corresponding TB size (TBS) of the second TB based on the procedure (e.g., a second TBS procedure) shown in FIG. 24.

The PUSCH transmission may be without repetitions.

The PUSCH transmission may be with PUSCH repetitions. For example, transmitting the second TB may be based on PUSCH repetition Type B or PUSCH repetition Type A.

The one or more configuration parameters may comprise one or more PUSCH configuration parameters (e.g., PUSCH-Config and/or PUSCH-ServingCellConfig). The PUSCH transmission (transmission power or spatial filter) may be based on the one or more PUSCH configuration parameters. The PUSCH transmission may be based on one or more RACH configuration parameters (e.g., comprising msgA-PUSCH-Config).

The one or more PUSCH configuration parameters (e.g., PUSCH-Config and/or PUSCH-ServingCellConfig) may further configure a number of slots for TB processing (e.g., numberOfSlotsTBoMS). The number of slots for TB processing may correspond to PUSCH transmission over multi-slot. For example, the wireless device may determine the number of slots for TB processing is 1 (when the numberOfSlotsTBoMS is not configured).

The one or more configuration parameters may comprise one or more CG configuration parameters. The one or more CG configuration parameters may configure/indicate at least one CG configuration (e.g., configuredGrantConfig). For example, the CG configuration may comprise a Type 1 CG configuration (rrc-ConfiguredUplinkGrant). The PUSCH transmission may be based on the one or more CG configuration parameters (e.g., a CG configuration of the at least one CG configuration).

The PUSCH transmission may be scheduled/triggered/indicated by a first DL command/message (not shown in FIG. 24). The first DL command (or message or signal) may be a first DCI. The first DL command may be/comprise a RAR message or a fallback RAR message (scheduling/indicating a Msg3 PUSCH transmission, e.g., the PUSCH is the Msg3 PUSCH). The wireless device may receive the first DL command comprising a scheduling grant (an UL grant) for transmitting the PUSCH. The UL grant may be dynamically indicated by the first DL command.

In some examples, the UL grant may be a configured UL grant (e.g., CG grant Type 2), e.g., the PUSCH may be a CG PUSCH (e.g., a CG Type 2 PUSCH). For example, the first DCI may activate the CG Type 2 PUSCH transmission (e.g., activates the CG configuration). The CG configuration may be a Type 2 CG configuration (e.g., when configuredGrantConfig does not include the rrc-ConfiguredUplinkGrant). Type 2 CG configuration may also be referred to by a CG Type 2 configuration.

In another example, the PUSCH may be a CG PUSCH. In one example, the CG PUSCH may be based on a CG Type 1 PUSCH. The CG configuration may be a Type 1 CG configuration (e.g., when configuredGrantConfig includes rrc-ConfiguredUplinkGrant). Type 1 CG configuration may also be referred to by a CG Type 1 configuration.

In yet another example, the PUSCH may be a MsgA PUSCH. For example, the wireless device may transmit the PUSCH based on the one or more PRACH configuration parameters (e.g., msgA-PUSCH-Config and/or msgA-MCS).

For example, for transmitting the second TB (or the PUSCH), the wireless device may (corresponding to the second TB) determine at least one of the following: a modulation order (Qₘ), a target code rate (R), a redundancy version (RV), the TBS (based on the second TBS procedure). A modulation and coding scheme (MCS) field of the first DL command may indicate the modulation order and/or the target code rate. For example, the MCS field of the first DCI may indicate an MCS index I_{MCS}. An RV field of the first DL command may indicate the RV used for transmitting the PUSCH. The wireless device may, for the indicated MCS index, determine the TBS of the second TB.

In some cases (e.g., for the CG Type 1 PUSCH transmission), the wireless device may determine the modulation order (Qₘ), the target code rate (R), the redundancy version (RV), the TBS using the one or more CG configuration parameters (e.g., CG Type 1 configuration).

The one or more configuration parameters (e.g., configuredGrantConfig and/or PUSCH-Config) may comprise at least one second MCS table, e.g., mcs-Table in the one or more CG configuration parameters (configuredGrantConfig) and/or mcs-Table in the PUSCH-config and/or msgA-MCS in the one or more RACH configuration parameters. For example, the wireless device may determine the modulation order (Qₘ) and the target code rate (R) based on the MCS index I_{MCS} (indicated by the first DL command and/or the one or more CG configuration parameters) and/or the at least one second MCS table.

The wireless device may determine allocated frequency resources (a second allocated PRBs in the active UL BWP) for the transmission of the PUSCH based on a frequency domain allocation filed (e.g., frequencyDomainAllocation) in the CG configuration (e.g., the CG Type 1 configuration) and/or a FDRA value indicated by the first DL command (e.g., the first DCI, or the RAR message, or the fallback RAR message). The allocated frequency resources may comprise resource block assignment in frequency domain. Three uplink resource allocation schemes type 0, type 1 and type 2 may be supported for the PUSCH transmission.

The second TBS procedure may comprise determining a second total number of allocated PRBs [symbol] for transmitting the PUSCH. Based on the first DL command (e.g., the FDRA field of the first DL command) and/or the FDRA filed of the CG configuration and/or the one or more PRACH configuration parameters (e.g., msgA-PUSCH-Config), the wireless device may determine second allocated PRBs (e.g., the second total number of allocated PRBs), e.g., [symbol] in FIG. 24. The second allocated PRBs are within the active UL BWP. The wireless device may transmit the PUSCH using/based on the second allocated PRBs. The second allocated PRBs may comprise a second plurality of PRBs, e.g., for transmitting the PUSCH. The second allocated PRBs may be scheduled bandwidth for transmitting the PUSCH. [symbol] may be a size of (e.g., a number of PRBS in) the second plurality of PRBs allocated for the PUSCH.

As shown in FIG. 24, the second TBS procedure may comprise determining a number of REs within the slot (e.g., for transmitting PUSCH) N_{RE}. N_{RE} may be a second total number of REs allocated for the PUSCH. The wireless device may determine the TBS based on N_{RE}.

As shown in FIG. 24, the wireless device may determine the second total number of REs allocated for the PUSCH as [symbol] =N*min(156, M_{RE})·n_{PRB}· [symbol] may be a total number of REs allocated for the PDSCH within a PRB of the plurality of PRBs. The wireless device may determine the [symbol] as

$${M}_{𝕀𝕀} = {N}_{𝕀𝕀}^{RB} \cdot {N}_{symb}^{sh} - {N}_{DMRS}^{PRB} - {N}_{oh}^{PRB} \cdot {N}_{𝕀𝕀}^{RB}$$

may be a number of subcarriers in a physical resource block, e.g.,

$${N}_{𝕀𝕀}^{RB} = 12 \cdot {N}_{𝕀𝕀𝕀𝕀}^{sh}$$

may be a number of symbols of the PUSCH allocation within the slot.

$${N}_{𝕀𝕀𝕀𝕀}^{PRB}$$

may be a number of REs for DM-RS per PRB in a scheduled duration of the PUSCH.

$${N}_{𝕀𝕀𝕀𝕀}^{PRB}$$

may comprise an overhead of the DM-RS CDM groups without data.

$${N}_{oh}^{PRB}$$

may be an overhead indicated by xOverhead in the one or more PUSCH configuration parameters (e.g., PUSCH-ServingCellConfig). In some examples, the wireless device may set

$${N}_{oh}^{PRB}$$

to 0, e.g., if the xOverhead in PUSCH-ServingCellconfig is not configured (a value from 6, 12, or 18), and/or for Msg3 PUSCH transmission and/or for MsgA PUSCH transmission. In case of PUSCH repetition Type B,

$${N}_{𝕀𝕀𝕀𝕀}^{PRB}$$

may be based on a nominal repetition with the duration of L symbols without segmentation. N≥1 may be the number of slots for the TB processing.

Based on determining the TB size (using the second TBS procedure), the wireless device may determine a second HARQ information corresponding to the TB and indicate the HARQ information to higher layers (e.g., MAC layer) of the wireless device. The HARQ information may comprise the TBS size of the second TB, corresponding HARQ process ID, and NDI (whether it is an initial transmission or retransmission). The higher layers of the wireless device may transmit the second TB via the PUSCH transmission.

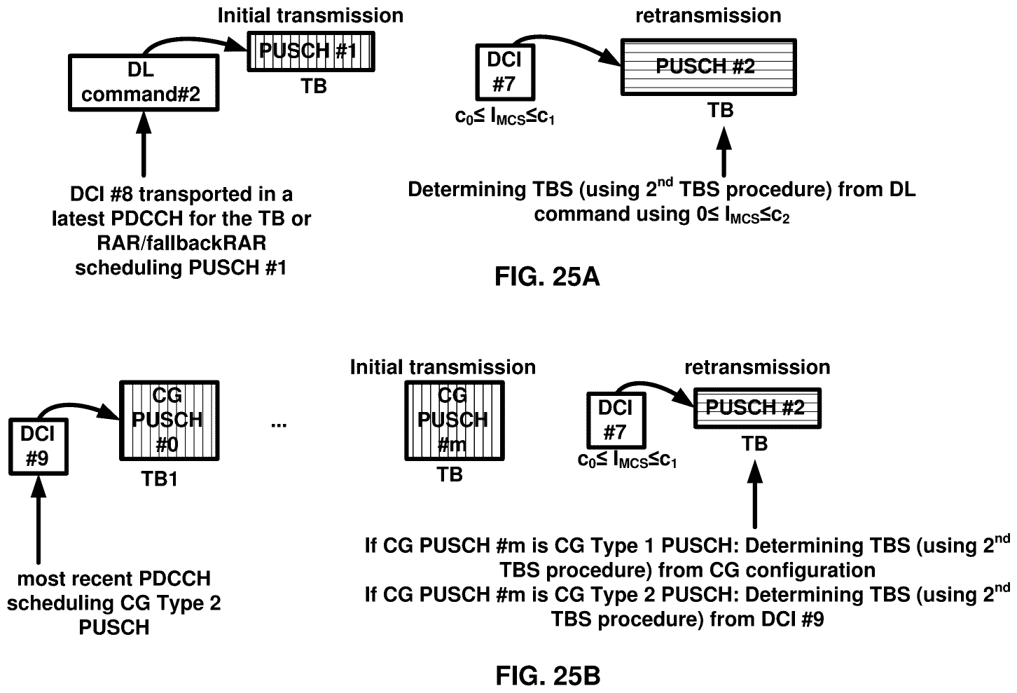

FIG. 25A and FIG. 25B show examples of transport block (TB) size determination for UL transmissions. For example, the wireless device may use the second TBS procedure (discussed in embodiment of FIG. 24 above) for determining the TBS. In some aspects, embodiments of FIG. 25A and FIG. 25B may provide enhancement(s) for the transport block (TB) size determination discussed above, e.g., when a MCS index is larger than a second threshold and/or for retransmission of the TB (provided by the PUSCH in FIG. 24).

For example, when the MCS index is smaller than or equal to the second threshold, the wireless device may use the second TBS procedure for determining the TB size of the TB. When the MCS index is smaller than or equal to the second threshold, the wireless device may determine a second MCS condition not being satisfied.

When the MCS index is larger than the second threshold, the wireless device may use embodiments of FIG. 25A and FIG. 25B. When the MCS index is larger than the second threshold (e.g., for using use the embodiments of FIG. 25A and FIG. 25B), the wireless device may determine the second MCS condition being satisfied.

As shown in FIG. 25A, the wireless device may receive DCI #7 scheduling PUSCH #2 transmission. The PUSCH #2 may carry/be with the second TB. For example, the DCI #7 may schedule a retransmission of the second TB that previously transmitted via a PUSCH #1, e.g., the PUSCH #1 and the PUSCH #2 carry the same second TB (e.g., the second TB). The PUSCH #1 may be the PUSCH shown in FIG. 24. The wireless device may, corresponding to the PUSCH #2, determine the second MCS condition being satisfied.

The wireless device may determine the second MCS condition not being satisfied based on the MCS index corresponding to the PUSCH #2 with the (retransmission of) TB satisfying 0≤ [symbol] c₂ where the second threshold is c₂. The wireless device may determine the second MCS condition not being satisfied based on 0≤ [symbol] ≤27 (e.g., the second threshold is 28) and transform precoding being disabled for the PUSCH #2 and the first MCS table being used for the PUSCH #2. The wireless device may determine the second MCS condition not being satisfied based on 0≤ [symbol] ≤28 (e.g., the second threshold is 29) and transform precoding being disabled for the PUSCH #2 and the first MCS table not being used for the PUSCH #2. The wireless device may determine the second MCS condition not being satisfied based on 0≤ [symbol] ≤27 (e.g., the second threshold is 28) and transform precoding being enabled for the PUSCH #2. Based on the second MCS condition not being satisfied, the wireless device may determine the TBS of the second TB (transmission via the PUSCH #2) using the second TBS procedure.

For example, the wireless device may determine the second MCS condition being satisfied based on the MCS index corresponding to the PUSCH #2 with the (retransmission of) TB satisfying c₀≤I_{MCS}≤c₁. The wireless device may determine the second MCS condition being satisfied based on at least one of the following being fulfilled/met: (Case 4) c₀=28, c₁=31 (e.g., the second threshold is 28) and when a first MCS table (e.g., 3GPP TS 38.214 Table 5.1.3.1-2, e.g., MCS table 2 for PDSCH) of the at least one MCS table is used for the PUSCH #2 and transform precoding for PUSCH #2 is disabled; or (Case 5) c₀=28, c₁=31 (e.g., the second threshold is 28) and the transform precoding is enabled for the PUSCH #2.

The wireless device may determine the second MCS condition being satisfied based on the MCS index being larger than 32 (e.g., the second threshold is 32).

As shown in FIG. 25A, based on the second MCS condition being satisfied, the wireless device for determining the TBS of the second TB in the PUSCH #2 uses/considers a DL command (or message) #2 (DCI #8 in FIG. 25A) for the initial transmission of the TB using 0≤ [symbol] ≤c₂ where c₂=27 or 28. Based on the second MCS condition being satisfied, the wireless device for determining the TBS of the (retransmission of the) second TB in the PUSCH #2 uses the second TBS procedure and the DL command #2 (using 0≤ [symbol] ≤c₂). For Case 1, c₂=27. For Case 2, c₂=27. For some cases, c₂=28. Other values may be possible.

The DL command #2 may be the DCI #8. The DCI #8 may be the first DCI. The DL command #2 may schedule/indicate the PUSCH #1 transmission. The wireless device may receive the DCI #8 in a latest PDCCH (monitoring occasion) for the (same) second TB, e.g., the initial transmission of the second TB transmitted in the PUSCH #1. The DCI #8 may be transported in the latest PDCCH for the same second TB. The DCI #8 may schedule/indicate transmission of the PUSCH #1 with/carrying the (initial transmission of the) second TB. For example, both the DCI #8 and the DCI #7 may indicate the same NDI value. In some cases, both the DCI #8 and the DCI #7 may indicate the same HARQ process number. Based on the second MCS condition being satisfied, the wireless device for determining the TBS of the (retransmission of the) second TB in the PUSCH #2 uses the second TBS procedure and the DCI #8 (using 0≤ [symbol] ≤c₂).

The DL command #2 may be a second RAR/fallback RAR message. The second RAR/fallback RAR message may be the RAR message or the fallback RAR message scheduling transmission of the PUSCH #1. The wireless device may further determine there is no DCI #8 for the same second TB using 0≤ [symbol] ≤c₂. Based on the second MCS condition being satisfied, the wireless device for determining the TBS of the (retransmission of the) second TB in the PUSCH #2 uses the second TBS procedure and the second RAR/fallback RAR message (using 0≤ [symbol] ≤c₂).

As shown in FIG. 25B, the wireless device may receive the second DL command (the DL command #2) scheduling the PUSCH #2. The PUSCH #2 may carry/be with the second TB. For example, the second DL command may schedule the retransmission of the second TB that is previously transmitted via a CG PUSCH #m, e.g., the CG PUSCH #m and the PUSCH #2 carry the same second TB. The transmission of the CG PUSCH #m may be based on the CG Type 1/Type 2 configuration. The CG PUSCH #m may be the PUSCH shown in FIG. 24.

The wireless device may determine the TBS of the second TB using/from the CG configuration based on: the second MCS being satisfied; and the PUSCH #m (for the initial transmission of the second TB) being transmitted using the CG UL grant (indicated by the CG configuration), and there is no PDCCH for the second TB using 0≤ [symbol] ≤c₂ (c₂=27 or 28).

The wireless device may determine the TBS of the second TB using/from the CG Type 1 configuration based on: the second MCS being satisfied; and the PUSCH #m (for the initial transmission of the second TB) being transmitted using the CG UL grant (indicated by the CG Type 1 configuration), and there is no PDCCH for the second TB using 0≤I_{MCS}≤c₂ (c₂=27 or 28).

The wireless device may determine the TBS of the second TB using/from a DCI #9 activating the CG Type 2 configuration based on: the second MCS being satisfied; and the PUSCH #m (for the initial transmission of the second TB) being transmitted using the CG UL grant (indicated by the CG Type 2 configuration), and there is no PDCCH for the second TB using 0≤ [symbol] ≤c₂ (c₂=27 or 28). As shown in FIG. 25B, the CG PUSCH transmission may be activated based on the DCI #9 (e.g., when the CG configuration is the CG Type 2 configuration).

As shown in FIG. 25B, the wireless device may receive (prior to receiving the DCI #7 and/or the transmission of the CG PUSCH #m) the DCI #9 activating the CG Type 2 configuration. After the CG Type 2 configuration being activated (based on the DCI #9), the wireless device may transmit UL data via/using configured UL grant configured by the CG Type 2 configuration and the DCI #9. The DCI #9 may indicate frequency resources (e.g., “Frequency domain resource assignment” field of the DCI #9) and/or VRB-to-PRB mapping or transmitting the CG PUSCH(s) (e.g., CG PUSDH #0, . . . , CG PUSCH #m, m=1, 2, . . . ). The DCI #9 may indicate time domain resources (e.g., via a ‘Time domain resource assignment’ field of the activating DCI #9). The DCI #9 may be CRC scrambled by a CS-RNTI. The DCI #9 may comprise an NDI field with NDI=0.

The wireless device may receive the DCI #9 in a most recent PDCCH scheduling/activating/triggering the CG Type 2 configuration. For example, if the wireless device received a DCI #10 (prior to receiving the DCI #9) that activates a second CG Type 2 configuration of the at least one CG configuration, the wireless device may ignore the DCI #10 for determining the TBS size of the second TB transported in (carried by) the PUSCH #2. For example, the wireless device may determine there is no DCI after receiving the DCI #9 that activates a third CG Type 2 configuration of the at least one CG configuration.

The second CG Type 2 configuration may be different than the CG Type 2 configuration.

The second CG Type 2 configuration may be the CG Type 2 configuration.

The third CG Type 2 configuration may be different than the CG Type 2 configuration.

The third CG Type 2 configuration may be the CG Type 2 configuration.

When the CG Type 2 configuration is activated (by the DCI #9), the wireless device may transmit a first/starting/earliest/initial CG PUSCH (the CG PUSCH #0). The wireless device may transmit CG PUSCHs (e.g., the CG PUSCH #m) after the first CG PUSCH. The wireless device may transmit CG PUSCHs without corresponding PDCCH transmission and using the CG Type 2 configuration.

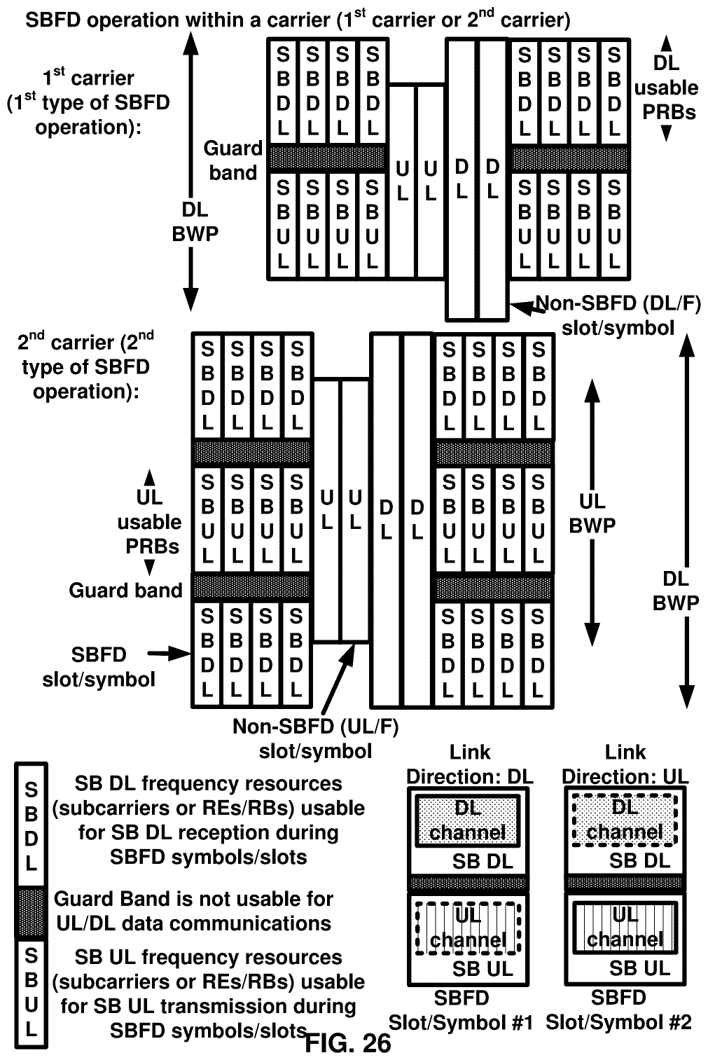

FIG. 26 shows an example of sub-band full-duplex (SBFD) operation as per an aspect of an embodiment of the present disclosure. FIG. 26 shows two examples of SBFD operations in a carrier. Other examples are also possible. The carrier may be a TDD carrier. The carrier may be an FDD carrier. Using the SBFD operation, a wireless device may reduce UL transmission latency or UL transmission capacity, as the wireless device may be allowed/configured to transmit UL signals/channels in/during SBFD symbols/slots.

The SBFD symbols/slots are the DL slots/symbols (configured by the one or more configuration parameters) configured/indicated for the SBFD operation.

The one or more configuration parameters may configure a wireless device with the SBFD operation in the carrier. The one or more configuration parameters may comprise one or more SBFD configuration parameters. The one or more TDD configuration parameters may comprise one or more SBFD configuration parameters.

The wireless device may be in an RRC connected state. For example, the one or more SBFD configuration parameters may configure/enable the wireless device for the SBFD operation only when the wireless device is in the RRC connected state. The wireless device may perform a handover procedure (to handover from a source cell of the one or more serving cells to a target cell) based on the one or more SBFD configuration parameters.

Optionally or alternatively, the wireless device may be in an RRC idle/inactive state. For example, the one or more SBFD configuration parameters may configure/enable the wireless device for the SBFD operation only when the wireless device is in the RRC idle/inactive state. For example, during the RRC idle/inactive state of the wireless device, the wireless device may perform an initial access procedure (e.g., a random access procedure for the initial access) based on the one or more SBFD configuration parameters. For example, during the RRC idle/inactive state of the wireless device, the wireless device may perform a small data transmission (SDT) procedure based on the one or more SBFD configuration parameters. For example, during the RRC idle/inactive state of the wireless device, the wireless device may perform SRS transmission for positioning procedure based on the one or more SBFD configuration parameters.

The one or more SBFD configuration parameters may comprise one or more cell-specific (or common) SBFD configuration parameters.

The one or more SBFD configuration parameters may comprise one or more UE-specific (or dedicated) SBFD configuration parameters.

The one or more SBFD configuration parameters may configure one or more SBFD subbands. The one or more SBFD configuration parameters may configure/indicate a SBFD subband time locations of a SBFD subband (of the one or more SBFD subbands). The one or more SBFD configuration parameters may configure/indicate a SBFD subband frequency locations of the SBFD subband. For example, the SBFD subband time locations may be within a first period. The first period may be a SBFD period (or a SBFD periodicity).

The first period may be based on the at least one TDD pattern. For example, the first period may be the TDD periodicity. The first period may be larger than the TDD periodicity. The first period may be smaller than the TDD periodicity. The one or more SBFD configuration parameters may indicate/configure the first period.

The first period may be equal to a multiplication of a second value and the TDD periodicity. The one or more SBFD configuration parameters may indicate/configure the second value.

The first period may be based on the first TDD pattern. For example, the first period may be the first TDD periodicity P₁ (of the first TDD pattern). Based on the one or more SBFD configuration parameters not indicating the first period, the wireless device may set the first period to a default value. The default value may be the first TDD periodicity.

The first period may be based on the second TDD pattern. For example, the first period may be the second TDD periodicity P₂ (of the second TDD pattern). Based on the one or more SBFD configuration parameters not indicating the first period, the wireless device may set the first period to the default value. The default value may be the second TDD periodicity.

In some examples, the default value may be a summation of the first TDD periodicity P₁ and the second TDD periodicity P₂.

The one or more SBFD configuration parameters may further configure/indicate a second period. The second period may correspond to the second TDD pattern. The first period may correspond to the first TDD pattern. When the second period is absent from the one or more SBFD configuration parameters (e.g., the one or more SBFD configuration parameters not indicating the second period), the wireless device may determine the SBFD subband(s) is only configured within/correspond to the first TDD pattern.

In another example, when the second period is absent from the one or more SBFD configuration parameters (e.g., the one or more SBFD configuration parameters not indicating the second period), the wireless device may determine the SBFD subband(s) is configured within/correspond to the first TDD pattern and the second TDD pattern.

In another example, when the first period is absent from the one or more SBFD configuration parameters (e.g., the one or more SBFD configuration parameters not indicating the second period), the wireless device may determine the SBFD subband(s) is only configured within/correspond to the second TDD pattern and the second TDD pattern.

In another example, when the first period is absent from the one or more SBFD configuration parameters (e.g., the one or more SBFD configuration parameters not indicating the second period), the wireless device may determine the SBFD subband(s) is only configured within/correspond to the second TDD pattern.

The one or more SBFD configuration parameters may indicate that a slot/symbol of a set of slots/symbols comprise of at least one SBFD slot/symbol. The one or more SBFD configuration parameters may indicate that a slot/symbol of the set of slots/symbols comprise of at least one non-SBFD slot/symbol. The plurality of slots may comprise the set of slots/symbols. A slot/symbols of the set of slots/symbols may be a DL slot (of the one or more DL slots) or a flexible slot (of the one or more flexible slots/symbols).

An SBFD slot/symbol of the at least one SBFD slot/symbol may be a DL slot/symbol (of the one or more DL slots/symbols) or a flexible slot/symbol (of the one or more flexible slots/symbols) configured for the SBFD operation. The SBFD slot/symbol may be within the SBFD time locations.

A non-SBFD slot/symbol of the at least one non-SBFD slot/symbol may be a DL slot/symbol (of the one or more DL slots) or an UL slots/symbol (of the one or more UL slots/symbols) or a flexible slot/symbol (of the one or more flexible slots/symbols). The non-SBFD symbol/slot may not be within the SBFD time locations.

For the SBFD subband frequency locations, FIG. 26 provides two examples (or configurations). As shown in FIG. 26, a maximum number of UL sub-bands (UL SBs) for SBFD operation in an SBFD symbol within a TDD carrier is one.

A first example may correspond to a first (TDD) carrier. An UL subband in an SBFD symbol/slot may be located at one side of the first carrier. The first example may be referred to by a first type of SBFD operation. In the first type of the SBFD operation, the SBFD symbol/slot (e.g., a first type of SBFD symbol/slot) may correspond to/comprise a D-U or a U-D partitioning/configuration of frequency resources of the SBFD symbol/slot. The carrier may be the first carrier.

A second example may correspond to a second (TDD) carrier. An UL subband in an SBFD symbol/slot may be located at the middle part of the second carrier. The second example may be referred to by a second type of SBFD operation. In the second type of the SBFD operation, the SBFD symbol/slot (e.g., a second type of SBFD symbol/slot) may correspond to/comprise a D-U-D partitioning/configuration of frequency resources of the SBFD symbol. The carrier may be the second carrier.

The D-U or the U-D or the D-U-D partitioning of the frequency resources of the SBFD symbol may provide/indicate examples of the SBFD subband frequency location(s). The one or more SBFD configuration parameters may indicate/configure the SBFD subband frequency location(s). The SBFD subband frequency location(s) may correspond to each SBFD symbol/slot within the SBFD subband time locations.

The SBFD symbol/slot may comprise an UL subband and at least one DL subband. The one or more SBFD configuration parameters may configure/indicate the SBFD subband frequency locations. The SBFD subband frequency locations may comprise frequency locations of UL subband and/or frequency locations of DL subband(s) (e.g., the at least one DL subband). The frequency locations of the UL subband may comprise at least one subband frequency-domain resources (e.g., PRBs or REs).

The frequency locations of UL subband may comprise a first set of resource blocks (RBs). The first set of RBs may comprise a first set of resource elements (REs). The first set of resource blocks may comprise/be UL subband frequency resources. The first set of resource blocks may correspond to at least a cell-specific UL subband and/or a UE-specific UL subband.

The frequency locations of DL subband(s) may comprise a second set of resource blocks (RBs). The second set of RBs may comprise a second set of resource elements (REs). The second set of resource blocks may comprise/be DL subband frequency resources. The second set of resource blocks may correspond to at least cell-specific DL subband(s) and/or UE-specific DL subband(s). The DL subband(s) frequency resources may comprise/indicate (or be) the frequency locations of DL subband(s).

In one example, the one or more SBFD configuration parameters may configure/indicate the first set of RBs and the second set of RBs. The wireless device may determine/derive a third set of resource blocks (RBs) corresponding to frequency locations of Guardband(s). The frequency locations of Guardband(s) are not within the UL subband or DL subband(s). The third set of RBs may comprise a third set of REs.

In another example, the one or more SBFD configuration parameters may configure/indicate the first set of RBs and the third set of RBs. The wireless device may determine/derive the second set of resource blocks (RBs), e.g., by excluding the first set of RBs and the third set of RBs from RBs of an active DL BWP (or the carrier).

In yet another example, the one or more SBFD configuration parameters may configure/indicate the second set of RBs and the third set of RBs. The wireless device may determine/derive the first set of resource blocks (RBs), e.g., by excluding the second set of RBs and the third set of RBs from RBs of an active UL BWP (or the carrier). The active UL BWP may correspond to/associated with the active DL BWP.

Union of the first set of RBs, the second set of RBs, and the third set of RBs may comprise the RBs of the active DL BWP (or the carrier). The first set of RBs may belong to RBs of the active UL BWP.

The second set of resource blocks/resource elements may comprise contiguous resource blocks/elements (e.g., for the D-U or U-D partitioning of the frequency resources) or non-contiguous blocks/elements (e.g., D-U-D partitioning of the frequency resources).

The third set of resource blocks/elements may be contiguous, e.g., when only one Guardband (e.g., the D-U or U-D partitioning of the frequency resources) is configured in the SBFD symbol/slot. The set of third resource blocks/elements may be non-contiguous, e.g., when at least two Guardbands (e.g., D-U-D partitioning of the frequency resources) are configured in the SBFD symbol/slot.

The one or more SBFD configuration parameters may indicate/configure Guardband(s) to reduce interference leakage between/among UL transmissions in the UL subband frequency resources in the SBFD symbol(s)/slot(s) (at a wireless device or a base station) and DL receptions in the DL subband frequency resources in the SBFD symbol(s)/slot(s) (at the wireless device or the base station).

As also shown in FIG. 26, the UL subband frequency resources (e.g., the first set of RBs) within the active UL BWP may also be referred to by UL usable PRBs. The UL usable PRBs may comprise UL usable resource blocks/elements. The wireless device may determine the UL usable PRBs (or the first set of RBs) as an intersection between the UL subband frequency resources and the active UL BWP in the SBFD symbol(s)/slot(s).

The DL subband(s) frequency resources (e.g., the second set of RBs) within the active DL BWP may also be referred to by DL usable PRBs. The DL usable PRBs may comprise DL usable resource blocks/elements. The wireless device may determine the DL usable PRBs as an intersection between the DL subband(s) frequency resources and active DL BWP in the SBFD symbol(s)/slot(s).

In some examples, the one or more SBFD configuration parameters may (explicitly or implicitly) configure/indicate the UL/DL usable PRBs within the active UL/DL BWP in the SBFD symbol(s)/slot(s).

The wireless device may use the UL usable PRBs for UL transmissions (e.g., transmission of UL signals/channels) during the at least one SBFD symbol/slot. During the at least one SBFD symbol/slot, DL receptions outside of the DL usable PRBs may not be allowed, e.g., the wireless device may not use the UL usable PRBs and/or the Guardband(s) for DL receptions during the at least one SBFD symbol/slot.

The wireless device may use the DL usable PRBs for DL receptions (e.g., reception of DL signals/channels) during at least one SBFD symbol/slot. UL transmissions outside the UL usable PRBs may not be allowed, e.g., the wireless device may not use the DL usable PRBs and/or the Guardband(s) for UL transmissions during at least one SBFD symbol/slot.

For example, a maximum number of UL sub-bands (UL SBs) for SBFD operation in an SBFD symbol within a TDD carrier is a first number. The one or more SBFD configuration parameters may configure/indicate the first number. When the first number is absent/missing from the one or more SBFD configuration parameters, the wireless device may consider a default value for the first number. The default value may be one.

For example, the first number may be one. The first number may be more than one. The first number may be greater than or equal to one. In one example, if the first number is set to zero, the wireless device may consider/assume the SBFD symbol/slot as a DL symbol/slot or a flexible symbol/slot. In another example, if the first number is set to zero, the wireless device may consider/assume the SBFD symbol/slot as an UL symbol/slot.

As also shown in FIG. 26, the wireless device may determine a link direction (e.g., a DL link direction or an UL link direction) during/in (or corresponding to) a SBFD symbol/slot. The SBFD symbol/slot may comprise both the DL usable PRBs and the UL usable PRBs. By determining the link direction during/in the SBFD symbol/slot the wireless device may determine whether to receive DL signals/channels using/via the DL usable PRBs during/in the SBFD symbol/slot or transmit UL signals/channels using/via the UL usable PRBs during/in the SBFD symbol/slot.

As shown in FIG. 26, when the link direction is the DL link direction corresponding to/in a SBFD symbol/slot #1 (of the at least one SBFD symbol/slot), the wireless device may determine to receive DL signals/channels using/via the DL usable PRBs during/in the SBFD symbol/slot #1.

As shown in FIG. 26, when the link direction is the UL link direction corresponding to/in a SBFD symbol/slot #2 (of the at least one SBFD symbol/slot), the wireless device may determine to transmit UL signals/channels using/via the UL usable PRBs during/in the SBFD symbol/slot #2.

The link direction of an SBFD symbol/slot of the at least one SBFD symbol/slot may be semi-statically configured/indicated by the one or more SBFD configuration parameters. The wireless device may determine the link direction (e.g., the DL link direction or the UL link direction) corresponding to the SBFD symbol/slot based on the one or more SBFD configuration parameters (e.g., explicit or semi-static manner/approach/technique). The one or more SBFD configuration parameters may indicate/configure the link direction of the SBFD symbol/slot semi-statistically (not dynamically). For example, the one or more SBFD configuration parameters indicate/configure a first bitmap. The first bitmap may indicate/configure the link direction of a first set of SBFD slot(s)/symbol(s) (e.g., comprising the SBFD symbol/slot #1), within the SBFD time locations, as the DL link direction. The first bitmap may indicate/configure the link direction of a second set of SBFD slot(s)/symbol(s) (e.g., comprising the SBFD symbol/slot #2), within the SBFD time locations, as the UL link direction. The first bitmap may be applicable for the first period and/or the second period. Union of the first set of SBFD slots/symbols and the second set of SBFD slots/symbols may comprise (all) SBFD symbols/slots configured/indicated within the SBFD time locations.

In another example, the wireless device may determine the link direction (e.g., the DL link direction or the UL link direction) corresponding to the SBFD symbol/slot #1 based on a scheduling indication (e.g., dynamically). For example, the scheduling indication (e.g., RRC or DCI) may indicate reception of DL signals/channels during an SBFD symbol/slot #1 of the at least one SBFD symbol/slot. The wireless device may, based on the scheduling indication, determine the link direction of the SBFD symbol/slot #1 is the DL link direction. For example, the determining the link direction of the SBFD symbol/slot #1 as the DL link direction may further based on the one or more SBFD configuration parameters indicating/configuring (semi-statistically) the link direction corresponding to the SBFD symbol/slot #1 as the DL link direction.

In one case, the one or more SBFD configuration parameters may not indicate/configure (semi-statistically) the link direction corresponding to the SBFD symbol/slot #1. For example, the scheduling indication (e.g., RRC or DCI) may indicate reception of DL signals/channels during an SBFD symbol/slot #1 of the at least one SBFD symbol/slot. The wireless device may, based on the scheduling indication and the one or more SBFD configuration parameters not indicating/configuring (semi-statistically) the link direction corresponding to the SBFD symbol/slot #1, determine the link direction of the SBFD symbol/slot #1 is the DL link direction.

In one case, the one or more SBFD configuration parameters may indicate/configure (semi-statistically) the link direction corresponding to the SBFD symbol/slot #1 as the UL link direction. For example, the scheduling indication (e.g., RRC or DCI) may indicate reception of DL signals/channels during an SBFD symbol/slot #1 of the at least one SBFD symbol/slot. The wireless device may, based on the scheduling indication and the one or more SBFD configuration parameters indicating/configuring (semi-statistically) the UL link direction corresponding to the SBFD symbol/slot #1, determine the link direction of the SBFD symbol/slot #1 is the DL link direction.

The scheduling indication (e.g., RRC or DCI) may indicate transmission of UL signals/channels during an SBFD symbol/slot #2 of the at least one SBFD symbol/slot. The wireless device may, based on the scheduling indication, determine the link direction of the SBFD symbol/slot #2 is the UL link direction. For example, the determining the link direction of the SBFD symbol/slot #2 as the UL link direction may further based on the one or more SBFD configuration parameters indicating/configuring (semi-statistically) the link direction corresponding to the SBFD symbol/slot #2 as the UL link direction.

In one case, the one or more SBFD configuration parameters may not indicate/configure (semi-statistically) the link direction corresponding to the SBFD symbol/slot #2. For example, the scheduling indication (e.g., RRC or DCI) may indicate transmission of UL signals/channels during the SBFD symbol/slot #2 of the at least one SBFD symbol/slot. The wireless device may, based on the scheduling indication and the one or more SBFD configuration parameters not indicating/configuring (semi-statistically) the link direction corresponding to the SBFD symbol/slot #2, determine the link direction of the SBFD symbol/slot #2 is the UL link direction.

In one case, the one or more SBFD configuration parameters may indicate/configure (semi-statistically) the link direction corresponding to the SBFD symbol/slot #2 as the DL link direction. For example, the scheduling indication (e.g., RRC or DCI) may indicate transmission of UL signals/channels during the SBFD symbol/slot #2 of the at least one SBFD symbol/slot. The wireless device may, based on the scheduling indication and the one or more SBFD configuration parameters indicating/configuring (semi-statistically) the DL link direction corresponding to the SBFD symbol/slot #2, determine the link direction of the SBFD symbol/slot #2 is the UL link direction.

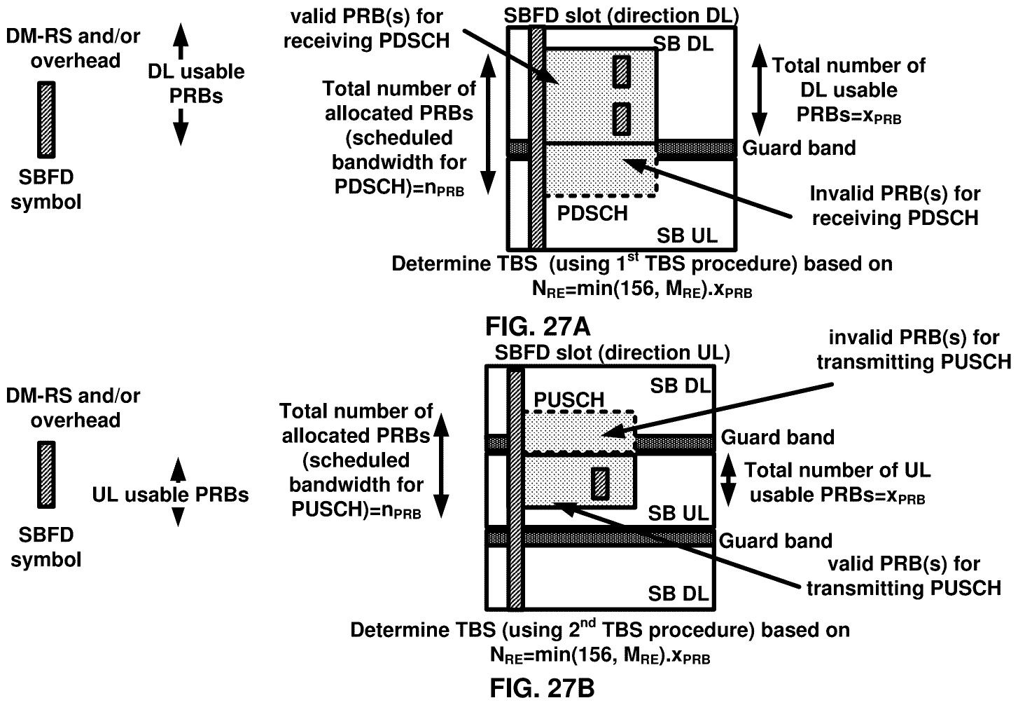

FIG. 27A shows an example of DL receptions in a SBFD slot/symbol as per an aspect of an embodiment of the present disclosure. FIG. 27A may show an example of a TBS determination (using the first TBS procedure) when the wireless device receives a PDSCH in the SBFD slot/symbol of the at least one SBFD symbol/slot. The PDSCH may be an SPS PDSCH. The PDSCH in FIG. 27A may be the PDSCH in FIG. 20.

For example, the wireless device may receive a first DCI scheduling/indicating reception of the PDSCH in the SBFD symbol/slot.

Compared to FIG. 20, receiving the PDSCH is in/within the SBFD symbol/slot while in the embodiment of FIG. 20 receiving the PDSCH is in/during/within the DL/F slot.

In some aspects, embodiment of FIG. 27A provides enhancements for the first TBS procedure for receiving the PDSCH in the SBFD slot/symbol. The wireless device may receive the PDSCH in the SBFD symbol by determining a TB size of a TB (using the first TBS procedure) associated with (carried by) the PDSCH.

For receiving the TB/PDSCH in the SBFD symbol/slot, the wireless device may (corresponding to the TB) determine at least one of the following: a modulation order (Qₘ), a target code rate (R), a redundancy version (RV), the TBS (based on the first TBS procedure). Based on the first DCI (e.g., a FDRA field of the first DCI) and/or the resource allocation scheme, the wireless device may determine the allocated (or assigned) PRBs (e.g., with the total number of allocated PRBs, e.g., [symbol] in FIG. 27A), for receiving the PDSCH in the SBFD symbol/slot. The allocated PRBs may be within the active DL BWP.

For example, the wireless device may determine a first condition being satisfied based on the allocated PRBs for receiving the PDSCH in the SBFD slot/symbol overlapping/colliding with SBFD boundaries (e.g., at least one RE of the plurality of RBs overlapping/colliding with the first set of RBs and/or the third set of RBs). The wireless device may determine the first condition being satisfied based on at least one RE/RB of the plurality of PRBs not being within the DL usable PRBs.

The wireless device may determine the first condition not being satisfied based on the allocated PRBs for receiving the PDSCH in the SBFD slot/symbol not overlapping/colliding with the SBFD boundaries (e.g., no RE of the plurality of REs overlapping/colliding with the first set of RBs and/or the third set of RBs). The wireless device may determine the first condition not being satisfied based on the plurality of PRBs being within the DL usable PRBs.

The wireless device may (e.g., when the first condition is met/satisfied) receive the PDSCH in the SBFD symbol/slot using the allocated PRBs (e.g., the plurality of PRBs) within the DL usable PRBs (e.g., the second set of RBs). As shown in FIG. 27A, the wireless device may, in response to the first condition being satisfied/met, exclude any RB/RE of the plurality of RBs that is not in the DL usable PRBs. In one implementation, (e.g., when the first condition is met/satisfied) the wireless device may consider any RB/RE of the plurality of RBs that is not in the DL usable PRBs as invalid for receiving the PDSCH in the SBFD symbol. In another implementation, (e.g., when the first condition is met/satisfied) the wireless device may consider the allocated PRBs (e.g., the plurality of PRBs) within the DL usable PRBs as valid for receiving the PDSCH in the SBFD symbol.

When the first condition is met/satisfied, the wireless device may avoid suing any RB/RE of the plurality of RBs that is not in the DL usable PRBs for receiving the PDSCH in the SBFD slot/symbol. For example, the wireless device may not use (or avoid using) any RB/RE of the plurality of RBs that is not in the DL usable PRBs for PDSCH resource mapping.

Under/based on the first TBS procedure for receiving PDSCH in DL/F slot (as also discussed above in relation with FIG. 20), the TBS is determined based on the total number of allocated PRBs [symbol] , for receiving the PDSCH in the DL/F slot. In the DL/F slot, [symbol] is the total number of REs allocated for the PDSCH and determined/calculated as/by [symbol] =min(156, M_{RE})·n_{PRB}.

Under/based on the first TBS procedure for receiving PDSCH in the SBFD slot/symbol (as shown in FIG. 27A) and if the first condition is not satisfied, the TBS is determined based on the total number of allocated PRBs [symbol] , for receiving the PDSCH in the SBFD slot/symbol. In the SBFD slot/symbol and when the first condition is not met/satisfied, [symbol] is the total number of REs allocated for the PDSCH and determined/calculated as/by [symbol] =min(156, M_{RE})·n_{PRB}.

Under/based on the first TBS procedure for receiving PDSCH in the SBFD slot/symbol (as shown in FIG. 27A) and if the first condition is satisfied, the TBS is determined based on a total number of DL usable PRBs for receiving the PDSCH. In the SBFD slot/symbol, [symbol] is the total number of REs valid for the PDSCH and calculated/determined as [symbol] =min(156, M_{RE})·x_{PRB}. In the SBFD slot/symbol and when the first condition is met/satisfied, N_{RE} is the total number of REs of the allocated REs within the DL usable SBFD. As shown in FIG. 27A, [symbol] may be a total number of DL usable PRBs allocated for receiving the PDSCH. [symbol] may be a size of (e.g., a number of) the DL usable PRBs (or valid RBs/REs) in the plurality of PRBs allocated for the PDSCH. For example, for determining [symbol] the wireless device may exclude any REs/RBs of the plurality of PRBs (allocated for the PDSCH) colliding/overlapping with the third set of RBs and/or the first set of RBs. For example, for determining [symbol] the wireless device may only consider REs/RBs of the plurality of PRBs (allocated for the PDSCH) that are colliding/overlapping (or are within) with the second set of RBs.

When the allocated PRBs (for receiving the PDSCH in the SBFD slot/symbol) not overlapping with the third set of RBs and/or the first set of RBs (e.g., the first condition is not satisfied), [symbol] = [symbol] . When at least one RE (or RB) of the plurality of PRBs (for receiving the PDSCH in the SBFD slot/symbol) overlaps/collides with the third set of RBs and/or the first set of RBs (e.g., the first condition is satisfied), the wireless device may determine [symbol] <n_{PRB}.

Optionally, in some implementations, when the allocated PRBs (for receiving the PDSCH in the SBFD slot/symbol) overlapping with the third set of RBs and/or the first set of RBs (e.g., the first condition is not satisfied) and the one or more configuration parameters not indicating a fifth parameter, the wireless device may determine [symbol] = [symbol] . For example, the wireless device may rate match the PDSCH in the SBFD slot/symbol around any PRBs/REs of the allocated PRBs overlapping with the third set of RBs and/or the first set of RBs.

When at least one RE (or RB) of the plurality of PRBs (for receiving the PDSCH in the SBFD slot/symbol) overlaps/collides with the third set of RBs and/or the first set of RBs (e.g., the first condition is satisfied) and the one or more configuration parameters indicating the fifth parameter, the wireless device may determine [symbol] <n_{PRB}.

Optionally, in the present disclosure, the one or more configuration parameters may comprise the fifth parameter. The fifth parameter may indicate whether a TBS of a TB (received in an SBFD symbol/slot) is based on the total number of allocated PRBs [symbol] for the PDSCH with the TB or the total number of DL usable PRBs (or valid RBs/REs) in the plurality of PRBs [symbol] .

The fifth parameter may indicate a first value (enabled or true or 1 or configured) or a second value (disabled or false or 0). Using the fifth parameter, alignment between the wireless device and the base station may increase (e.g., for determining the TBS of the TB in the SBFD symbol/slot). In some implementations, when the one or more configuration parameters do not comprise the fifth parameter (e.g., the fifth parameter is absent from the one or more configuration parameters), the wireless device may determine the fifth parameter indicates the second value. When the one or more configuration parameters comprise the fifth parameter (e.g., the fifth parameter is not absent from the one or more configuration parameters), the wireless device may determine the fifth parameter indicates the first value.

In some other implementations, when the one or more configuration parameters do not comprise the fifth parameter (e.g., the fifth parameter is absent from the one or more configuration parameters), the wireless device may determine the fifth parameter indicates the first value. When the one or more configuration parameters comprise the fifth parameter (e.g., the fifth parameter is not absent from the one or more configuration parameters), the wireless device may determine the fifth parameter indicates the second value.

Optionally, in some embodiments of the present disclosure, the wireless device may determine the first condition being satisfied based on the fifth parameter indicating the first value.

Alternatively, in some embodiments of the present disclosure, the wireless device may determine the first condition being satisfied based on the fifth parameter indicating the second value.

Similar to embodiment of FIG. 20, [symbol] may be the total number of REs allocated for the PDSCH within a PRB of the plurality of PRBs. The wireless device may determine the

$$as = {N}_{sc}^{RB} \cdot - {N}_{DMRS}^{PRB} - {N}_{oh}^{PRB} .$$

may be the number of subcarriers in a physical resource block, e.g.,

$$= 12.$$

may be the number of symbols of the PDSCH allocation within the slot. [symbol] may be the number of REs for DM-RS per PRB in a scheduled duration of the PDSCH. [symbol] may comprise the overhead of the DM-RS CDM groups without data.

$${N}_{oh}^{PRB}$$

may be the overhead indicated by xOverhead in
the one or more PDSCH configuration parameters (e.g., PDSCH-ServingCellConfig and/or pdsch-ConfigMulticast).

For example, the wireless device may determine the first condition being met/satisfied based on whether the first set of capabilities comprise at least one SBFD capability or not. The at least one SBFD capability may indicate the wireless device has a capability (e.g., an eleventh capability) for receiving DL signals/channels (e.g., PDSCH/PDCCH/CSI-RS/PRS) in/during the SBFD symbols/slots. The at least one SBFD capability may indicate the wireless device has a capability (e.g., a twelfth capability) for transmitting UL signals/channels (e.g., PRACH/PUSCH/PUCCH/SRS) in/during the SBFD symbols/slots. In response to the first set of capabilities comprising/indicating the at least one SBFD capability, the wireless device may determine the first condition being satisfied. In response to the first set of capabilities not comprising/indicating the at least one SBFD capability, the wireless device may determine the first condition not being satisfied.

For example, the eleventh capability may indicate whether the wireless device has a capability to receive the PDSCH in the SBFD slots/symbols when the allocated PRBs for receiving the PDSCH overlaps/collides with the first set of RBs/REs and/or the third set of RBs/REs.

When the eleventh capability indicates the wireless device has the capability to receive the PDSCH in the SBFD slots/symbols and the allocated PRBs for receiving the PDSCH overlaps/collides with the first set of RBs/REs and/or the third set of RBs/REs (as shown in FIG. 27A), the wireless device determines the first condition is satisfied. The wireless device may receive the PDSCH in the SBFD symbol (using the DL usable PRBs of the plurality of PRBs) based on at least one of the following: the first condition being satisfied; and/or the eleventh capability indicating the wireless device has the capability to receive the PDSCH in the SBFD slots/symbols; and/or the allocated PRBs for receiving the PDSCH overlapping/colliding with the first set of RBs/REs and/or the third set of RBs/REs (as shown in FIG. 27A).

When the eleventh capability does not indicate the wireless device has the capability to receive the PDSCH in the SBFD slots/symbols and the allocated PRBs for receiving the PDSCH overlaps/collides with the first set of RBs/REs and/or the third set of RBs/REs (as shown in FIG. 27A), the wireless device determines the first condition is not satisfied. The wireless device may drop/avoid/ignore receiving (or not receive) the PDSCH in the SBFD symbol based on at least one of the following: the first condition not being satisfied; and the eleventh capability not indicating the wireless device has the capability to receive the PDSCH in the SBFD slots/symbols; and the allocated PRBs for receiving the PDSCH overlapping/colliding with the first set of RBs/REs and/or the third set of RBs/REs.

Optionally, in some embodiments of the present disclosure, the wireless device may determine the first condition not being satisfied based on the allocated PRBs for receiving the PDSCH (in the SBFD symbol/slot) overlapping/colliding with the first set of RBs/REs and/or the third set of RBs/REs ( [symbol] < [symbol] ).

Additionally, the wireless device may determine the first condition being satisfied based on the allocated PRBs for receiving the PDSCH (in the SBFD symbol/slot) not overlapping/colliding with the first set of RBs/REs and/or the third set of RBs/REs ( [symbol] =n_{PRB}).

Optionally, in some embodiments of the present disclosure, the wireless device may determine the first condition not being satisfied based on the DL usable PRBs for receiving the PDSCH (in the SBFD symbol/slot) being a first threshold/offset (Thr) larger than the allocated PRBs for receiving the PDSCH (in the SBFD symbol/slot) ( [symbol] +Thr<n_{PRB}). For example, the wireless device may determine the first condition not being satisfied based on a difference (e.g., in a number of PRBs/subcarriers) between the allocated PRBs within the DL usable SBFD (e.g., x_{PRB}) for receiving the PDSCH (in the SBFD symbol/slot) and the allocated PRBs for receiving the PDSCH (in the SBFD symbol/slot) being greater/larger than the first threshold/offset Thr( [symbol] −x_{PRB}>Thr).

In some embodiments of the present disclosure, the wireless device may determine the first condition being satisfied based on the DL usable PRBs for receiving the PDSCH (in the SBFD symbol/slot) being the first threshold/offset (Thr) smaller/lower than the allocated PRBs for receiving the PDSCH (in the SBFD symbol/slot) ( [symbol] +Thr≥n_{PRB}). For example, the wireless device may determine the first condition being satisfied based on a difference (e.g., in a number of PRBs/subcarriers) between the allocated PRBs within the DL usable SBFD (e.g., x_{PRB}) for receiving the PDSCH (in the SBFD symbol/slot) and the allocated PRBs for receiving the PDSCH (in the SBFD symbol/slot) being smaller/lower than the first threshold/offset Thr ( [symbol] −x_{PRB}≤Thr).

Using the first threshold/offset to determine whether to receive the PDSCH in the SBFD slot/symbol may improve DL spectral efficiency/reliability. For example, the base station may not transmit to the wireless device the PDSCH in the SBFD symbol/slot if the first condition not being satisfied, e.g., [symbol] −x_{PRB}>Thr. When [symbol] −x_{PRB}>Thr a possibility that the wireless device fails to correctly decode a DL data transmitted by the PDSCH (in the SBFD symbol) may increase which may reduce DL spectral efficiency/reliability. For example, the base station may transmit to the wireless device the PDSCH in the SBFD symbol/slot if the first condition being satisfied, e.g., [symbol] −x_{PRB}≤Thr. When [symbol] − [symbol] ≤Thr a possibility that the wireless device correctly decodes the DL data transmitted by the PDSCH (in the SBFD symbol) may increase which may improve DL spectral efficiency/reliability.

The one or more configuration parameter (e.g., the one or more SBFD configuration parameters) may indicate configure the first threshold/offset.

The at least one SBFD capability may be per band. The wireless device that supports (or indicates to the base station) the at least one SBFD capability may be an SBFD-aware UE/wireless device (or an SBFD-capable UE). The wireless device that does not support (or does not indicate to the base station) the at least one SBFD capability may be an SBFD-unaware UE/wireless device.

The at least one SBFD capability may indicate whether the wireless device has a capability (a thirteenth capability) for determine the TBS of the TB based on the total number of allocated PRBs [symbol] or a total number of DL usable PRBs (or valid RBs/REs) in the plurality of PRBs [symbol] . When the first set of capabilities indicate the wireless device has the thirteenth capability, the wireless device may determine the TBS size of the TB (e.g., in the SBFD symbol/slot) based on the total number of DL usable PRBs (or valid RBs/REs) in the plurality of PRBs [symbol] . When the first set of capabilities does not indicate the wireless device has the thirteenth capability, the wireless device may determine the TBS size of the TB (e.g., in the SBFD symbol/slot) based on the total number of allocated PRBs [symbol] .

In some implementations, based on/when the allocated PRBs (for receiving the PDSCH in the SBFD slot/symbol) overlapping with the third set of RBs and/or the first set of RBs (e.g., the first condition is not satisfied) and the first set of capabilities does not indicate the wireless device has the thirteenth capability, the wireless device may determine [symbol] = [symbol] . For example, the wireless device may rate match the PDSCH in the SBFD slot/symbol around PRBs/REs of the allocated PRBs overlapping with the third set of RBs and/or the first set of RBs.

When at least one RE (or RB) of the plurality of PRBs (for receiving the PDSCH in the SBFD slot/symbol) overlaps/collides with the third set of RBs and/or the first set of RBs (e.g., the first condition is satisfied) and the first set of capabilities indicate the wireless device has the thirteenth capability, the wireless device may determine [symbol] <n_{PRB}.

In some other implementations, when the allocated PRBs (for receiving the PDSCH in the SBFD slot/symbol) overlapping with the third set of RBs and/or the first set of RBs (e.g., the first condition is not satisfied) and/or the one or more configuration parameters not indicating the fifth parameter and/or the first set of capabilities does not indicate the wireless device has the thirteenth capability, the wireless device may determine [symbol] = [symbol] . For example, the wireless device may rate match the PDSCH in the SBFD slot/symbol around PRBs/REs of the allocated PRBs overlapping with the third set of RBs and/or the first set of RBs.

When at least one RE (or RB) of the plurality of PRBs (for receiving the PDSCH in the SBFD slot/symbol) overlaps/collides with the third set of RBs and/or the first set of RBs (e.g., the first condition is satisfied) and/or the one or more configuration parameters indicating the fifth parameter and/or the first set of capabilities indicate the wireless device has the thirteenth capability, the wireless device may determine x_{PRB}<n_{PRB}.

In some implementations, when the first set of capabilities comprise either the eleventh capability and/or the twelfth capability, the wireless device may automatically indicate the thirteenth capability. For example, it may be mandatory for the SBFD-aware UE/wireless device to indicate the thirteenth capability.

In other implementations, when the first set of capabilities comprise the thirteenth capability, the wireless device may indicate the wireless device has the thirteenth capability, e.g., the wireless device may determine the TBS size of the TB (e.g., in the SBFD symbol/slot) based on the total number of DL usable PRBs (or valid RBs/REs) in the plurality of PRBs [symbol] .

In other implementations, when the first set of capabilities do not comprise the thirteenth capability, the wireless device may not indicate the wireless device has the thirteenth capability, e.g., the wireless device may determine the TBS size of the TB (e.g., in the SBFD symbol/slot) based on the total number of allocated PRBs [symbol] .

Optionally, the wireless device may determine the first condition being satisfied based on the first set of capabilities comprising/indicating the thirteenth capability.

Alternatively, the wireless device may determine the first condition not being satisfied based on the first set of capabilities not comprising/indicating the thirteenth capability.

FIG. 27B shows an example of UL transmissions in a SBFD slot/symbol as per an aspect of an embodiment of the present disclosure. FIG. 27B may show an example of a TBS determination (using the second TBS procedure) when the wireless device transmits a PUSCH in the SBFD slot/symbol of the at least one SBFD symbol/slot. The PUSCH may be a CG PUSCH. The PUSCH in FIG. 27B may be the PUSCH in FIG. 24.

For example, the wireless device may receive the first DL command (e.g., a first DCI, the RAR message or the fallback RAR message) scheduling/indicating transmission of the PUSCH in the SBFD symbol/slot.

Compared to FIG. 24, transmitting the PUSCH is in/within the SBFD symbol/slot while in the embodiment of FIG. 24 transmitting the PUSCH is in/within the UL/F slot.

In some aspects, embodiment of FIG. 27B provides enhancements for the second TBS procedure for transmitting the PUSCH in the SBFD slot/symbol. The wireless device may transmit the PUSCH in the SBFD symbol by determining a TB size of a second TB (using the second TBS procedure) associated with (carried by) the PUSCH.

For transmitting the second TB in the SBFD symbol/slot, the wireless device may (corresponding to the TB) determine at least one of the following: a modulation order (Qₘ), a target code rate (R), a redundancy version (RV), the TBS (based on the first TBS procedure).

The wireless device may determine the second allocated PRBs (in the active UL BWP) for the transmission of the PUSCH in the SBFD slot/symbol based on a frequency domain allocation filed (e.g., frequencyDomainAllocation) in the CG configuration (e.g., the CG Type 1 configuration) and/or a FDRA value indicated by the first DL command (e.g., the first DCI, or the RAR message, or the fallback RAR message). The second allocated (or assigned) PRBs is with the second total number of allocated PRBs, e.g., [symbol] in FIG. 27B and is used for transmitting the PUSCH in the SBFD symbol/slot. The second allocated PRBs may be within the active UL BWP. The second allocated PRBs may comprise the second plurality of PRBs.

For example, the wireless device may determine a second condition being satisfied based on the second allocated PRBs (or the second plurality of PRBs) for transmitting the PUSCH in the SBFD slot/symbol overlapping/colliding with SBFD boundaries (e.g., at least one RE of the second plurality of RBs overlapping/colliding with the second set of RBs and/or the third set of RBs). The wireless device may determine the second condition being satisfied based on at least one RE/RB of the second plurality of PRBs not being within the UL usable PRBs.

In some cases, based on the first condition being satisfied, the wireless device may determine the second condition being satisfied. Based on the first condition not being satisfied, the wireless device may determine the second condition not being satisfied.

The wireless device may determine the second condition not being satisfied based on the second allocated PRBs for transmitting the PUSCH in the SBFD slot/symbol not overlapping/colliding with the SBFD boundaries (e.g., no RE of the second plurality of RBs overlapping/colliding with the second set of RBs and/or the third set of RBs). The wireless device may determine the second condition not being satisfied based on the second plurality of PRBs being within the UL usable PRBs.

The wireless device may (e.g., when the second condition is met/satisfied) transmit the PUSCH in the SBFD symbol/slot using the second allocated PRBs (e.g., the second plurality of PRBs) within the UL usable PRBs (e.g., the first set of RBs). As shown in FIG. 27B, the wireless device may, in response to the second condition being satisfied/met, exclude any RB/RE of the second plurality of RBs that is not in the UL usable PRBs. In one implementation, (e.g., when the second condition is met/satisfied) the wireless device may consider any RB/RE of the second plurality of RBs that is not in the UL usable PRBs as invalid for transmitting the PUSCH in the SBFD symbol/slot. In another implementation, (e.g., when the second condition is met/satisfied) the wireless device may consider the second allocated PRBs (e.g., the second plurality of PRBs) within the UL usable PRBs as valid for transmitting the PUSCH in the SBFD symbol/slot.

When the second condition is met/satisfied, the wireless device may avoid suing any RB/RE of the second plurality of RBs that is not in the UL usable PRBs for transmitting the PUSCH in the SBFD slot/symbol. For example, the wireless device may not use (or avoid using) any RB/RE of the second plurality of RBs that is not in the UL usable PRBs for PUSCH resource mapping.

Under/based on the second TBS procedure for transmitting the PUSCH in DL/F slot (as also discussed above in relation with FIG. 24), the TBS is determined based on the second total number of allocated PRBs [symbol] for transmitting the PUSCH in the DL/F slot. In the DL/F slot, [symbol] is the second total number of REs allocated for the PUSCH and determined/calculated as/by [symbol] =min(156, M_{RE})·n_{PRB}.

Under/based on the second TBS procedure for transmitting the PUSCH in the SBFD slot/symbol (as shown in FIG. 27B) and if the second condition is not satisfied, the TBS is determined based on the second total number of allocated PRBs [symbol] for transmitting the PUSCH in the SBFD slot/symbol. In the SBFD slot/symbol and when the second condition is not met/satisfied, [symbol] is the second total number of REs allocated for the PUSCH and determined/calculated as/by [symbol] =min(156, M_{RE})·n_{PRB}.

Under/based on the second TBS procedure for transmitting the PUSCH in the SBFD slot/symbol (as shown in FIG. 27B) and if the second condition is satisfied, the TBS is determined based on a total number of the second allocated PRBs within the UL usable PRBs for transmitting the PUSCH. In the SBFD slot/symbol, [symbol] is a second total number of REs valid for the PUSCH in the SBFD slot/symbol and calculated/determined as [symbol] =min(156, M_{RE})·x_{PRB}. In the SBFD slot/symbol and when the second condition is met/satisfied, [symbol] is a total number of REs of the second allocated REs within the UL usable SBFD. As shown in FIG. 27B, [symbol] may be a total number of UL usable PRBs valid for transmitting the PUSCH. [symbol] may be a size of (e.g., a number of) the UL usable PRBs in the second plurality of PRBs allocated for the PUSCH. For example, for determining [symbol] the wireless device may exclude any REs/RBs of the second plurality of PRBs (allocated for the PUSCH) colliding/overlapping with the third set of RBs and/or the second set of RBs. For example, for determining [symbol] the wireless device may only consider REs/RBs of the second plurality of PRBs (allocated for the PUSCH) that are colliding/overlapping (or are within) with the first set of RBs.

When the second allocated PRBs (for transmitting the PUSCH in the SBFD slot/symbol) not overlapping with the third set of RBs and/or the second set of RBs e.g., the second condition is not satisfied), the wireless device may determine [symbol] = [symbol] When at least one RE (or RB) of the second plurality of PRBs (for transmitting the PUSCH in the SBFD slot/symbol) overlaps/collides with the third set of RBs and/or the second set of RBs (e.g., the second condition is satisfied), the wireless device may determine [symbol] <n_{PRB}.

Optionally, in some implementations, the second allocated PRBs (for transmitting the PUSCH in the SBFD slot/symbol) not overlapping with the third set of RBs and/or the second set of RBs (e.g., the second condition is not satisfied) and the one or more configuration parameters not indicating a sixth parameter, the wireless device may determine [symbol] = [symbol] . For example the wireless device may rate match the PUSCH in the SBFD slot/symbol around any PRBs/REs of the allocated PRBs overlapping with the third set of RBs and/or the second set of RBs.

When at least one RE (or RB) of the second plurality of PRBs (for transmitting the PUSCH in the SBFD slot/symbol) overlaps/collides with the third set of RBs and/or the second set of RBs (e.g., the second condition is satisfied) and the one or more configuration parameters indicating the sixth parameter, the wireless device may determine [symbol] <n_{PRB}.

Optionally, in the present disclosure, the one or more configuration parameters may comprise the sixth parameter. The sixth parameter may indicate whether a TBS of a TB (transmitted in an SBFD symbol/slot) is based on the second total number of allocated PRBs [symbol] for the PUSCH with the TB or the total number of UL usable PRBs (or valid RBs/REs) in the second plurality of PRBs [symbol] .

The sixth parameter may indicate a first value (enabled or true or 1 or configured) or a second value (disabled or false or 0). Using the sixth parameter, alignment between the wireless device and the base station may increase (e.g., for determining the TBS of the TB in the SBFD symbol/slot). In some implementations, when the one or more configuration parameters do not comprise the sixth parameter (e.g., the sixth parameter is absent from the one or more configuration parameters), the wireless device may determine the sixth parameter indicates the second value. When the one or more configuration parameters comprise the sixth parameter (e.g., the sixth parameter is not absent from the one or more configuration parameters), the wireless device may determine the sixth parameter indicates the first value.

In some other implementations, when the one or more configuration parameters do not comprise the sixth parameter (e.g., the sixth parameter is absent from the one or more configuration parameters), the wireless device may determine the sixth parameter indicates the first value. When the one or more configuration parameters comprise the sixth parameter (e.g., the sixth parameter is not absent from the one or more configuration parameters), the wireless device may determine the sixth parameter indicates the second value.

Optionally, in some embodiments of the present disclosure, the wireless device may determine the second condition being satisfied based on the sixth parameter indicating the first value.

Alternatively, in some embodiments of the present disclosure, the wireless device may determine the second condition being satisfied based on the sixth parameter indicating the second value.

Similar to embodiment of FIG. 24, [symbol] may be the total number of REs allocated for the PDSCH within a PRB of the plurality of PRBs. The wireless device may determine the

$$as = {N}_{sc}^{RB} \cdot - {N}_{DMRS}^{PRB} - {N}_{oh}^{PRB} .$$

may be the number of subcarriers in a physical resource block, e.g.,

$$= 12.$$

may be the number of symbols of the PUSCH allocation within the slot. [symbol] may be the number of REs for DM-RS per PRB in a scheduled duration of the PUSCH. [symbol] may comprise the overhead of the DM-RS CDM groups without data.

$${N}_{oh}^{PRB}$$

may be the overhead indicated by xOverhead in the one or more PUSCH configuration parameters (e.g., PUSCH-ServingCellConfig).

For example, the wireless device may determine the second condition being met/satisfied based on whether the first set of capabilities comprise the at least one SBFD capability or not. In response to the first set of capabilities comprising/indicating the at least one SBFD capability, the wireless device may determine the second condition being satisfied. In response to the first set of capabilities not comprising/indicating the at least one SBFD capability, the wireless device may determine the second condition not being satisfied.

For example, the twelfth capability may indicate whether the wireless device has a capability to transmit the PUSCH in the SBFD slots/symbols when the second allocated PRBs for transmitting the PUSCH overlaps/collides with the second set of RBs/REs and/or the third set of RBs/REs.

When the twelfth capability indicates the wireless device has the capability to transmit the PUSCH in the SBFD slots/symbols when the second allocated PRBs for transmitting the PUSCH overlaps/collides with the second set of RBs/REs and/or the third set of RBs/REs (as shown in FIG. 27B), the wireless device determines the second condition is satisfied. The wireless device may transmit the PUSCH in the SBFD symbol (using the UL usable PRBs of the second plurality of PRBs) based on the second condition being satisfied; and the twelfth capability indicating the wireless device has the capability to transmit the PUSCH in the SBFD slots/symbols when the second allocated PRBs for transmitting the PUSCH overlaps/collides with the second set of RBs/REs and/or the third set of RBs/REs (.

When the twelfth capability does not indicate the wireless device has the capability to transmit the PUSCH in the SBFD slots/symbols when the second allocated PRBs for transmitting the PUSCH overlaps/collides with the second set of RBs/REs and/or the third set of RBs/REs (as shown in FIG. 27B), the wireless device determines the second condition is not satisfied. The wireless device may drop/avoid/ignore transmitting (or not transmit) the PUSCH in the SBFD symbol based on the second condition not being satisfied; and the twelfth capability not indicating the wireless device has the capability to transmit the PUSCH in the SBFD slots/symbols when the second allocated PRBs for transmitting the PUSCH overlaps/collides with the second set of RBs/REs and/or the third set of RBs/REs.

Optionally, in some embodiments of the present disclosure, the wireless device may determine the second condition not being satisfied based on the second allocated PRBs for transmitting the PUSCH (in the SBFD symbol/slot overlapping/colliding with the second set of RBs/REs and/or the third set of RBs/REs ( [symbol] <n_{PRB}). Additionally, the wireless device may determine the second condition being satisfied based on the second allocated PRBs for transmitting the PUSCH (in the SBFD symbol/slot) not overlapping/colliding with the second set of RBs/REs and/or the third set of RBs/REs ( [symbol] =n_{PRB}).

Optionally, in some embodiments of the present disclosure, the wireless device may determine the second condition not being satisfied based on the UL usable PRBs for transmitting the PUSCH (in the SBFD symbol/slot) being a second threshold/offset (Thr_2) larger than the second allocated PRBs for [symbol] transmitting the PUSCH (in the SBFD symbol/slot) ( [symbol] +Thr₂<n_{PRB}). For example, the wireless device may determine the second condition not being satisfied based on a difference (e.g., in a number of PRBs/subcarriers) between the second allocated PRBs within the UL usable SBFD (e.g., x_{PRB}) for transmitting the PUSCH (in the SBFD symbol/slot) and the second allocated PRBs for transmitting the PUSCH (in the SBFD symbol/slot) being greater/larger than the second threshold/offset Thr_2 ( [symbol] − [symbol] >Thr₂).

In some embodiments of the present disclosure, the wireless device may determine the second condition being satisfied based on the UL usable PRBs for transmitting the PUSCH (in the SBFD symbol/slot) being the second threshold/offset smaller/lower than the second allocated PRBs for transmitting the PUSCH (in the SBFD symbol/slot) ( [symbol] +Thr₂≥n_{PRB}). For example, the wireless device may determine the second condition being satisfied based on a difference (e.g., in a number of PRBs/subcarriers) between the second allocated PRBs within the UL usable SBFD (e.g., x_{PRB}) for transmitting the PUSCH (in the SBFD symbol/slot) and the second allocated PRBs for transmitting the PUSCH (in the SBFD symbol/slot) being smaller/lower than the second threshold/offset ( [symbol] −x_{PRB}≤Thr₂).

Using the second threshold/offset to determine whether to transmit the PUSCH in the SBFD slot/symbol may improve UL spectral efficiency/reliability. For example, the wireless device may not transmit the PUSCH in the SBFD symbol/slot if the second condition not being satisfied, e.g., [symbol] − [symbol] >Thr₂. When [symbol] −x_{PRB}>Thr₂ a possibility that the base station fails to correctly decode an UL data transmitted by the PUSCH (in the SBFD symbol) may increase which may reduce UL spectral efficiency/reliability. For example, the wireless device may transmit the PUSCH in the SBFD symbol/slot if the second condition being satisfied, e.g., [symbol] −x_{PRB}≤Thr₂. When [symbol] −x_{PRB}≤Thr₂ a possibility that the base station correctly decodes the UL data transmitted by the PUSCH (in the SBFD symbol) may increase which may improve UL spectral efficiency/reliability.

The one or more configuration parameter (e.g., the one or more SBFD configuration parameters) may indicate configure the second threshold/offset.

The at least one SBFD capability may indicate whether the wireless device has a capability (a fourteenth capability) for determine the TBS of the TB based on the second total number of allocated PRBs [symbol] or a total number of UL usable PRBs (or valid RBs/REs) in the second plurality of PRBs [symbol] . When the first set of capabilities indicate the wireless device has the fourteenth capability, the wireless device may determine the TBS size of the TB (e.g., in the SBFD symbol/slot) based on the total number of UL usable PRBs (or valid RBs/REs) in the second plurality of PRBs [symbol] . When the first set of capabilities does not indicate the wireless device has the fourteenth capability, the wireless device may determine the TBS size of the TB (e.g., in the SBFD symbol/slot) based on the second total number of allocated PRBs [symbol] .

In some implementations, based on/when the second allocated PRBs (for transmitting the PUSCH in the SBFD slot/symbol) overlapping with the third set of RBs and/or the second set of RBs (e.g., the second condition is not satisfied) and the first set of capabilities does not indicate the wireless device has the fourteenth capability, the wireless device may determine [symbol] = [symbol] For example, the wireless device may rate match the UDSCH in the SBFD slot/symbol around PRBs/REs of the second allocated PRBs overlapping with the third set of RBs and/or the second set of RBs.

When at least one RE (or RB) of the second plurality of PRBs (for transmitting the PUSCH in the SBFD slot/symbol) overlaps/collides with the third set of RBs and/or the second set of RBs (e.g., the second condition is satisfied) and the first set of capabilities indicate the wireless device has the fourteenth capability, the wireless device may determine [symbol] <n_{PRB}.

In some other implementations, when the allocated PRBs (for transmitting the PUSCH in the SBFD slot/symbol) overlapping with the third set of RBs and/or the second set of RBs (e.g., the first condition is not satisfied) and/or the one or more configuration parameters not indicating the sixth parameter and/or the first set of capabilities does not indicate the wireless device has the fourteenth capability, the wireless device may determine [symbol] = [symbol] . For example, the wireless device may rate match the PUSCH in the SBFD slot/symbol around PRBs/REs of the second allocated PRBs overlapping with the third set of RBs and/or the second set of RBs.

When at least one RE (or RB) of the second plurality of PRBs (for transmitting the PUSCH in the SBFD slot/symbol) overlaps/collides with the third set of RBs and/or the second set of RBs (e.g., the second condition is satisfied) and/or the one or more configuration parameters indicating the sixth parameter and/or the first set of capabilities indicate the wireless device has the fourteenth capability, the wireless device may determine [symbol] <n_{PRB}.

In some implementations, when the first set of capabilities comprise either the eleventh capability and/or the twelfth capability, the wireless device may automatically indicate the fourteenth capability.

For example, it may be mandatory for the SBFD-aware UE/wireless device to indicate the fourteenth capability.

In other implementations, when the first set of capabilities comprise the fourteenth capability, the wireless device may indicate the wireless device has the fourteenth capability, e.g., the wireless device may determine the TBS size of the TB (e.g., in the SBFD symbol/slot) based on the total number of UL usable PRBs (or valid RBs/REs) in the second plurality of PRBs [symbol] .

In other implementations, when the first set of capabilities do not comprise the fourteenth capability, the wireless device may not indicate the wireless device has the fourteenth capability, e.g., the wireless device may determine the TBS size of the TB (e.g., in the SBFD symbol/slot) based on the second total number of allocated PRBs [symbol] .

The wireless device may determine the second condition being satisfied based on the first set of capabilities comprising/indicating the fourteenth capability.

The wireless device may determine the second condition not being satisfied based on the first set of capabilities not comprising/indicating the fourteenth capability.

In the present disclosure, an SBFD-aware wireless device refers to a wireless device that has hardware/software capabilities (e.g., a second set of capabilities) for communicating in UL/DL with an SBFD-enabled base station. The SBFD-aware wireless device communicates with the base station based on the SBFD operation. The SBFD-aware wireless device may be half-duplex. The SBFD-aware wireless device may be full-duplex.

In the present disclosure, “SBFD operation” can refer to “SBFD mode” or “SBFD communication mode” or “SBFD frame configuration” or “SBFD reception mode” or “SBFD transmission mode”.

In the present disclosure, “type” can refer to “mode” or “status” or “configuration” or “combination” or “operation” or the like.

In the present disclosure, “partitioning” can refer to “segmentation” or “division” or “split” or “subdivision” or “division” or “part” or “segment” or the like.

In the present disclosure, “subband” can refer to “sub-band”.

In the present disclosure, “Guardband” can refer to “Guard-band” or “guardband” or “guard-band” or “guard band”.

In the present disclosure, “location” can refer to “position” or “point” or “region”.

In the present disclosure, “frequency resources” can refer to “resource blocks” or “resource elements” or “subcarriers” or “bandwidth part”.

In the present disclosure, “overlap” can refer to “collide”.

In the present disclosure, “UL subband frequency resources” can refer to frequency resources that are configure/allocated for UL subband transmissions in the TDD carrier.

In the present disclosure, “DL subband frequency resources” can refer to frequency resources that are configure/allocated for DL subband receptions in the TDD carrier.

In the present disclosure, “UL subband transmissions” can refer to “transmissions using the first set of RBs”.

In the present disclosure, “DL subband receptions” can refer to “receptions using the second set of RBs”.

In the present disclosure, “a cell” may refer to “a serving cell”. A cell may be a PCell, SCell, or a SpCell, or a SPCell.

In the present disclosure, uplink transmissions may refer to transmissions.

In the present disclosure, downlink receptions may refer to receptions.

In the present disclosure, when a slot comprises only SBFD symbols, the slot may be referred to by/as an SBFD slot.

In the present disclosure, when a slot comprises at least one non-SBFD symbol, the slot may be referred to by/as a partial SBFD slot or a partial non-SBFD slot.

In the present disclosure, when a slot comprises only non-SBFD symbols, the slot may be referred to by/as a non-SBFD slot.

In the present disclosure, “allocated PRBs” may refer to “a total number of allocated PRBs” or “scheduled bandwidth” or “assigned PRBs” or “a plurality of PRBs”.

In the present disclosure, “a resource block (RB)” may refer to “a resource element (RE)” or “a subcarrier”. For example, a subcarrier during a unit of time (e.g., a symbol) may be referred to as “a resource element”. For example, “a plurality of PRBs” may refer to “a plurality of REs” or “a plurality of subcarriers”. For example, “a second plurality of PRBs” may refer to “a second plurality of REs” or “a second plurality of subcarriers”.

In the present discloser, “an initial transmission of a TB” may comprise “a last/latest retransmission of the TB”.

In the present disclosure, “a new transmission of the TB” may refer to by “the initial transmission of the TB”. The initial transmission may be the first or earliest or starting transmission for the TB. The wireless device may determine whether a transmission of/for TB is a new transmission or retransmission based on a HARQ information (e.g., HARQ process number and NDI value) corresponding to the TB. The HARQ process number corresponding to the new transmission of/for TB and the retransmission of/for TB is the same. The NDI value corresponding to the new transmission of/for TB and the retransmission of/for TB is the same.

In the present disclosure, “a received data for a TB” may refer to “a received data of the TB” or “a received data by the TB” or “a received data in the TB”.

In the present disclosure, “decoding a TB” may refer to “decoding a received data for the TB”. Decoding the TB may be successful (correct) or unsuccessful (incorrect).

In existing technologies, a wireless device may expect a TBS (TBS 1) of the initial transmission of a TB (in a PDSCH #1) and a TBS (TBS 2) of a retransmission of the TB (in a PDSCH #2) to be equal (or the same). In the first TBS procedure (using the unquantized intermediate variable N_{info} and/or the quantized intermediate number of information bits [symbol] ), even when a second MCS that is used for the PDSCH #2 (for retransmission of the TB) is different than a first MCS index that is used for PDSCH #1 (for the initial transmission of the TB), the TBS 2 stays equal to TBS1. In existing technologies, it is highly impossible (with a probability of less than 10⁻⁶) that the TBS2 becomes different than the TBS1. Possible causes/reasons for the TBS2 to become different than the TBS1 may be a residual error in decoding a PDCCH that schedules/indicates the transmission/retransmission of the TB and/or signaling errors between the wireless device and a base station. The signaling errors may comprise the base station mistakenly receives a HARQ-ACK instead of a HARQ-NACK transmitted by the wireless device for (decoding failure of) the initial transmission; and the wireless device misses a second PDCCH scheduling a third TB (that not retransmission of the TB) associated with a HARQ process. The HARQ process may be associated with the TB.

As in the existing technologies, a possibility for the TBS 1 being different than the TBS 2 is very low (with a probability of less than 10⁻⁶), it is left to the wireless device (UE) implementation how to handle the retransmission of the TB (Option 1 or Option 2 in FIG. 23).

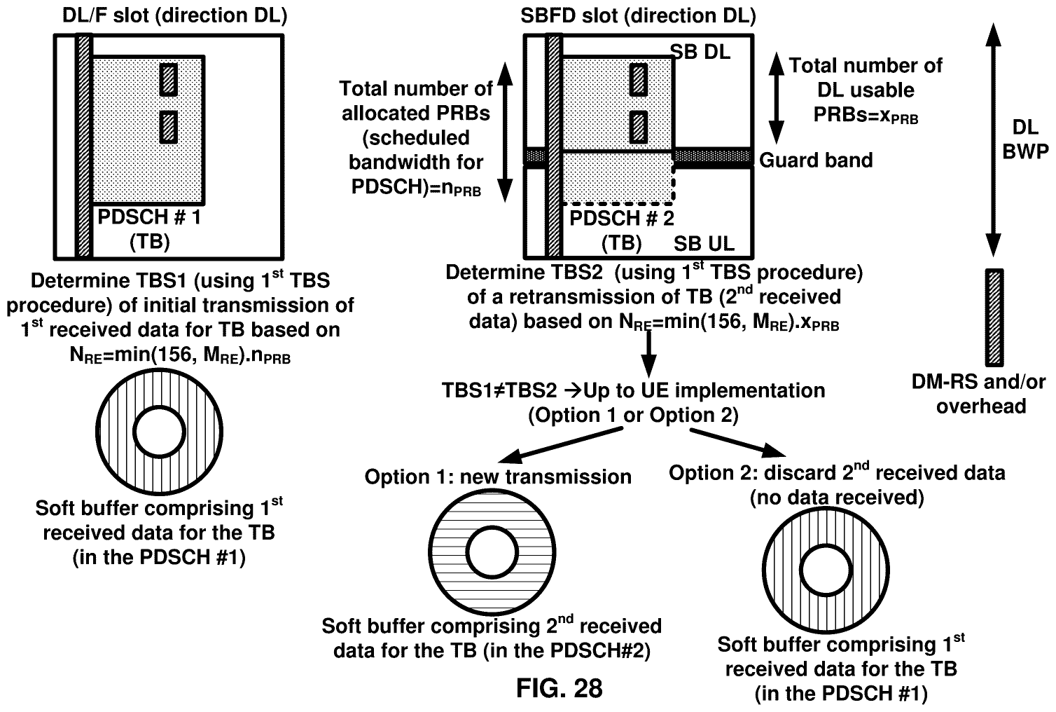

Compared to existing technologies, a probability that the TBS2 becomes different than the TBS1 in the SBFD operation may become much higher than 10⁻⁶ (e.g., it may be more than 10⁻² or even higher). The reason may be that in the SBFD operation (as also discussed in embodiments of FIG. 27A), the TB size determination may be based on the DL usable PRBs (in the SBFD slots/symbols) instead of the allocated PRBs (in the DL/F slots), e.g., as the TB size determination is based on the DL usable PRBs instead on the allocated PRBs it is more probable that the TBS 2 to be different than the TBS 1. FIG. 28 shows an example demonstrating retransmission operation with different TB sizes (the TBS 1 not equal to the TBS 2) among the retransmission(s) and/or the initial transmission of the TB. Other examples are also possible although not shown here.

FIG. 28 illustrates an example of retransmission of transport block in SBFD operation as per an aspect of an embodiment of the present disclosure. As shown the wireless device may receive the PDSCH #1 (carrying/with the TB) in the DL/F slot (as also discussed in FIG. 20). The wireless device may determine the TBS (TBS 1) using the first TBS procedure based on the allocated PRBs for receiving the PDSCH #1 (e.g., n_{PRB}). As shown in FIG. 28 (see also FIG. 22 and/or FIG. 23), based on unsuccessfully decoding a first received data for the TB, the wireless device may (re-)place the first received data for the TB in a first soft buffer for the TB.

For example, the wireless device may receive a retransmission of the TB in the SBFD slot. Receiving the PDSCH #2 in the SBFD slot/symbol may be based on embodiment of FIG. 27A. The PDSCH #2 may comprise a second received data for the TB (e.g., retransmission of the TB). The wireless device may receive the PDSCH #1 in the DL/F slot. The PDSCH #1 may comprise the first received data for the TB. For example, the first received data (or the PDSCH #1) and the second received data (or the PDSCH #2) may correspond to the same HARQ process. In another example, the first received data (or the PDSCH #1) and the second received data (or the PDSCH #2) may correspond to the same NDI value, e.g., an NDI corresponding to the PDSCH #2 may not be toggled with respect to an NDI corresponding to the PDSCH #1.

The wireless device may (when the first condition is met/satisfied) determine the TBS 2 (based on the first TBS procedure and as discussed in the embodiment of FIG. 27A above) based on the allocated PRBs within the DL usable SBFD (e.g., x_{PRB}). Receiving the PDSCH #2 may be similar to receiving the PDSCH in FIG. 27A. As x_{PRB}<n_{PRB} (e.g., the allocated PRBs for receiving the PDSCH #2 in the SBFD symbol/slot overlapping/colliding with the first set of RBs and/or the third set of RBs), the TBS 2 becomes different than the TBS 1. As x_{PRB}<n_{PRB}, receiving the PDSCH #2 (in frequency domain) may be partial.

In the existing technologies (as also discussed in embodiment of FIG. 23), when the TBS 2 is different than the TBS 1, it is left up to UE implementation (the wireless device either performs Option 1 or Option 2). If the UE implementation is Option 2, the wireless device may discard the second received data and keep the first received data in the soft buffer. Under Option 2, spectral efficiency of SBFD operation may reduce or wastage of DL resources may increase, as the base station may transmit the PDSCH #2 (comprising the second received data for the TB) in the SBFD slot while the wireless device discards the second received data for the TB.

In one example, a first MCS index used for the PDSCH #1 may be the same as a second MCS index used for the PDSCH #2.

Alternatively, the first MCS index used for the PDSCH #1 may be different than the second MCS index used for the PDSCH #2.

Similar to FIG. 28, alternatively, it is possible that the PDSCH #1 reception be in the SBFD symbol/slot and the PDSCH #2 reception be in the DL/F slot. For this alternative case, as x_{PRB}<n_{PRB} (e.g., the allocated PRBs for receiving the PDSCH #1 in the SBFD symbol/slot overlapping/colliding with the first set of RBs and/or the third set of RBs), the TBS 1 becomes different than the TBS 2.

In existing technologies, as also discussed above in connection with FIG. 28, the TBS 1 corresponding to the initial transmission of the TB (e.g., in the PDSCH #1 reception in the DL/F slot) and the TBS 2 of the retransmission of the TB (e.g., in the PDSCH #2 reception in the SBFD slot) may be different e.g., when x_{PRB}<n_{PRB}. In some implementations, the wireless device may discard the retransmission of the TB, which results in DL resource wastage and/or reduces DL spectral efficiency of the wireless device. There is a need to enhance DL/UL transmissions (e.g., in the SBFD operation) in order to improve DL/UL spectral efficiency and/or improve alignment between the wireless device and the base station.

The embodiment shown in FIG. 28 may only represent some scenario(s) that result in the TBS 1 and the TBS 2 being different. Other examples that result in a partial reception of either the PDSCH #1 or the PDSCH #2 may also result in the TBS land the TBS 2 being different. The partial reception may be in a time domain, e.g., when at least one symbol (e.g., DL or F or SBFD symbol) for receiving either the PDSCH #1 or the PDSCH #2 is dropped (due to a collision with other DL signals, e.g., SSB, and/or UL signals, e.g., PRACH/PUCCH/SRS or the like). The partial reception may be in frequency domain, e.g., when at least one RE of the plurality of REs for receiving either the PDSCH #1 or the PDSCH #2 is invalid/not used. For other scenarios that result in the TBS 1 and the TBS 2 being different, the embodiments/solutions proposed in this disclosure may be equally applicable. Embodiment of FIG. 28 may show one example of the partial reception (e.g., of the PDSCH #2) in the frequency domain.

Embodiments of the present disclosure are related to an approach for solving the problems described above. These and other features of the present disclosure are described further below.

In an example embodiment, a wireless device may receive the one or more configuration parameters comprising a first parameter indicating a retransmission of a transport block (TB) with a different TB size (TBS) than an initial transmission of the TB is a new transmission. The wireless device may receive (an initial transmission of) a first TB with a first TBS. The wireless device may receive a retransmission of the first TB with a second TBS, wherein the first TBS is different than the second TBS. The wireless device may decode the retransmission of the first TB as a new transmission based on the first parameter.

In an example embodiment, in response to the second TBS being different than the first TBS, the wireless device may decode the retransmission of the first TB as a new transmission based on the first parameter.

In an example embodiment, the wireless device may decode the retransmission of the first TB as a new transmission in response to the first parameter indicating the retransmission of the TB with the different TBS than the initial transmission of the TB is the new transmission.

In an example embodiment, a wireless device may receive (an initial transmission of) a first TB with a first TBS. The wireless device may receive a retransmission of the first TB with a second TBS. In response to the second TBS being different than the first TBS, the wireless device may discard the retransmission of the first TB based on the one or more configuration parameters (e.g., the first message) not indicating a retransmission of a transport block (TB) with a different TB size (TBS) than an initial transmission of the TB is a new transmission.

Some embodiments of the present disclosure may improve alignment between the wireless device and/or the base station and/or improve spectral efficiency (e.g., reduce UL/DL resource waste), e.g., for transmitting data to the wireless device as the wireless device may avoid discarding the retransmission of the first TB with the TBS 2≠TBS 1 when the first message comprises the first parameter.

According to some embodiments of the present disclosure, instead of leaving handing (e.g., choosing Option 1 or Option 2) of the retransmission of the first TB with the TBS 2≠TBS 1 up to the UE implementation, the wireless device handles the retransmission of the first TB with the TBS 2≠TBS 1 based on whether the message 1 comprise/indicate the first parameter or not.

In an example embodiment, a wireless device may transmit a second message (e.g., of the one or more capability messages) comprising a second parameter indicating the wireless device has a capability (e.g., an Option1-based Capability) for retransmission of a TB with a different TB size (TBS) than an initial transmission of the TB. The wireless device may receive (an initial transmission of) a first TB with a first TBS. The wireless device may receive a retransmission of the first TB with a second TBS, wherein the first TBS is different than the second TBS. The wireless device may decode the retransmission of the first TB as a new transmission based on the second parameter.

In an example embodiment, in response to the second TBS being different than the first TBS, the wireless device may decode the retransmission of the first TB as a new transmission based on the second parameter.

In an example embodiment, the wireless device may decode the retransmission of the first TB as a new transmission in response to the second message indicating the Option1-based Capability.

In an example embodiment, the wireless device may transmit the second message (e.g., of the one or more capability messages). The wireless device may receive (an initial transmission of) a first TB with a first TBS. The wireless device may receive a retransmission of the first TB with a second TBS. In response to the second TBS being different than the first TBS, the wireless device may discard the retransmission of the first TB based on the second message not indicating the wireless device has a capability (e.g., the Option1-based Capability) for retransmission of a TB with a different TB size (TBS) than an initial transmission of the TB.

In an example embodiment, a wireless device may transmit the one or more UE-capability messages (e.g., the second message) comprising the second parameter indicating the wireless device has a capability (e.g., the Option1-based Capability) for retransmission of a TB with a different TB size (TBS) than an initial transmission of the TB. The wireless device may receive the one or more configuration parameters (e.g., the first message) comprising the first parameter indicating a retransmission of a transport block (TB) with a different TB size (TBS) than an initial transmission of the TB is a new transmission. The wireless device may receive (an initial transmission of) a first TB with a first TBS. The wireless device may receive a retransmission of the first TB with a second TBS, wherein the first TBS is different than the second TBS. The wireless device may decode the retransmission of the first TB as a new transmission in response to the first parameter indicating the retransmission of the TB with the different TBS than the initial transmission of the TB is the new transmission and/or the second parameter indicating the wireless device has a capability (e.g., the Option1-based Capability) for retransmission of a TB with a different TB size (TBS) than an initial transmission of the TB.

In an example embodiment, a wireless device may transmit one or more UE-capability messages (e.g., the second message) comprising the second parameter indicating the wireless device does not have a capability (e.g., the Option1-based Capability) for a retransmission of a TB with a different TB size (TBS) than an initial transmission of the TB. The wireless device may receive (an initial transmission of) a first TB with a first TBS. The wireless device may receive a retransmission of the first TB with a second TBS, wherein the first TBS is different than the second TBS. In response to the second TBS being different than the first TBS and the second parameter not indicating the Option1-based capability, the wireless device may discard the retransmission of the first TB.

In an example embodiment, a wireless device may transmit one or more UE-capability messages (e.g., the second message) comprising the second parameter indicating the wireless device has a capability (e.g., an Option2-based Capability) for discarding retransmission of a TB with a different TB size (TBS) than an initial transmission of the TB. The wireless device may receive (an initial transmission of) a first TB with a first TBS. The wireless device may receive a retransmission of the first TB with a second TBS, wherein the first TBS is different than the second TBS. In response to the second TBS being different than the first TBS and the second parameter indicating the Option2-based capability, the wireless device may discard the retransmission of the first TB.

Some embodiments of the present disclosure may improve alignment between the wireless device and/or the base station and/or improve spectral efficiency (e.g., reduce UL/DL resource waste). For example, the wireless device may report its capability (e.g., the Option2-based Capability or Option1-based Capability) for handling (receiving or discarding) retransmission(s) of a TB with different TBS than the initial transmission of the TB. This allows the base station to determine whether to transmit a retransmission of the TB with different TBS or not.

In an example embodiment, a wireless device may receive the one or more configuration parameters (e.g., the first message) comprising the first parameter indicating a retransmission of a transport block (TB) with a different TB size (TBS) than an initial transmission of the TB is a new transmission. The wireless device may receive (an initial transmission of) a first TB with a first TBS. The wireless device may receive a retransmission of the first TB with a second TBS, wherein the first TBS is different than the second TBS. The wireless device may decode the retransmission of the first TB as a new transmission in response to the first parameter indicating the retransmission of the TB with the different TBS than the initial transmission of the TB is the new transmission and/or the second parameter not indicating the wireless device has a capability (e.g., the Option1-based Capability) for retransmission of a TB with a different TB size (TBS) than an initial transmission of the TB.

In an example embodiment, a wireless device may transmit the one or more UE-capability messages (e.g., the second message) comprising a third parameter indicating the wireless device has a capability (e.g., a fifteenth capability) for combining a received data for a retransmission of a TB with a received data for an initial transmission of the TB when the retransmission of the TB is with a different TB size (TBS) than the initial transmission of the TB. The wireless device may receive the initial transmission of the first TB (comprising a first received data) with the first TBS. The wireless device may receive the retransmission of the first TB (comprising a second received data) with the second TBS, wherein the second TBS is different than (not equal to) the first TBS. In response to the third parameter, decoding a combined data comprising a combination of the first received data and the second received data.

In an example embodiment, a wireless device may transmit the one or more UE-capability messages (e.g., the second message). The wireless device may receive the initial transmission of the first TB (comprising a first received data) with the first TBS. The wireless device may receive the retransmission of the first TB (comprising a second received data) with the second TBS. In response to the second TBS being different than (not equal to) the first TBS and based on second message not indicating the wireless device has a capability (e.g., the fifteenth capability) for combining a received data for a retransmission of a TB with a received data for an initial transmission of the TB when the retransmission of the TB is with a different TB size (TBS) than the initial transmission of the TB, not combining the first received data and the second received data for decoding the retransmission of the first TB.

In an example embodiment, a wireless device may transmit the one or more UE-capability messages (e.g., the second message) comprising the third parameter indicating the wireless device has a capability (e.g., the fifteenth capability) for handing (e.g., decoding/receiving) a retransmission of a TB with a different TB size (TBS) than the initial transmission of the TB and a maximum TBS difference value corresponding to the retransmission of the TB and the initial transmission of the TB. The wireless device may receive the initial transmission of the first TB (comprising the first received data) with the first TBS. The wireless device may receive the retransmission of the first TB (comprising the second received data) with the second TBS, wherein the second TBS is different than (not equal to) the first TBS. In response to a difference between the first TBS and the second TBS being lower/smaller than the maximum TBS difference value, decoding a combined data comprising a combination of the first received data and the second received data.

In an example embodiment, a wireless device may transmit the one or more UE-capability messages (e.g., the second message) indicating a capability (e.g., the fifteenth capability) for handing (e.g., decoding/receiving) a retransmission of a TB with a different TB size (TBS) than the initial transmission of the TB and a maximum TBS difference value corresponding to the retransmission of the TB and the initial transmission of the TB. The wireless device may receive the initial transmission of the first TB (comprising the first received data) with the first TBS. The wireless device may receive the initial transmission of the first TB (comprising the first received data) with the first TBS. The wireless device may receive the retransmission of the first TB (comprising the second received data) with the second TBS. In response to a difference between the first TBS and the second TBS being greater/larger (not smaller) than the maximum TBS difference value, not combining the first received data and the second received data for decoding the first TB.

In an example embodiment, a wireless device may receive the one or more configuration parameters comprising a fourth parameter indicating an initial transmission and retransmissions for a TB are during/in a same symbol/slot type (a SBFD symbol/slot or a non-SBFD symbol/slot). The wireless device may receive an initial transmission of the TB in a first symbol/slot with a first symbol/slot type (e.g., the SBFD symbol/slot or the non-SBFD symbol/slot). Based on the fourth parameter, the wireless device may receive a retransmission of the first TB in a second symbol/slot with the first symbol/slot type (e.g., the SBFD symbol/slot or the non-SBFD symbol/slot).

In an example embodiment, a wireless device may receive the one or more configuration parameters comprising the fourth parameter indicating an initial transmission and retransmissions for a TB are during/in a same symbol/slot type (a SBFD symbol/slot or a non-SBFD symbol/slot). The wireless device may receive an initial transmission of the TB in a first non-SBFD symbol/slot. Based on the fourth parameter, the wireless device may receive a retransmission of the first TB in a second non-SBFD symbol/slot.

In an example embodiment, a wireless device may receive the one or more configuration parameters comprising the fourth parameter indicating an initial transmission and retransmissions for a TB are during/in a same symbol/slot type (a SBFD symbol/slot or a non-SBFD symbol/slot). The wireless device may receive an initial transmission of the TB in a first SBFD symbol/slot. Based on the fourth parameter, the wireless device may receive a retransmission of the first TB in a second SBFD symbol/slot.

In an example embodiment, a wireless device may receive the one or more configuration parameters comprising the fourth parameter indicating an initial transmission and retransmissions for a TB are during/in a same symbol/slot type (a SBFD symbol/slot or a non-SBFD symbol/slot). The wireless device may receive an initial transmission of the TB in a first SBFD symbol/slot. Based on the fourth parameter and the first condition being satisfied, the wireless device may receive a retransmission of the first TB in a second SBFD symbol/slot.

In an example embodiment, a wireless device may receive the one or more configuration parameters comprising the fourth parameter indicating an initial transmission and retransmissions for a TB are during/in a same symbol/slot type (a SBFD symbol/slot or a non-SBFD symbol/slot). The wireless device may receive an initial transmission of the TB in a first SBFD symbol/slot. Based on the fourth parameter and the first condition not being satisfied, the wireless device may receive a retransmission of the first TB in a second SBFD symbol/slot.

In an example embodiment, a wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first symbol/slot with a first symbol/slot type (e.g., the SBFD symbol/slot or the non-SBFD symbol/slot). Based on the parameter indicating an initial transmission and retransmissions for a TB are during/in a same symbol/slot type (SBFD symbol/slot or non-SBFD symbol/slot), the wireless device may not receive or discard/drop a retransmission of the first TB in a second symbol/slot with a second symbol/slot type (e.g., the SBFD symbol/slot or the non-SBFD symbol/slot) different than the first symbol/slot type.

In an example embodiment, a wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first SBFD symbol/slot. Based on the parameter indicating an initial transmission and retransmissions for a TB are during/in a same symbol/slot type (SBFD symbol/slot or non-SBFD symbol/slot), the wireless device may not receive or discard/drop a retransmission of the first TB in a first non-SBFD symbol/slot.

In an example embodiment, a wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first SBFD symbol/slot. Based on the parameter indicating an initial transmission and retransmissions for a TB are during/in a same symbol/slot type (SBFD symbol/slot or non-SBFD symbol/slot) and/or the first condition not being satisfied (e.g., corresponding to the initial transmission of the first TB in/during the first SBFD symbol/slot), the wireless device may not receive or discard/drop a retransmission of the first TB in a first non-SBFD symbol/slot.

In an example embodiment, a wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first SBFD symbol/slot. Based on the parameter indicating an initial transmission and retransmissions for a TB are during/in a same symbol/slot type (SBFD symbol/slot or non-SBFD symbol/slot) and/or the first condition being satisfied (e.g., corresponding to the initial transmission of the first TB in/during the first SBFD symbol/slot), the wireless device may not receive or discard/drop a retransmission of the first TB in a first non-SBFD symbol/slot.

In an example embodiment, a wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first non-SBFD symbol/slot. Based on the parameter indicating an initial transmission and retransmissions for a TB are during/in a same symbol/slot type (SBFD symbol/slot or non-SBFD symbol/slot), the wireless device may not receive or discard/drop a retransmission of the first TB in a first SBFD symbol/slot.

In an example embodiment, a wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first non-SBFD symbol/slot. Based on the parameter indicating an initial transmission and retransmissions for a TB are during/in a same symbol/slot type (SBFD symbol/slot or non-SBFD symbol/slot) and/or the first condition not being satisfied (e.g., corresponding to a retransmission of the first TB in/during a first SBFD symbol/slot), the wireless device may not receive or discard/drop the retransmission of the first TB in the first SBFD symbol/slot.

In an example embodiment, a wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first non-SBFD symbol/slot. Based on the parameter indicating an initial transmission and retransmissions for a TB are during/in a same symbol/slot type (SBFD symbol/slot or non-SBFD symbol/slot) and/or the first condition being satisfied (e.g., corresponding to a retransmission of the first TB in/during a first SBFD symbol/slot), the wireless device may not receive or discard/drop the retransmission of the first TB in the first SBFD symbol/slot.

In an example embodiment, a wireless device may receive the one or more configuration parameters (e.g., the one or more SBFD configuration parameters). The wireless device may receive an initial transmission of the first TB in/during a first symbol/slot with a first symbol/slot type (e.g., an SBFD symbol/slot or a non-SBFD symbol/slot). The wireless device may receive a retransmission of the first TB in a second symbol/slot with a second symbol/slot type (e.g., the SBFD symbol/slot or the non-SBFD symbol/slot) different than the first SBFD symbol based on the one or more configuration parameters not indicating an initial transmission and retransmissions for a TB are during/in a same symbol/slot type (the SBFD symbol/slot or the non-SBFD symbol/slot).

In an example embodiment, a wireless device may receive the one or more configuration parameters (e.g., the one or more SBFD configuration parameters). the wireless device may receive an initial transmission of the first TB in/during a first symbol/slot with a first symbol/slot type (e.g., an SBFD symbol/slot or a non-SBFD symbol/slot). The wireless device may receive a retransmission of the first TB in a second symbol/slot with a second symbol/slot type (e.g., the SBFD symbol/slot or the non-SBFD symbol/slot) different than the first SBFD symbol based on the one or more configuration parameters not indicating an initial transmission and retransmissions for a TB are during/in a same symbol/slot type (the SBFD symbol/slot or the non-SBFD symbol/slot) and/or the first condition not being satisfied.

In an example embodiment, a wireless device may receive the one or more configuration parameters (e.g., the one or more SBFD configuration parameters). the wireless device may receive an initial transmission of the first TB in/during a first symbol/slot with a first symbol/slot type (e.g., an SBFD symbol/slot or a non-SBFD symbol/slot). The wireless device may receive a retransmission of the first TB in a second symbol/slot with a second symbol/slot type (e.g., the SBFD symbol/slot or the non-SBFD symbol/slot) different than the first SBFD symbol based on the one or more configuration parameters not indicating an initial transmission and retransmissions for a TB are during/in a same symbol/slot type (the SBFD symbol/slot or the non-SBFD symbol/slot) and/or the first condition being satisfied.

In an example embodiment, a wireless device may receive the one or more configuration parameters (e.g., the one or more SBFD configuration parameters). the wireless device may receive an initial transmission of the first TB in/during a first SBFD symbol/slot. The wireless device may receive a retransmission of the first TB in a second non-SBFD symbol/slot based on the one or more configuration parameters not indicating an initial transmission and retransmissions for a TB are during/in a same symbol/slot type (the SBFD symbol/slot or the non-SBFD symbol/slot).

In an example embodiment, a wireless device may receive the one or more configuration parameters (e.g., the one or more SBFD configuration parameters). the wireless device may receive an initial transmission of the first TB in/during a first non-SBFD symbol/slot. The wireless device may receive a retransmission of the first TB in a second SBFD symbol/slot based on the one or more configuration parameters not indicating an initial transmission and retransmissions for a TB are during/in a same symbol/slot type (the SBFD symbol/slot or the non-SBFD symbol/slot).

Some embodiments of the present disclosure may improve alignment between the wireless device and/or the base station and/or improve spectral efficiency (e.g., reduce UL/DL resource waste), e.g., for transmitting data to the wireless device as the wireless device may avoid discarding the retransmission of the first TB with the TBS 2≠TBS 1 when the first message comprises the first parameter. According to some embodiments of the present disclosure, instead of leaving handing (e.g., choosing Option 1 or Option 2) of the retransmission of the first TB with the TBS 2≠TBS 1 up to the UE implementation, the wireless device handles the retransmission of the first TB with the TBS 2≠TBS 1 based on whether the message 1 comprise/indicate the first parameter or not.

Some embodiments of the present disclosure may improve alignment between the wireless device and/or the base station and/or improve spectral efficiency (e.g., reduce UL/DL resource waste). For example, the wireless device may report its capability (e.g., the Option2-based Capability or Option1-based Capability) for handling (receiving or discarding) retransmission(s) of a TB with different TBS than the initial transmission of the TB. This allows the base station to determine whether to transmit a retransmission of the TB with different TBS or not.

Some embodiments may improve spectral efficiency/reliability of SBFD operations. For example, the base station may restrict retransmissions/initial transmissions of TBs during a same slot/symbol type (e.g., an SBFD symbol/slot or non-SBFD symbol/slot). This reduces a possibility of discarding retransmissions of the TB at the wireless device (e.g., when the first condition is not satisfied).

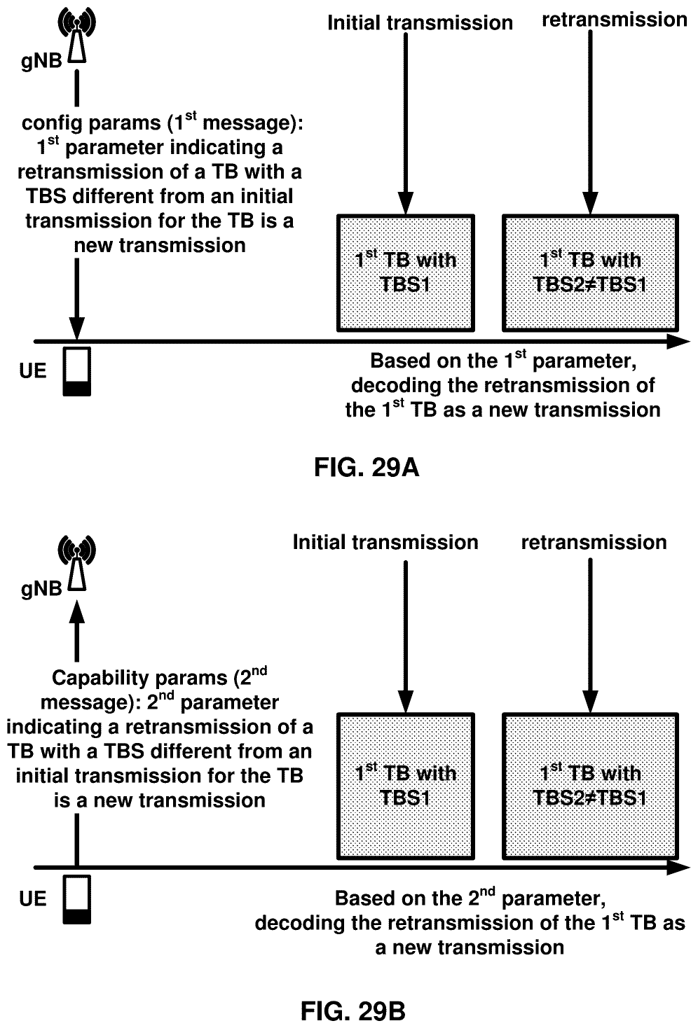

FIG. 29A illustrates an example of downlink receptions as per an aspect of an embodiment of the present disclosure. For example, FIG. 29A may show an example of decoding downlink data for a TB when a TB size of the TB across initial transmission and retransmissions are different. For example, FIG. 29A may provide one or more enhancements for the first DL reception procedure discussed above in relation to FIG. 23.

In some aspects, embodiment of FIG. 29A may provide enhancements for the first TBS procedure. Optionally or additionally, the embodiment of FIG. 29A may be combined with the embodiment of FIG. 20 for determining a first TBS of a first TB. Optionally or additionally, the embodiment of FIG. 29A may be combined with the embodiment of FIG. 20 for receiving the first TB (e.g., decoding a received data for the first TB).

In some other aspects, embodiment of FIG. 29A may provide enhancements for the retransmission of the first TB, e.g., when the TB size is different between the initial transmission of the TB and the retransmission of the TB, e.g., TBS 2≠TBS 1. Optionally, the embodiment of FIG. 29A may be combined with the embodiment of FIG. 21A and/or FIG. 21B for receiving the first TB (e.g., decoding the received data for the first TB).

The wireless device may receive (from a base station) the one or more configuration parameters (e.g., the one or more messages). For example, the wireless device may receive a first message of the one or more messages comprising the one or more configuration parameters. The one or more configuration parameters may comprise a first parameter. For example, the first message may comprise the first parameter.

In an example embodiment, the first parameter may indicate a retransmission of a transport block (TB) with a different TB size (TBS) than an initial transmission of the TB is a new transmission. In one example, the first message (and/or the one or more configuration parameters) may indicate the retransmission of the transport block (TB) with the different TB size (TBS) than the initial transmission of the TB is the new transmission.

As shown in FIG. 29A, the wireless device may receive (from the base station) a first TB with a first TBS (TBS 1). The wireless device may determine the first TBS (for receiving the first TB) based on the first TBS procedure (see FIG. 20). For example, receiving the first TB with the TBS 1 may comprise (or be) an initial/earliest/starting/first transmission of the first TB.

The wireless device may receive (from the base station) a retransmission of the first TB with a second TBS (TBS 2).

The wireless device may, via the first transmission of the first TB, receive a first received data (e.g., a first MAC PDU and/or a first packet) for the first TB.

The wireless device may, via the retransmission of the first TB, receive a second received data (e.g., a second MAC PDU and/or a second packet) for the first TB.

The wireless device may determine the second TBS (for receiving the retransmission of the first TB) based on the first TBS procedure (see FIG. 20). Optionally or additionally, the wireless device may determine the TBS2 similar to embodiment(s) of FIG. 21A and/or FIG. 21B discussed above.

For example, the wireless device may determine the TBS 2 is different from the TBS 1. The wireless device may determine the retransmission of the first TB being with a different TBS than the initial transmission for the TB. In an example embodiment, as shown in FIG. 29A, the wireless device may, based on the first parameter, decode the retransmission of the first TB as a new transmission (e.g., Option 1 in FIG. 23 and/or FIG. 28). In an example embodiment, the wireless device may decode the retransmission of the first TB as a new transmission (e.g., Option 1 in FIG. 23 and/or FIG. 28) in response to the first parameter indicating the retransmission of the TB with the different TBS than the initial transmission of the TB is the new transmission.

In an example embodiment, the wireless device may decode the retransmission of the first TB as a new transmission (e.g., Option 1 in FIG. 23 and/or FIG. 28) in response to the first parameter indicating the retransmission of the TB with the different TBS than the initial transmission of the TB is the new transmission; and the retransmission of the first TB being with a different TBS than the initial transmission for the TB (e.g., the TBS 2 is not equal to the TBS 1 or the TBS 2 is different that the TBS 1).

In an example embodiment, the wireless device may decode the retransmission of the first TB as a new transmission (e.g., Option 1 in FIG. 23 and/or FIG. 28) in response to the first message comprising the first parameter.

In an example embodiment, the wireless device may decode the retransmission of the first TB as a new transmission (e.g., Option 1 in FIG. 23 and/or FIG. 28) in response to the first message comprising the first parameter; and the retransmission of the first TB being with a different TBS than the initial transmission for the TB (e.g., the TBS 2 is not equal to the TBS 1 or the TBS 2 is different that the TBS 1).

In an example embodiment, in response to the first message comprising the first parameter, decoding the retransmission of the TB may be based on the TBS 2 being different than the TBS 1.

In an example embodiment, decoding the retransmission of the TB may be based on the TBS 2 being different than the TBS 1 and/or the first parameter indicating the retransmission of the TB with the different TBS than the initial transmission of the TB is the new transmission.

In one example, the first TB with the TBS 1 may be a new transmission (e.g., the initial transmission for the TB). The first TB with the TBS 2 may be a first/starting/earliest retransmission of the first TB.

In another example, the first TB with the TBS 1 may be an N-th (N>1) retransmission for the TB, e.g., the first TBS may be a last signaled TBS for the first TB before the retransmission of the first TB with the TBS 2. The first TB with the TBS 2 may be (N+1) retransmission of the first TB.

In an example embodiment, the wireless device may, based on the first message not indicating/comprising the first parameter, discard (or ignore) the retransmission of the first TB (Option 2 in FIG. 23 and/or FIG. 28). The wireless device may, based on the first message not indicating/comprising the first parameter, avoid decoding (or not decode) the retransmission of the first TB (Option 2 in FIG. 23 and/or FIG. 28).

In an example embodiment, the wireless device may discard (or ignore) the retransmission of the first TB (Option 2 in FIG. 23 and/or FIG. 28) in response to the first parameter not indicating the retransmission of the TB with the different TBS than the initial transmission of the TB is the new transmission; and the retransmission of the first TB being with a different TBS than the initial transmission for the TB (e.g., the TBS 2 is not equal to the TBS 1 or the TBS 2 is different that the TBS 1).

In an example embodiment, the wireless device may avoid decoding (or not decode) the retransmission of the first TB (Option 2 in FIG. 23 and/or FIG. 28) in response to the first parameter not indicating the retransmission of the TB with the different TBS than the initial transmission of the TB is the new transmission; and the retransmission of the first TB being with a different TBS than the initial transmission for the TB (e.g., the TBS 2 is not equal to the TBS 1 or the TBS 2 is different that the TBS 1).

In an example embodiment, the wireless device may, based on the first message not indicating/comprising the first parameter, not expect (or consider it as error) to receive the retransmission for the first TB with the different TB size than the initial transmission for the first TB (e.g., TBS 2 not equal to TBS 1).

The base station may transmit the retransmission for the TB with the TBS 2 different than the TBS 1 based on the first message comprising the first parameter. In an example embodiment, the base station may transmit the retransmission for the TB with the TBS 2 different than the TBS 1 based on the first parameter indicating the retransmission of the TB with the different TBS than the initial transmission of the TB is the new transmission.

Optionally, the base station may further determine a decoding of the initial transmission for the TB being unsuccessful at the wireless device. For example, the base station may receive a HARQ-ACK information bit with a NACK value corresponding to the initial transmission of the first TB. In response to the NACK value corresponding to the initial transmission of the first TB and the first message comprising the first parameter, the base station may transmit the retransmission for the TB with the TBS 2 different than the TBS 1.

The base station may determine a second MCS index for retransmission for the TB with the TBS 2 based on the first parameter indicating the retransmission of the TB with the different TBS than the initial transmission of the TB is the new transmission. The base station may determine the second MCS regardless of a first MCS that is used for the initial transmission for the first TB. The second TBS may be based on the second MCS (as discussed in embodiment of FIG. 20). The first TBS may be based on the first MCS (as discussed in embodiment of FIG. 20).

In response to the first message not comprising/indicating the first parameter, the base station may avoid transmitting the retransmission for the TB with the TBS 2 different than the TBS 1. In response to the first message not comprising/indicating the first parameter, the base station may transmit the retransmission for the TB with the TBS 2 that is equal to the TBS 1. In response to the NACK value corresponding to the initial transmission of the first TB and the first message not comprising the first parameter, the base station may transmit the retransmission for the TB with the TBS 2 equal to the TBS 1. The base station may determine the second MCS based on the first MCS that is used for the initial transmission for the first TB. the second MCS and the first MCS may result in the same TBS for the TB.

Some embodiments of the present disclosure may improve alignment between the wireless device and/or the base station and/or improve spectral efficiency (e.g., reduce UL/DL resource waste) for transmitting data to the wireless device as the wireless device may avoid discarding the retransmission of the first TB with the TBS 2≠TBS 1 when the first message comprises the first parameter. In effect, according to some embodiments of the present disclosure, instead of leaving handing (e.g., choosing Option 1 or Option 2) of the retransmission of the first TB with the TBS 2≠TBS 1 up to the UE implementation, the wireless device handles the retransmission of the first TB with the TBS 2≠TBS 1 based on whether the message 1 comprise/indicate the first parameter or not.

In some implementations, the first parameter may indicate whether the wireless device handles the retransmission of TBs (e.g., the first TB) with different TBSs than the initial transmission of TBs (e.g., the TBS 2≠TBS 1) based on Option 1 or Option 2. In one example, when the first message comprises the first parameter, the wireless device may handle the retransmission of the first TB with the TBS 2≠TBS 1 based on Option 1. When the first message does not comprise the first parameter, the wireless device may handle the retransmission of the first TB with the TBS 2≠TBS 1 based on either Option 2 or Option 1.

Optionally, in the embodiment of FIG. 29A, the wireless device may further determine the first TB with the TBS 1 not being successfully decoded. The wireless device may, based on the first received data for the first TB not being successfully (correctly) decoded, (re-)place (or put) the first received data (of the first TB) in a first soft buffer. The first soft buffer may be for/or be associated with the first TB. For example, based on unsuccessfully (incorrectly) decoding the first received data (for the first TB), the wireless device may instruct the lower layers (e.g., PHY layer) of the wireless device to generate acknowledgment (NACK) for the first TB (e.g., only when the first HARQ process is feedback enabled). For example, the wireless device may transmit the HARQ-ACK with a negative value (NACK) corresponding to a HARQ process #n of the first TB (e.g., only when the first HARQ process is feedback enabled).

The first soft buffer may store/hold the first received data for the first TB. The first soft buffer may correspond to a first HARQ information comprising the HARQ process #n. The first soft buffer may correspond to (or associated with) the first TB. The first soft buffer comprises the first received data for the first TB. In some cases, the wireless device may, prior to placing/replacing the first received data in the first soft buffer and based on the received first TB (the first received data) being the very first (or earliest/starting/initial) transmission of the TB, flush the first soft buffer. By flushing the first soft buffer, the wireless device may delete/remove/discard any data in the first soft buffer.

Optionally, in the embodiment of FIG. 29A, the wireless device may consider the retransmission of the first TB as a new transmission of the first TB in response to the first message comprising the first parameter; and the retransmission of the first TB being with a different TBS than the initial transmission for the TB (e.g., the TBS 2 is not equal to the TBS 1 or the TBS 2 is different that the TBS 1).

Optionally, in the embodiment of FIG. 29A, based on the first TB not been successfully decoded, the wireless device may (re-)place the second received data (for the first TB) in the first soft buffer for the first TB in response to the first message comprising the first parameter; and the retransmission of the first TB being with a different TBS than the initial transmission for the TB (e.g., the TBS 2 is not equal to the TBS 1 or the TBS 2 is different that the TBS 1). Additionally, the wireless device may avoid combining the second received data with the first received data in the first soft buffer for the first TB. Additionally, corresponding to the retransmission of the first TB (e.g., the second received data) and based on the first TB not been successfully decoded, the wireless device may avoid instructing the physical layer to combine the second received data with the first received data currently in the first soft buffer (for the first TB).

Optionally, in the embodiment of FIG. 29A, the wireless device may decode the retransmission of the first TB as a new transmission (e.g., decode the second received data for the first TB). If the wireless device successfully (correctly) decodes the second received data, the wireless device may disassemble/demultiplex the second MAC PDU for the retransmission of the first TB and/or deliver the second MAC PDU of the retransmission of the first TB to higher layers (e.g., RLC/PDCP) layer. For example, based on successfully (correctly) decoding the second received data, the wireless device may instruct the lower layers (e.g., PHY layer) of the wireless device to generate acknowledgment (e.g., ACK) for the retransmission of the first TB (e.g., only when the HARQ process #n is feedback enabled). For example, the wireless device may (e.g., only when the HARQ process #n is feedback enabled) transmit the HARQ-ACK with positive value (the acknowledgment) corresponding to the HARQ process #n of the first TB.

Optionally, in the embodiment of FIG. 29A, the wireless device may determine the second received data for the first TB not being successfully (correctly) decoded. The wireless device may, based on the second received data for the first TB not being successfully (correctly) decoded, instruct the lower layers (e.g., PHY layer) of the wireless device to generate acknowledgment (NACK) for the first TB (e.g., only when the HARQ process #n is feedback enabled). For example, the wireless device may transmit the HARQ-ACK with a negative value (NACK) corresponding to the HARQ process #n of the first TB (e.g., only when the HARQ process #n is feedback enabled).

FIG. 29B illustrates an example of downlink receptions as per an aspect of an embodiment of the present disclosure. For example, FIG. 29B may show an example of decoding downlink data for a TB when a TB size of the TB across initial transmission and retransmissions are different. For example, FIG. 29B may provide one or more enhancements for the first DL reception procedure discussed above in relation to FIG. 23.

In some aspect, embodiment of FIG. 29B may provide enhancements for the first TBS procedure. Optionally or additionally, the embodiment of FIG. 29B may be combined with the embodiment of FIG. 20 for determining the first TBS of the first TB. Optionally or additionally, the embodiment of FIG. 29B may be combined with the embodiment of FIG. 20 for receiving the first TB (e.g., decoding the received data for the first TB).

In some other aspect, embodiment of FIG. 29B may provide enhancements for the retransmission of the first TB, e.g., when the TB size is different between the initial transmission of the TB and the retransmission of the TB, e.g., TBS 2≠TBS 1. Optionally, the embodiment of FIG. 29B may be combined with the embodiment of FIG. 21A and/or FIG. 21B for receiving the first TB (e.g., decoding the received data for the first TB).

The wireless device may transmit the one or more capability messages to the base station. The one or more UE capability messages may comprise capability parameters. The one or more UE capability messages may comprise a second message. The second message may comprise a second parameter.

For example, the second message may comprise capability parameters (the at least one set of capabilities). The capability parameters may comprise the second parameter.

The capability parameters may be the UE capabilities. The first set of capabilities may comprise the second parameter. For example, the second message may comprise the first set of capabilities.

In an example embodiment, the second parameter may indicate whether the wireless device has a capability for a retransmission of a transport block (TB) with a different TB size (TBS) than an initial transmission of the TB. In some implementations, the second parameter may indicate whether the wireless device has the capability for handling the retransmission of TBs with different TBSs than the initial transmission for TBs based on Option 1 or Option 2.

In one example, when the second parameter indicates the wireless device handles the retransmission of TBs with different TBSs than the initial transmission for TBs based on Option 1 (Option1-based Capability), the wireless device has the capability (or indicate the capability) for the retransmission of a transport block (TB) with a different TB size (TBS) than an initial transmission of the TB.

Option1-based Capability may indicate the retransmission of the TB with a different TBS than the initial transmission of the TB is a new transmission at the wireless device (Option 1).

In another example, when the second parameter indicates the wireless device handles the retransmission of TBs with different TBSs than the initial transmission for TBs based on Option 2 (Option2-based Capability), the wireless device does not have the capability (or does not indicate the capability) for the retransmission of a transport block (TB) with a different TB size (TBS) than an initial transmission of the TB.

Option2-based Capability may indicate the retransmission of the TB with a different TBS than the initial transmission of the TB is discarded/dropped/ignored at the wireless device (Option 2).

For example, when the second message does not comprise the second parameter, the wireless device does not have the capability (or does not indicate the capability) for the retransmission of a transport block (TB) with a different TB size (TBS) than an initial transmission of the TB.

For example, when the second message does not comprise the second parameter, the wireless device handles the retransmission of TBs with different TBSs than the initial transmission for TBs based on Option 2 (Option2-based Capability).

In the example of FIG. 29B, the wireless device may indicate the Option1-based Capability to the base station. As shown in FIG. 29B, the wireless device may receive (from the base station) the first TB with the first TBS (TBS 1). The wireless device may determine the first TBS (for receiving the first TB) based on the first TBS procedure (see FIG. 20). For example, receiving the first TB with the TBS 1 may comprise (or be) an initial/earliest/starting/first transmission of the first TB.

The wireless device may receive (from the base station) the retransmission of the first TB with the second TBS (TBS 2). The wireless device may determine the second TBS (for receiving the retransmission of the first TB) based on the first TBS procedure (see FIG. 20). Optionally or additionally, the wireless device may determine the TBS2 similar to embodiment(s) of FIG. 21A and/or FIG. 21B discussed above. For example, the wireless device may further determine the first TB with the TBS 1 not being successfully decoded.

For example, the wireless device may determine the TBS 2 is different from the TBS 1. The wireless device may determine the retransmission of the first TB being with a different TBS than the initial transmission for the TB. In an example embodiment, as shown in FIG. 29B, the wireless device may, based on the second message, determine whether to decode the retransmission of the first TB as the new transmission (e.g., Option 1 in FIG. 23 and/or FIG. 28) or drop/discard the retransmission of the first TB (Option 2 in FIG. 23 and/or FIG. 28).

In an example embodiment, the wireless device may decode the retransmission of the first TB as the new transmission (e.g., Option 1 in FIG. 23 and/or FIG. 28) in response to the second parameter indicating the Option1-based Capability. In an example embodiment, the wireless device may decode the retransmission of the first TB as the new transmission (e.g., Option 1 in FIG. 23 and/or FIG. 28) in response to the second message (or the second parameter) indicating the retransmission of the TB with the different TBS than the initial transmission of the TB is the new transmission.

In an example embodiment, the wireless device may decode the retransmission of the first TB as a new transmission (e.g., Option 1 in FIG. 23 and/or FIG. 28) in response to the second message (or the second parameter) indicating the retransmission of the TB with the different TBS than the initial transmission of the TB is the new transmission (e.g., the Option1-based Capability); and the retransmission of the first TB being with a different TBS than the initial transmission for the TB (e.g., the TBS 2 is not equal to the TBS 1 or the TBS 2 is different that the TBS 1).

In an example embodiment, in response to the second parameter indicating the Option1-based Capability, decoding the retransmission of the TB may be based on the TBS 2 being different than the TBS 1.

In an example embodiment, decoding the retransmission of the TB may be based on the TBS 2 being different than the TBS 1 and/or the second message indicating the retransmission of the TB with the different TBS than the initial transmission of the TB is the new transmission.

In an example embodiment, the wireless device may drop/discard the retransmission of the first TB (Option 2) in response to the second parameter indicating the Option2-based Capability. The wireless device may avoid decoding the retransmission of the first TB as the new transmission (e.g., Option 1 in FIG. 23 and/or FIG. 28) in response to the second parameter indicating the Option2-based Capability. In an example embodiment, the wireless device may avoid decoding the retransmission of the first TB as the new transmission (e.g., Option 1 in FIG. 23 and/or FIG. 28) in response to the second message (or the second parameter) not indicating the retransmission of the TB with the different TBS than the initial transmission of the TB is the new transmission.

In an example embodiment, the wireless device may drop/discard the retransmission of the first TB (e.g., Option 2 in FIG. 23 and/or FIG. 28) in response to the second message (or the second parameter) not indicating the retransmission of the TB with the different TBS than the initial transmission of the TB is the new transmission (e.g., not indicating the Option1-based Capability); and the retransmission of the first TB being with a different TBS than the initial transmission for the TB (e.g., the TBS 2 is not equal to the TBS 1 or the TBS 2 is different that the TBS 1).

In an example embodiment, the wireless device may avoid decoding the retransmission of the first TB as a new transmission (e.g., Option 2 in FIG. 23 and/or FIG. 28) in response to the second message (or the second parameter) not indicating the retransmission of the TB with the different TBS than the initial transmission of the TB is the new transmission (e.g., not indicating the Option1-based Capability); and the retransmission of the first TB being with a different TBS than the initial transmission for the TB (e.g., the TBS 2 is not equal to the TBS 1 or the TBS 2 is different that the TBS 1).

In an example embodiment, the wireless device may, based on the second message (or the second parameter) not indicating the retransmission of the TB with the different TBS than the initial transmission of the TB is the new transmission (e.g., not indicating the Option1-based Capability), not expect (or consider it as error) to receive the retransmission for the first TB with the different TB size than the initial transmission for the first TB (e.g., TBS 2 not equal to TBS 1).

Optionally, in the embodiment of FIG. 29B, the wireless device may further determine the first TB with the TBS 1 not being successfully decoded. The wireless device may, based on the first received data for the first TB not being successfully (correctly) decoded, (re-)place (or put) the first received data (of the first TB) in the first soft buffer. The first soft buffer may be for/or be associated with the first TB. For example, based on unsuccessfully (incorrectly) decoding the first received data (for the first TB), the wireless device may instruct the lower layers (e.g., PHY layer) of the wireless device to generate acknowledgment (NACK) for the first TB (e.g., only when the first HARQ process is feedback enabled). For example, the wireless device may transmit the HARQ-ACK with a negative value (NACK) corresponding to the HARQ process #n of the first TB (e.g., only when the first HARQ process is feedback enabled).

The first soft buffer may store/hold the first received data for the first TB. The first soft buffer may correspond to the first HARQ information comprising the HARQ process #n. The first soft buffer may correspond to (or associated with) the first TB. The first soft buffer comprises the first received data for the first TB. In some cases, the wireless device may, prior to placing/replacing the first received data in the first soft buffer and based on the received first TB (the first received data) being the very first (or earliest/starting/initial) transmission of the TB, flush the first soft buffer. By flushing the first soft buffer, the wireless device may delete/remove/discard any data in the first soft buffer.

Optionally, in the embodiment of FIG. 29B, the wireless device may consider the retransmission of the first TB as a new transmission of the first TB in response to the second message (or the second parameter) indicating the retransmission of the TB with the different TBS than the initial transmission of the TB is the new transmission (e.g., the Option1-based Capability); and the retransmission of the first TB being with a different TBS than the initial transmission for the TB (e.g., the TBS 2 is not equal to the TBS 1 or the TBS 2 is different that the TBS 1).

Optionally, in the embodiment of FIG. 29B, based on the first TB not been successfully decoded, the wireless device may (re-)place the second received data (for the first TB) in the first soft buffer for the first TB in response to the second message (or the second parameter) indicating the retransmission of the TB with the different TBS than the initial transmission of the TB is the new transmission (e.g., the Option1-based Capability); and the retransmission of the first TB being with a different TBS than the initial transmission for the TB (e.g., the TBS 2 is not equal to the TBS 1 or the TBS 2 is different that the TBS 1).

Additionally, in the embodiment of FIG. 29B, the wireless device may avoid combining the second received data with the first received data in the first soft buffer for the first TB. For example, corresponding to the retransmission of the first TB (e.g., the second received data) and based on the first TB not been successfully decoded, the wireless device may avoid instructing the physical layer to combine the second received data with the first received data currently in the first soft buffer (for the first TB).

Additionally, in the embodiment of FIG. 29B, the wireless device may decode the retransmission of the first TB as a new transmission (e.g., decode the second received data for the first TB) in response to the second message (or the second parameter) indicating the retransmission of the first TB with the different TBS than the initial transmission of the first TB is the new transmission (e.g., the Option1-based Capability); and the retransmission of the first TB being with a different TBS than the initial transmission for the first TB (e.g., the TBS 2 is not equal to the TBS 1 or the TBS 2 is different that the TBS 1). Additionally, if the wireless device successfully (correctly) decodes the second received data, the wireless device may disassemble/demultiplex the second MAC PDU for retransmission of the first TB and/or deliver the second MAC PDU for the retransmission of the first TB to higher layers (e.g., RLC/PDCP) layer. For example, based on successfully (correctly) decoding the second received data, the wireless device may instruct the lower layers (e.g., PHY layer) of the wireless device to generate acknowledgment (e.g., ACK) for the retransmission of the first TB (e.g., only when the HARQ process #n is feedback enabled). For example, the wireless device may (e.g., only when the HARQ process #n is feedback enabled) transmit the HARQ-ACK with positive value (the acknowledgment) corresponding to the HARQ process #n of the first TB.

Alternatively, in the embodiment of FIG. 29B, the wireless device may determine the second received data for the first TB not being successfully (correctly) decoded. The wireless device may, based on the second received data for the first TB not being successfully (correctly) decoded, instruct the lower layers (e.g., PHY layer) of the wireless device to generate acknowledgment (NACK) for the retransmission of the first TB (e.g., only when the HARQ process #n is feedback enabled). For example, the wireless device may transmit the HARQ-ACK with a negative value (NACK) corresponding to the HARQ process #n (e.g., only when the HARQ process #n is feedback enabled).

The base station may transmit the retransmission for the TB with the TBS 2 different than the TBS 1 based on the second message comprising the second parameter. In an example embodiment, the base station may transmit the retransmission for the TB with the TBS 2 different than the TBS 1 based on the second parameter indicating the retransmission of the TB with the different TBS than the initial transmission of the TB is the new transmission (e.g., the second parameter indicating the Option1-based Capability).

Optionally, the base station may further determine a decoding of the initial transmission for the TB being unsuccessful at the wireless device. For example, the base station may receive a HARQ-ACK information bit with a NACK value corresponding to the initial transmission of the first TB. In response to the NACK value corresponding to the initial transmission of the first TB and the second message comprising the second parameter, the base station may transmit the retransmission for the TB with the TBS 2 different than the TBS 1.

The base station may determine the second MCS index for retransmission for the TB with the TBS 2 based on the second parameter indicating the retransmission of the TB with the different TBS than the initial transmission of the TB is the new transmission (e.g., the second parameter indicating the Option2-based Capability). The base station may determine the second MCS regardless of the first MCS that is used for the initial transmission for the first TB.

In response to the second message not comprising/indicating the second parameter (e.g., not indicating the Option1-based Capability), the base station may avoid transmitting the retransmission for the TB with the TBS 2 different than the TBS 1. In response to the second message not comprising/indicating the second parameter, the base station may transmit the retransmission for the TB with the TBS 2 that is equal to the TBS 1. In response to the NACK value corresponding to the initial transmission of the first TB and the second message not comprising the second parameter, the base station may transmit the retransmission for the TB with the TBS 2 equal to the TBS 1. The base station may determine the second MCS based on the first MCS that is used for the initial transmission for the first TB. The second MCS and the first MCS may result in the same TBS for the TB.

Optionally, in the embodiment of FIG. 29B, the second message may comprise a third parameter. The third parameter may indicate whether the wireless device has a capability (e.g., fifteenth capability of the first set of capabilities) to combine in a soft buffer for a TB received data for an initial transmission of the TB and a received data for a retransmission of the TB and with different TB sizes.

When the second message comprises the third parameter, the wireless device may indicate that the wireless device has the capability to combine in the soft buffer for the TB the received data for the initial transmission of the TB and the received data for the retransmission of the TB and with different TBSs.

When the second message does not comprise the third parameter, the wireless device may not indicate that the wireless device has the capability to combine in the soft buffer for the TB the received data for the initial transmission of the TB and the received data for the retransmission of the TB and with different TBSs. In another example, when the second message does not comprise the third parameter, the wireless device may indicate that the wireless device does not have the capability to combine in the soft buffer for the TB the received data for the initial transmission of the TB and the received data for the retransmission of the TB and with different TBSs.

The fifteenth capability may indicate that the wireless device has the capability to combine in the soft buffer for the TB the received data for the initial transmission of the TB and the received data for the retransmission of the TB and with different TBSs.

Optionally, in the embodiment of FIG. 29B, based on the first TB not been successfully decoded; and the second message (e.g., the third parameter) indicating the fifteenth capability and the TBS2≠TBS1, the wireless device may combine the second received data (for the retransmission of the first TB) with the first received data for the initial transmission of the first TB in the first soft buffer. For example, the first soft buffer may comprise a combination of the first received data and the second received data.

For example, corresponding to the retransmission of the first TB (e.g., the second received data) with TBS2≠TBS1 and when the first TB is not successfully decoded, the wireless device may instruct the physical layer to combine the second received data with the first received data currently in the first soft buffer based on the second message (e.g., the third parameter) indicating the fifteenth capability.

Alternatively, in the embodiment of FIG. 29B, based on the first TB not been successfully decoded; and the second message (e.g., the third parameter) not indicating the fifteenth capability; and the TBS2≠TBS1, the wireless device may avoid combining the second received data (for the retransmission of the first TB) with the first received data for the initial transmission of the first TB in the first soft buffer. Additionally or alternatively, the wireless device may (re-)place the second received data (for the first TB) in the first soft buffer for the first TB based on the first TB not been successfully decoded; and the second message (e.g., the third parameter) not indicating the fifteenth capability; and the TBS2≠TBS1.

For example, corresponding to the retransmission of the first TB (e.g., the second received data) with TBS2≠TBS1 and when the first TB is not successfully decoded, the wireless device may avoid instructing the physical layer to combine the second received data with the first received data currently in the first soft buffer based on the second message (e.g., the third parameter) not indicating the fifteenth capability.

Alternatively, in the embodiment of FIG. 29B, the fifteenths capability may indicate a maximum TBS difference between the TBS 1 and the TBS 2 (e.g., TBS_diff) for combining in the soft buffer for the first TB the first received data (for the initial transmission of the first TB) and the second received data. Based on the first TB not been successfully decoded; and the second message indicating the fifteenth capability and the 0<|TBS2−TBS1|≤TBS_diff, the wireless device may combine the second received data (for the retransmission of the first TB) with the first received data for the initial transmission of the first TB in the first soft buffer. For example, the first soft buffer may comprise a combination of the first received data and the second received data. For example, corresponding to the retransmission of the first TB (e.g., the second received data) with TBS2≠TBS1 and when the first TB is not successfully decoded, the wireless device may instruct the physical layer to combine the second received data with the first received data currently in the first soft buffer based on the second message indicating the fifteenth capability and 0<|TBS2−TBS1|≤TBS_diff.

Optionally, in the present disclosure, the wireless device may determine the first condition being satisfied based on the second message (e.g., the first set of capabilities) comprising/indicating the fifteenth capability.

Alternatively, the wireless device may determine the first condition not being satisfied based on the second message (e.g., the first set of capabilities) not comprising/indicating the fifteenth capability.

The wireless device may attempt to decode the combined data (e.g., the combination of the second received data and the first received data). The wireless device may transmit the HARQ-ACK (e.g., ACK or NACK) based on decoding the combined data (e.g., the combination of the second received data and the first received data). If successfully decoding the combined data, the wireless device may transmit the HARQ-ACK information with the ACK value. If unsuccessfully decoding the combined data, the wireless device may transmit the HARQ-ACK information with the NACK value.

Alternatively, in the embodiment of FIG. 29B, based on the first TB not been successfully decoded; and the second message indicating the fifteenth capability and the |TBS2−TBS1|>TBS_diff, the wireless device may not combine the second received data (for the retransmission of the first TB) with the first received data for the initial transmission of the first TB in the first soft buffer. The wireless device may (re-)place the second received data (for the first TB) in the first soft buffer for the first TB based on the first TB not been successfully decoded; and the second message (e.g., the third parameter) not indicating the fifteenth capability; and |TBS2−TBS1|>TBS_diff.

Optionally, in the present disclosure, the wireless device may determine the first condition being satisfied based on |TBS2−TBS1|≤TBS_diff. The wireless device may determine the first condition not being satisfied based on |TBS2−TBS1|>TBS_diff.

Some embodiments of the present disclosure may improve alignment between the wireless device and/or the base station and/or improve spectral efficiency (e.g., reduce UL/DL resource waste) for transmitting data to the wireless device as the wireless device may avoid discarding the retransmission of the first TB with the TBS 2≠TBS 1 when the second message comprises the second parameter. In effect, the second message allows the base station to be aware of handing (e.g., choosing Option 1 or Option 2) of the retransmission of the first TB with the TBS 2≠TBS 1 in the wireless device.

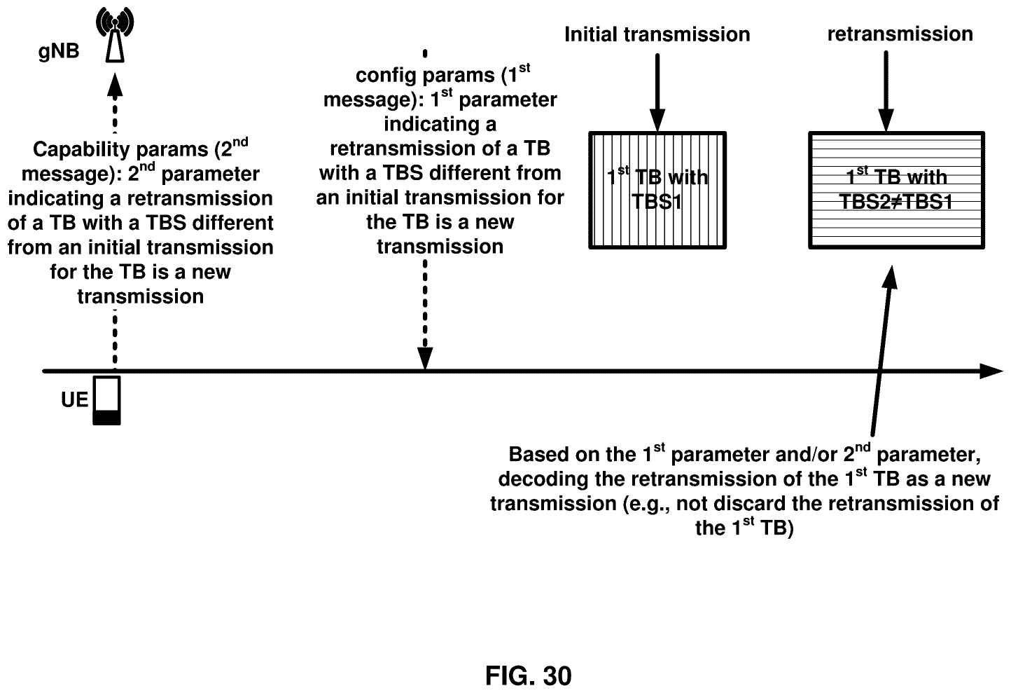

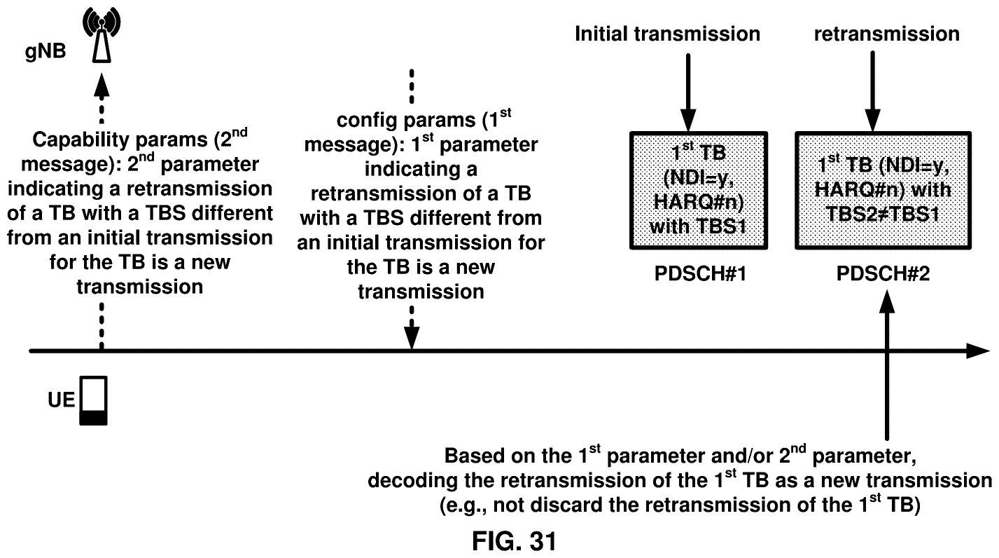

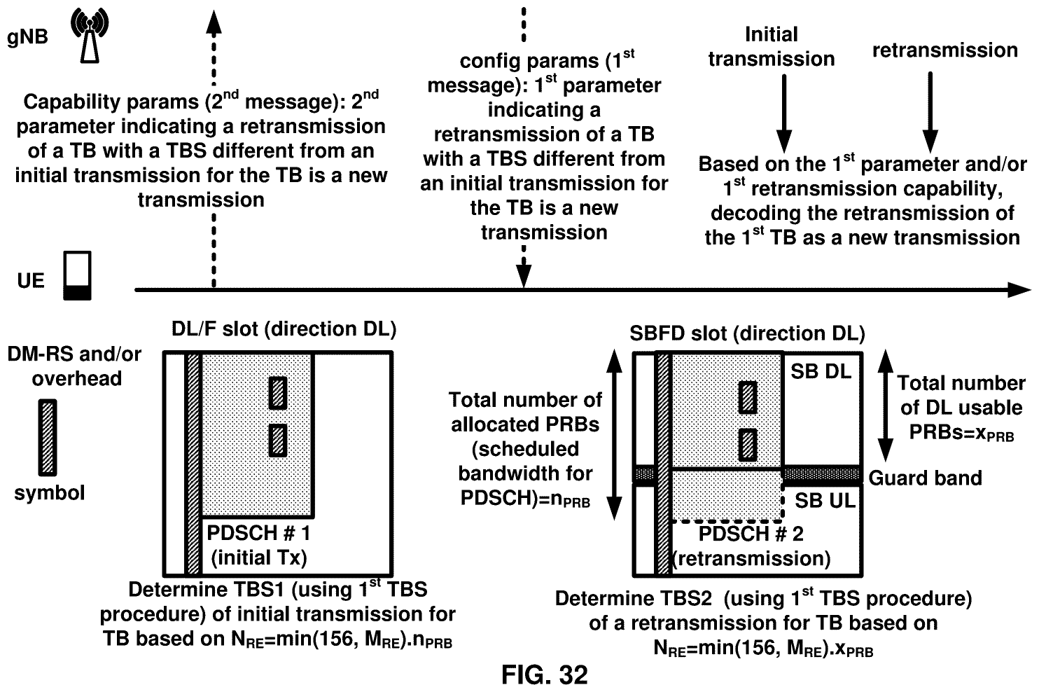

FIG. 30, FIG. 31, and FIG. 32 illustrate examples of downlink receptions as per aspects of embodiments of the present disclosure. In some aspects, FIG. 30, FIG. 31, and FIG. 32 may show some embodiments for combining embodiments of FIG. 29A and FIG. 29B. FIG. 32 may provide an example embodiment for SBFD operation. For example, FIG. 32 may provide one or more enhancements for FIG. 28 discussed above.

For example, the wireless device may receive from the base station the one or more configuration parameters. For the example of FIG. 32, the one or more configuration parameters may comprise the one or more SBFD configuration parameters.

The base station may receive the second message from the wireless device. In an example embodiment, the base station may, based on the receiving the second message, determine the first parameter of the first message. The base station may transmit to the wireless device the first message. For example, the second message may comprise the second parameter. For example, the first message may comprise the first parameter.

In one implementation, based on the second message comprising the second parameter, the first message may comprise the first parameter. For example, the first message may be the UE-specific message (e.g., RRC setup message, RRC reconfiguration message or the like). Alternatively, based on the second message comprising the second parameter, the first message may not comprise the first parameter. For example, the first message may be the UE-specific message (e.g., RRC setup message, RRC reconfiguration message or the like).

In another implementation, based on the second parameter indicating the Option1-based Capability, the base station may set the first parameter to indicate the retransmission of the transport block (TB) with the different TB size (TBS) than the initial transmission of the TB is the new transmission. For example, the first message may be the UE-specific message (e.g., RRC setup message, RRC reconfiguration message or the like). Some embodiments may improve the alignment between the wireless device and the base station may improve.

Alternatively, based on the second parameter indicating the Option1-based Capability, the first message may not comprise the first parameter. The advantage of this implementation is a reduction of signaling overhead. For example, the first message may be a cell-specific message, e.g., a broadcast information block (e.g., SIB1).

In another implementation, based on the second message not comprising the second parameter, the first message may comprise the first parameter. For example, based on the second parameter indicating the Option2-based Capability, the base station may set the first parameter to indicate the retransmission of the transport block (TB) with the different TB size (TBS) than the initial transmission of the TB is the new transmission. This allows the base station to properly configure the wireless device (via the first message) in order to not discard the retransmission of the first TB with TBS2≠TBS1. Some embodiments may improve the alignment between the wireless device and the base station may improve. For example, DL reliability for transmitting downlink data to wireless devices may increase.

As shown in FIG. 30 and FIG. 31, the wireless device may receive (from the base station) the first TB with the first TBS (TBS 1). Receiving the first TB may be via/using the first PDSCH (PDSCH #1 in F FIG. 31). For example, the base station may transmit the PDSCH #1 carrying/with the first TB. Receiving the PDSCH #1 may be based on a dynamic DL assignment (indicated by a DCI/or a RAR or a fallback RAR message). Receiving the PDSCH #1 may be based on a configured dynamic assignment (SPS PDSCH).

The first TB may be associated with the first HARQ information. The first HARQ information may comprise the HARQ process #n (a HARQ process with ID/index equal to n), an NDI value equal to y. The first HARQ information may comprise the first TBS.

The DCI may indicate the first HARQ information (e.g., the first MCS index, the HARQ process #n, and the NDI value y). The wireless device may determine the first HARQ information (e.g., the HARQ process #n) based on the one or more configuration parameters (e.g., SPS-config).

The wireless device may determine the first TBS (for receiving the first TB) based on the first TBS procedure (e.g., the first MCS index). For example, receiving the first TB with the TBS 1 may comprise (or be) an initial/earliest/starting/first transmission of the first TB.

An example of PDSCH #1 in the DL/F symbol/slot is shown in FIG. 32. The wireless device may follow the embodiment of FIG. 20 to determine the TBS1.

The wireless device may receive (from the base station) the retransmission of the first TB with the second TBS (TBS 2). Receiving the transmission of the first TB may be via/using the second PDSCH (PDSCH #2 in F FIG. 31). For example, the base station may transmit the PDSCH #2 carrying/with the first TB. Receiving the PDSCH #2 may be based on a second dynamic DL assignment (indicated by a second DCI). The retransmission of the first TB may be associated with a second HARQ information. The second HARQ information may comprise the HARQ process #n and the NDI value equal to y. The second HARQ information may comprise the second TBS.

The second DCI may indicate the second HARQ information (e.g., the second MCS index, the HARQ process #n, and the NDI value y). The wireless device may determine the second TBS (for receiving the retransmission of the first TB) based on the first TBS procedure (see FIG. 20), e.g., the second MCS index. Optionally or additionally, the wireless device may determine the TBS2 similar to embodiment(s) of FIG. 21A and/or FIG. 21B discussed above. For example, the wireless device may further determine the first TB with the TBS 1 not being successfully decoded.

FIG. 32 also shows an example that the receiving the PDSCH #1 is in/during the DL/F slot/symbols and the receiving the PDSCH #2 is in/during the SBFD slot/symbols. The wireless device may follow embodiments of FIG. 27A to determine the TBS 2.

Note that although FIG. 32 shows the case that the receiving the PDSCH #1 is in/during the DL/F slot/symbols and the receiving the PDSCH #2 is in/during the SBFD slot/symbols, other examples are also possible. For example, the receiving the PDSCH #1 may be in/during the SBFD slot/symbols and the receiving the PDSCH #2 may be in/during the DL/F slot/symbols. For this case, the same solution discussed in FIG. 32 may be applicable.

For example, the wireless device may determine the TBS 2 is different from the TBS 1.

The wireless device may determine the retransmission of the first TB being with a different TBS than the initial transmission for the TB.

In an example embodiment, as shown in FIG. 30 and/or FIG. 31, the wireless device may, based on the second message and/or the first message, determine whether to decode the retransmission of the first TB as the new transmission (e.g., Option 1 in FIG. 23 and/or FIG. 28) or drop/discard the retransmission of the first TB (Option 2 in FIG. 23 and/or FIG. 28).

In an example embodiment, the wireless device may decode the retransmission of the first TB as the new transmission (e.g., Option 1 in FIG. 23 and/or FIG. 28) in response to the second parameter indicating the Option1-based Capability and/or the first parameter indicating the retransmission of the TB with the different TBS than the initial transmission of the TB is the new transmission.

In an example embodiment, the wireless device may decode the retransmission of the first TB as the new transmission (e.g., Option 1 in FIG. 23 and/or FIG. 28) in response to the second parameter indicating the Option2-based Capability and/or the first parameter indicating the retransmission of the TB with the different TBS than the initial transmission of the TB is the new transmission.

In an example embodiment, the wireless device may decode the retransmission of the first TB as the new transmission (e.g., Option 1 in FIG. 23 and/or FIG. 28) in response to the second parameter indicating the Option1-based Capability.

In an example embodiment, the wireless device may decode the retransmission of the first TB as the new transmission (e.g., Option 1 in FIG. 23 and/or FIG. 28) in response to the first parameter indicating the retransmission of the TB with the different TBS than the initial transmission of the TB is the new transmission.

In an example embodiment, the wireless device may decode the retransmission of the first TB as the new transmission (e.g., Option 1 in FIG. 23 and/or FIG. 28) in response to the second message (or the second parameter) indicating the retransmission of the TB with the different TBS than the initial transmission of the TB is the new transmission and/or the first parameter indicating the retransmission of the TB with the different TBS than the initial transmission of the TB is the new transmission.

In an example embodiment, the wireless device may decode the retransmission of the first TB as a new transmission (e.g., Option 1 in FIG. 23 and/or FIG. 28) in response to the second message (or the second parameter) indicating the retransmission of the TB with the different TBS than the initial transmission of the TB is the new transmission (e.g., the Option1-based Capability); and the retransmission of the first TB being with a different TBS than the initial transmission for the TB (e.g., the TBS 2 is not equal to the TBS 1 or the TBS 2 is different that the TBS 1); and the first parameter indicating the retransmission of the TB with the different TBS than the initial transmission of the TB is the new transmission.

In an example embodiment, in response to the second parameter indicating the Option1-based Capability and the first parameter indicating the retransmission of the TB with the different TBS than the initial transmission of the TB is the new transmission, decoding the retransmission of the TB may be based on the TBS 2 being different than the TBS 1.

In an example embodiment, decoding the retransmission of the TB may be based on the TBS 2 being different than the TBS 1; and/or the second message indicating the retransmission of the TB with the different TBS than the initial transmission of the TB is the new transmission; and/or the first parameter indicating the retransmission of the TB with the different TBS than the initial transmission of the TB is the new transmission.

In an example embodiment, the wireless device may drop/discard the retransmission of the first TB (Option 2) in response to the second parameter indicating the Option2-based Capability and/or the first message not indicating/comprising the first parameter.

The wireless device may avoid decoding the retransmission of the first TB as the new transmission (e.g., Option 1 in FIG. 23 and/or FIG. 28) in response to the second parameter indicating the Option2-based Capability and/or the first message not indicating/comprising the first parameter.

In an example embodiment, the wireless device may avoid decoding the retransmission of the first TB as the new transmission (e.g., Option 1 in FIG. 23 and/or FIG. 28) in response to the second message (or the second parameter) not indicating the retransmission of the TB with the different TBS than the initial transmission of the TB is the new transmission and/or the first message (or the first parameter) not indicating the retransmission of the TB with the different TBS than the initial transmission of the TB is the new transmission.

In an example embodiment, the wireless device may drop/discard the retransmission of the first TB (e.g., Option 2 in FIG. 23 and/or FIG. 28) in response to the second message (or the second parameter) indicating the retransmission of the TB with the different TBS than the initial transmission of the TB is the new transmission (e.g., indicating the Option2-based Capability); and the retransmission of the first TB being with a different TBS than the initial transmission for the TB (e.g., the TBS 2 is not equal to the TBS 1 or the TBS 2 is different that the TBS 1); and/or the first message (or the first parameter) not indicating the retransmission of the TB with the different TBS than the initial transmission of the TB is the new transmission.

In an example embodiment, the wireless device may avoid decoding the retransmission of the first TB as a new transmission (e.g., Option 2 in FIG. 23 and/or FIG. 28) in response to the second message (or the second parameter) not indicating the retransmission of the TB with the different TBS than the initial transmission of the TB is the new transmission (e.g., not indicating the Option1-based Capability); and the retransmission of the first TB being with a different TBS than the initial transmission for the TB (e.g., the TBS 2 is not equal to the TBS 1 or the TBS 2 is different that the TBS 1); and/or the first message (or the first parameter) not indicating the retransmission of the TB with the different TBS than the initial transmission of the TB is the new transmission

In an example embodiment, the wireless device may, based on the second message (or the second parameter) not indicating the retransmission of the TB with the different TBS than the initial transmission of the TB is the new transmission (e.g., not indicating the Option1-based Capability) and/or the first message (or the first parameter) not indicating the retransmission of the TB with the different TBS than the initial transmission of the TB is the new transmission, not expect (or consider it as error) to receive the retransmission for the first TB with the different TB size than the initial transmission for the first TB (e.g., TBS 2 not equal to TBS 1).

Optionally, in the embodiments of FIG. 30 and/or FIG. 31 and/or FIG. 32, the wireless device may further determine the first TB with the TBS 1 not being successfully decoded. The wireless device may, based on the first received data for the first TB not being successfully (correctly) decoded, (re-)place (or put) the first received data (of the first TB) in a first soft buffer. The first soft buffer may be for/or be associated with the first TB. For example, based on unsuccessfully (incorrectly) decoding the first received data (for the first TB), the wireless device may instruct the lower layers (e.g., PHY layer) of the wireless device to generate acknowledgment (NACK) for the first TB (e.g., only when the first HARQ process is feedback enabled). For example, the wireless device may transmit the HARQ-ACK with a negative value (NACK) corresponding to a HARQ process #n of the first TB (e.g., only when the first HARQ process is feedback enabled).

The first soft buffer may store/hold the first received data for the first TB. The first soft buffer may correspond to the first HARQ information comprising the HARQ process #n. The first soft buffer may correspond to (or associated with) the first TB. The first soft buffer comprises the first received data for the first TB. In some cases, the wireless device may, prior to placing/replacing the first received data in the first soft buffer and based on the received first TB (the first received data) being the very first (or earliest/starting/initial) transmission of the TB, flush the first soft buffer. By flushing the first soft buffer, the wireless device may delete/remove/discard any data in the soft buffer.

Optionally, in the embodiments of FIG. 30 and/or FIG. 31 and/or FIG. 32, the wireless device may consider the retransmission of the first TB as a new transmission of the first TB in response to the second message comprising the second parameter; and/or the first message comprising the first parameter; and/or the retransmission of the first TB being with a different TBS than the initial transmission for the TB (e.g., the TBS 2 is not equal to the TBS 1 or the TBS 2 is different that the TBS 1). For example, the wireless device may consider the retransmission of the first TB as a new transmission of the first TB in response to the second parameter indicating the Option1-based Capability and/or the first parameter indicating the retransmission of the TB with the different TBS than the initial transmission of the TB is the new transmission; and/or the retransmission of the first TB being with a different TBS than the initial transmission for the TB (e.g., the TBS 2 is not equal to the TBS 1 or the TBS 2 is different that the TBS 1).

Optionally, in the embodiments of FIG. 30 and/or FIG. 31 and/or FIG. 32, based on the first TB not been successfully decoded, the wireless device may (re-)place the second received data (for the first TB) in the first soft buffer for the first TB in response to the second parameter indicating the Option1-based Capability and/or the first parameter indicating the retransmission of the TB with the different TBS than the initial transmission of the TB is the new transmission; and the retransmission of the first TB being with a different TBS than the initial transmission for the TB (e.g., the TBS 2 is not equal to the TBS 1 or the TBS 2 is different that the TBS 1). Additionally, the wireless device may avoid combining the second received data with the first received data in the soft buffer for the first TB. Additionally, corresponding to the retransmission of the first TB (e.g., the second received data) and based on the first TB not been successfully decoded, the wireless device may avoid instructing the physical layer to combine the second received data with the first received data currently in the first soft buffer (for the first TB).

Additionally, in the embodiments of FIG. 30 and/or FIG. 31 and/or FIG. 32, the wireless device may decode the retransmission of the first TB as a new transmission (e.g., decode the second received data for the first TB). If the wireless device successfully (correctly) decodes the second received data, the wireless device may disassemble/demultiplex the second MAC PDU for the retransmission of the first TB and/or deliver the second MAC PDU of the retransmission of the first TB to higher layers (e.g., RLC/PDCP) layer. For example, based on successfully (correctly) decoding the second received data, the wireless device may instruct the lower layers (e.g., PHY layer) of the wireless device to generate acknowledgment (e.g., ACK) for the retransmission of the first TB (e.g., only when the HARQ process #n is feedback enabled). For example, the wireless device may (e.g., only when the HARQ process #n is feedback enabled) transmit the HARQ-ACK with positive value (the acknowledgment) corresponding to the HARQ process #n of the first TB.

Alternatively, in the embodiments of FIG. 30 and/or FIG. 31 and/or FIG. 32, the wireless device may determine the second received data for the first TB not being successfully (correctly) decoded. The wireless device may, based on the second received data for the first TB not being successfully (correctly) decoded, instruct the lower layers (e.g., PHY layer) of the wireless device to generate acknowledgment (NACK) for the first TB (e.g., only when the HARQ process #n is feedback enabled). For example, the wireless device may transmit the HARQ-ACK with a negative value (NACK) corresponding to the HARQ process #n of the first TB (e.g., only when the HARQ process #n is feedback enabled).

Some embodiments (e.g., FIG. 32) may improve DL transmission efficiency in the SBFD operations.

Optionally, in FIG. 32, the wireless device may determine the first condition being satisfied.

Alternatively, in FIG. 32, the wireless device may determine the first condition not being satisfied.

Optionally, in the embodiment of FIG. 32, the wireless device may, based on the second message (or the second parameter) not indicating the retransmission of the TB with the different TBS than the initial transmission of the TB is the new transmission (e.g., not indicating the Option1-based Capability) and/or the first message (or the first parameter) not indicating the retransmission of the TB with the different TBS than the initial transmission of the TB is the new transmission, expect to receive the retransmission for the first TB in/during a slot/symbol(s) with a first symbol/slot type that is used for the initial transmission for the first TB. The first symbol/slot type may be SBFD. The first symbol/slot type may non-SBFD (e.g., DL/F)

Optionally, in the embodiment of FIG. 32, based on the second message (or the second parameter) not indicating the retransmission of the TB with the different TBS than the initial transmission of the TB is the new transmission (e.g., not indicating the Option1-based Capability) and/or the first message (or the first parameter) not indicating the retransmission of the TB with the different TBS than the initial transmission of the TB is the new transmission, receiving (by the wireless device from the base station) the retransmission for the first TB may be in/during the SBFD symbol(s)/slot and receiving (by the wireless device from the base station) the initial transmission for the first TB may be in/during the SBFD symbol(s)/slot.

Optionally, in the embodiment of FIG. 32, based on the second message (or the second parameter) not indicating the retransmission of the TB with the different TBS than the initial transmission of the TB is the new transmission (e.g., not indicating the Option1-based Capability) and/or the first message (or the first parameter) not indicating the retransmission of the TB with the different TBS than the initial transmission of the TB is the new transmission, receiving (by the wireless device from the base station) the retransmission for the first TB may be in/during the non-SBFD (DL/F) symbol(s)/slot and receiving (by the wireless device from the base station) the initial transmission for the first TB may be in/during the non-SBFD (DL/F) symbol(s)/slot.

Optionally, in the embodiment of FIG. 32, based on the second message (or the second parameter) not indicating the retransmission of the TB with the different TBS than the initial transmission of the TB is the new transmission (e.g., not indicating the Option1-based Capability); and/or the first message (or the first parameter) not indicating the retransmission of the TB with the different TBS than the initial transmission of the TB is the new transmission; and receiving the initial transmission for the first TB being in/during the SBFD symbol(s)/slot, the wireless device may avoid receiving the retransmission for the first TB in/during the non-SBFD symbol(s)/slot.

Optionally, in the embodiment of FIG. 32, based on the second message (or the second parameter) not indicating the retransmission of the TB with the different TBS than the initial transmission of the TB is the new transmission (e.g., not indicating the Option1-based Capability); and/or the first message (or the first parameter) not indicating the retransmission of the TB with the different TBS than the initial transmission of the TB is the new transmission; and receiving the initial transmission for the first TB being in/during the SBFD symbol(s)/slot, the wireless device may receive the retransmission for the first TB in/during the SBFD symbol(s)/slot.

Optionally, in the embodiment of FIG. 32, based on the second message (or the second parameter) not indicating the retransmission of the TB with the different TBS than the initial transmission of the TB is the new transmission (e.g., not indicating the Option1-based Capability); and/or the first message (or the first parameter) not indicating the retransmission of the TB with the different TBS than the initial transmission of the TB is the new transmission; and receiving the initial transmission for the first TB being in/during the non-SBFD symbol(s)/slot, the wireless device may avoid receiving the retransmission for the first TB in/during the SBFD symbol(s)/slot.

Optionally, in the embodiment of FIG. 32, based on the second message (or the second parameter) not indicating the retransmission of the TB with the different TBS than the initial transmission of the TB is the new transmission (e.g., not indicating the Option1-based Capability); and/or the first message (or the first parameter) not indicating the retransmission of the TB with the different TBS than the initial transmission of the TB is the new transmission; and receiving the initial transmission for the first TB being in/during the non-SBFD symbol(s)/slot, the wireless device may receive the retransmission for the first TB in/during the non-SBFD symbol(s)/slot.

Optionally, in the embodiment of FIG. 32, the wireless device may, based on the second message (or the second parameter) indicating the retransmission of the TB with the different TBS than the initial transmission of the TB is the new transmission (e.g., indicating the Option1-based Capability) and/or the first message (or the first parameter) indicating the retransmission of the TB with the different TBS than the initial transmission of the TB is the new transmission, expect to receive the retransmission for the first TB in/during a slot/symbol(s) with a first symbol/slot type that may be different for the initial transmission for the first TB. The first symbol/slot type may be SBFD. The first symbol/slot type may non-SBFD (e.g., DL/F)

Optionally, in the embodiment of FIG. 32, based on the second message (or the second parameter) indicating the retransmission of the TB with the different TBS than the initial transmission of the TB is the new transmission (e.g., indicating the Option1-based Capability) and/or the first message (or the first parameter) indicating the retransmission of the TB with the different TBS than the initial transmission of the TB is the new transmission, receiving the retransmission for the first TB (by the wireless device) may be in/during the SBFD symbol(s)/slot and receiving the initial transmission for the first TB may be in/during the non-SBFD symbol(s)/slot.

Optionally, in the embodiment of FIG. 32, based on the second message (or the second parameter) indicating the retransmission of the TB with the different TBS than the initial transmission of the TB is the new transmission (e.g., indicating the Option1-based Capability) and/or the first message (or the first parameter) indicating the retransmission of the TB with the different TBS than the initial transmission of the TB is the new transmission, receiving the retransmission (by the wireless device) for the first TB may be in/during the non-SBFD (DL/F) symbol(s)/slot and receiving the initial transmission for the first TB may be in/during the SBFD (DL/F) symbol(s)/slot.

In an example embodiment, the base station may, based on the second message (or the second parameter) not indicating the retransmission of the TB with the different TBS than the initial transmission of the TB is the new transmission (e.g., not indicating the Option1-based Capability) and/or the first message (or the first parameter) not indicating the retransmission of the TB with the different TBS than the initial transmission of the TB is the new transmission, transmit the retransmission for the first TB in/during a slot/symbol(s) with a first symbol/slot type that is used for the initial transmission for the first TB. The first symbol/slot type may be SBFD. The first symbol/slot type may non-SBFD (e.g., DL/F)

Optionally, in the embodiment of FIG. 32, based on the second message (or the second parameter) not indicating the retransmission of the TB with the different TBS than the initial transmission of the TB is the new transmission (e.g., not indicating the Option1-based Capability) and/or the first message (or the first parameter) not indicating the retransmission of the TB with the different TBS than the initial transmission of the TB is the new transmission, the base station may transmit (to the wireless device) the retransmission for the first TB in/during the SBFD symbol(s)/slot and transmit the initial transmission for the first TB in/during the SBFD symbol(s)/slot.

Optionally, in the embodiment of FIG. 32, based on the second message (or the second parameter) not indicating the retransmission of the TB with the different TBS than the initial transmission of the TB is the new transmission (e.g., not indicating the Option1-based Capability) and/or the first message (or the first parameter) not indicating the retransmission of the TB with the different TBS than the initial transmission of the TB is the new transmission, the base station may transmit (to the wireless device) the retransmission for the first TB in/during the non-SBFD (DL/F) symbol(s)/slot and transmit the initial transmission for the first TB in/during the non-SBFD (DL/F) symbol(s)/slot.

Optionally, in the embodiment of FIG. 32, based on the second message (or the second parameter) not indicating the retransmission of the TB with the different TBS than the initial transmission of the TB is the new transmission (e.g., not indicating the Option1-based Capability); and/or the first message (or the first parameter) not indicating the retransmission of the TB with the different TBS than the initial transmission of the TB is the new transmission; and transmitting to the wireless device the initial transmission for the first TB in/during the SBFD symbol(s)/slot, the base station may transmit the retransmission for the first TB in/during the SBFD symbol(s)/slot.

Optionally, in the embodiment of FIG. 32, based on the second message (or the second parameter) not indicating the retransmission of the TB with the different TBS than the initial transmission of the TB is the new transmission (e.g., not indicating the Option1-based Capability); and/or the first message (or the first parameter) not indicating the retransmission of the TB with the different TBS than the initial transmission of the TB is the new transmission; and transmitting to the wireless device the initial transmission for the first TB being in/during the SBFD symbol(s)/slot, the base station may transmit the retransmission for the first TB in/during the SBFD symbol(s)/slot.

Optionally, in the embodiment of FIG. 32, based on the second message (or the second parameter) not indicating the retransmission of the TB with the different TBS than the initial transmission of the TB is the new transmission (e.g., not indicating the Option1-based Capability); and/or the first message (or the first parameter) not indicating the retransmission of the TB with the different TBS than the initial transmission of the TB is the new transmission; and transmitting the initial transmission for the first TB in/during the non-SBFD symbol(s)/slot, the base station may avoid transmitting the retransmission for the first TB in/during the SBFD symbol(s)/slot.

Optionally, in the embodiment of FIG. 32, based on the second message (or the second parameter) not indicating the retransmission of the TB with the different TBS than the initial transmission of the TB is the new transmission (e.g., not indicating the Option1-based Capability); and/or the first message (or the first parameter) not indicating the retransmission of the TB with the different TBS than the initial transmission of the TB is the new transmission; and transmitting the initial transmission for the first TB in/during the SBFD symbol(s)/slot, the base station may avoid transmitting the retransmission for the first TB may be in/during the non-SBFD symbol(s)/slot.

Optionally, in the embodiment of FIG. 32, the base station may, based on the second message (or the second parameter) indicating the retransmission of the TB with the different TBS than the initial transmission of the TB is the new transmission (e.g., indicating the Option1-based Capability) and/or the first message (or the first parameter) indicating the retransmission of the TB with the different TBS than the initial transmission of the TB is the new transmission, transmit the retransmission for the first TB in/during a slot/symbol(s) with a first symbol/slot type that is different for the initial transmission for the first TB. The first symbol/slot type may be SBFD. The first symbol/slot type may be non-SBFD (e.g., DL/F).

Optionally, in the embodiment of FIG. 32, based on the second message (or the second parameter) indicating the retransmission of the TB with the different TBS than the initial transmission of the TB is the new transmission (e.g., indicating the Option1-based Capability) and/or the first message (or the first parameter) indicating the retransmission of the TB with the different TBS than the initial transmission of the TB is the new transmission, the base station may transmit to the wireless device the retransmission for the first TB in/during the SBFD symbol(s)/slot and transmit to the wireless device the initial transmission for the first TB in/during the non-SBFD symbol(s)/slot.

Optionally, in the embodiment of FIG. 32, based on the second message (or the second parameter) indicating the retransmission of the TB with the different TBS than the initial transmission of the TB is the new transmission (e.g., indicating the Option1-based Capability) and/or the first message (or the first parameter) indicating the retransmission of the TB with the different TBS than the initial transmission of the TB is the new transmission, the base station may transmit to the wireless device the retransmission for the first TB in/during the non-SBFD (DL/F) symbol(s)/slot and transmit to the wireless device the initial transmission for the first TB in/during the SBFD (DL/F) symbol(s)/slot.

Optionally, in the embodiment of FIG. 32, the one or more configuration parameters may comprise a fourth parameter. For example, the first message may comprise the fourth parameter. The fourth parameter may indicate whether a retransmission for a TB in/during a slot/symbol(s) with a first symbol/slot type that is the same for an initial transmission for the TB. The first symbol/slot type may be non-SBFD (e.g., DL/F). The first symbol/slot type may be SBFD.

The fourth parameter may indicate a first value (enabled or true or 1 or configured) or a second value (disabled or false or 0). Using the fourth parameter, alignment between the wireless device and the base station may increase. For example, when the second parameter indicates the Option2-based capability, the base station may configure the fourth parameter to the second value. When the second parameter indicates the Option1-based capability, the base station may configure the fourth parameter to the first value.

In some implementations, when the first message (or the one or more configuration parameters) does not comprise the fourth parameter (e.g., the fourth parameter is absent from the one or more configuration parameters), the wireless device may determine the fourth parameter indicates the second value. When the first message (or the one or more configuration parameters) comprises the fourth parameter (e.g., the fourth parameter is not absent from the one or more configuration parameters), the wireless device may determine the fourth parameter indicates the first value.

In some other implementations, when the first message (or the one or more configuration parameters) does not comprise the fourth parameter (e.g., the fourth parameter is absent from the one or more configuration parameters), the wireless device may determine the fourth parameter indicates the first value. When the first message (or the one or more configuration parameters) comprises the fourth parameter (e.g., the fourth parameter is not absent from the one or more configuration parameters), the wireless device may determine the fourth parameter indicates the second value.

In one example, when the fourth parameter indicates the first value, the fourth parameter may indicate the initial transmission for the TB is in an SBFD symbol/slot and the retransmission for the TB is (also) in/during an SBFD symbol/slot. Optionally, in the embodiment of FIG. 32, based on receiving the initial transmission of the TB (PDSCH #1) in a first SBFD symbol/slot (of the at least one SBFD symbol/slot) and the fourth parameter indicating the first value, the wireless device may receive the retransmission of the first TB in a second SBFD symbol/slot (of the at least one SBFD symbol/slot). Based on receiving the initial transmission of the TB (PDSCH #1) in a first non-SBFD symbol/slot (a first DL/F symbol/slot) and the fourth parameter indicating the first value, the wireless device may receive the retransmission of the first TB in a second non-SBFD symbol/slot (a second DL/F symbol/slot).

Optionally, in the embodiment of FIG. 32, when the fourth parameter indicates the first value, the wireless device may use embodiments of FIG. 29A, FIG. 29B, FIG. 30, FIG. 31, and/or FIG. 32 for receiving the retransmission of the first TB.

Optionally, in the embodiment of FIG. 32, based on receiving the initial transmission of the TB (PDSCH #1) in a first SBFD symbol/slot (of the at least one SBFD symbol/slot) and the fourth parameter indicating the second value, the wireless device may receive the retransmission of the first TB in the second non-SBFD symbol/slot (the second DL/F symbol/slot). Based on receiving the initial transmission of the TB (PDSCH #1) in the first non-SBFD symbol/slot (the first DL/F symbol/slot) and the fourth parameter indicating the second value, the wireless device may receive the retransmission of the first TB in the second SBFD symbol/slot.

Optionally, in the embodiment of FIG. 32, based on transmitting the initial transmission of the TB (PDSCH #1) in the first SBFD symbol/slot (of the at least one SBFD symbol/slot) and the fourth parameter indicating the first value, the base station may transmit to the wireless device the retransmission of the first TB in the second SBFD symbol/slot (of the at least one SBFD symbol/slot).

Optionally, in the embodiment of FIG. 32, based on transmitting the initial transmission of the TB (PDSCH #1) in the first non-SBFD symbol/slot (the first DL/F symbol/slot) and the fourth parameter indicating the first value, the base station may transmit to the wireless device the retransmission of the first TB in the second non-SBFD symbol/slot (the second DL/F symbol/slot).

Optionally, in the embodiment of FIG. 32, when the fourth parameter indicates the first value, the base station may use embodiments of FIG. 29A, FIG. 29B, FIG. 30, FIG. 31, and/or FIG. 32 for transmitting the retransmission of the first TB.

Optionally, in the embodiment of FIG. 32, based on transmitting the initial transmission of the TB (PDSCH #1) in the first SBFD symbol/slot (of the at least one SBFD symbol/slot) and the fourth parameter indicating the second value, the base station may transmit the retransmission of the first TB in the second non-SBFD symbol/slot (the second DL/F symbol/slot).

Optionally, in the embodiment of FIG. 32, based on transmitting the initial transmission of the TB (PDSCH #1) in the first non-SBFD symbol/slot (the first DL/F symbol/slot) and the fourth parameter indicating the second value, the base station may transmit the retransmission of the first TB in the second SBFD symbol/slot.

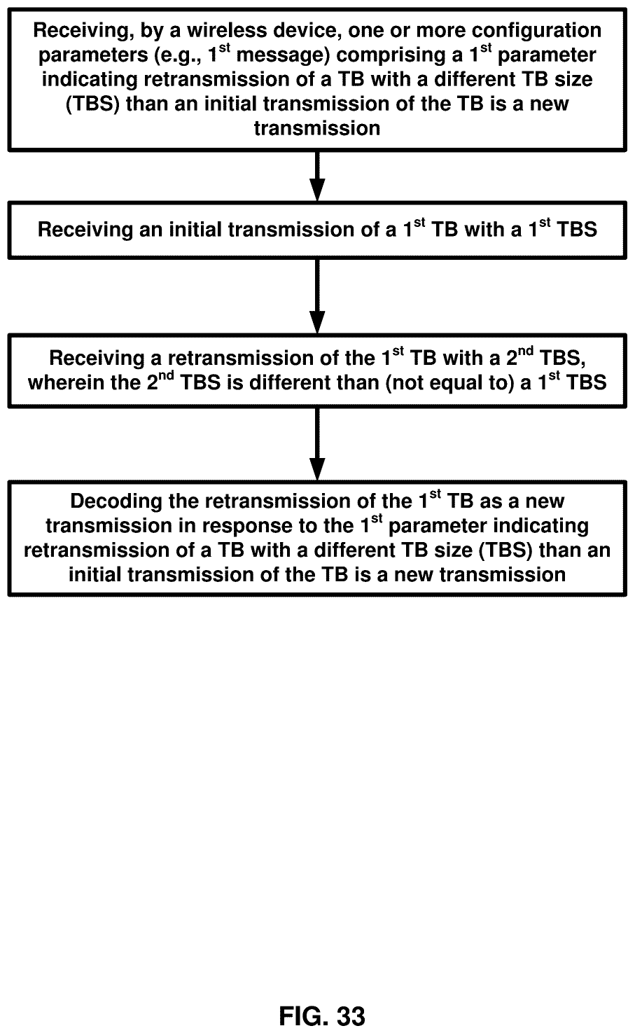

FIG. 33 illustrates an example flowchart of a downlink procedure as per an aspect of an embodiment of the present disclosure. The wireless device may receive the one or more configuration parameters (e.g., the first message) comprising the first parameter indicating a retransmission of a transport block (TB) with a different TB size (TBS) than an initial transmission of the TB is a new transmission. The wireless device may receive (an initial transmission of) a first TB with a first TBS. The wireless device may receive a retransmission of the first TB with a second TBS, wherein the first TBS is different than the second TBS. The wireless device may decode the retransmission of the first TB as a new transmission based on the first parameter.

In an example embodiment, the wireless device may receive the one or more configuration parameters (e.g., the first message) comprising the first parameter indicating a retransmission of a transport block (TB) with a different TB size (TBS) than an initial transmission of the TB is a new transmission. The wireless device may receive (an initial transmission of) a first TB with a first TBS. The wireless device may receive a retransmission of the first TB with a second TBS. In response to the second TBS being different than the first TBS, the wireless device may decode the retransmission of the first TB as a new transmission based on the first parameter.

In an example embodiment, the wireless device may receive the one or more configuration parameters (e.g., the first message) comprising the first parameter indicating a retransmission of a transport block (TB) with a different TB size (TBS) than an initial transmission of the TB is a new transmission. The wireless device may receive (an initial transmission of) a first TB with a first TBS. The wireless device may receive a retransmission of the first TB with a second TBS, wherein the first TBS is different than the second TBS. The wireless device may decode the retransmission of the first TB as a new transmission in response to the first parameter indicating the retransmission of the TB with the different TBS than the initial transmission of the TB is the new transmission.

In an example embodiment, the wireless device may receive (an initial transmission of) a first TB with a first TBS. The wireless device may receive a retransmission of the first TB with a second TBS. In response to the second TBS being different than the first TBS, the wireless device may discard the retransmission of the first TB based on the one or more configuration parameters (e.g., the first message) not indicating a retransmission of a transport block (TB) with a different TB size (TBS) than an initial transmission of the TB is a new transmission.

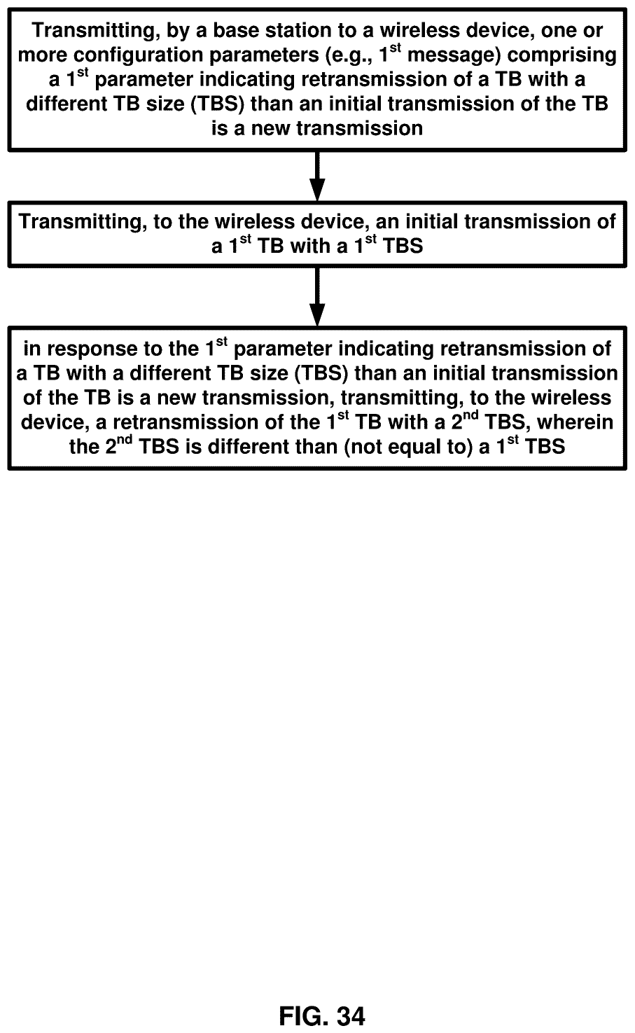

FIG. 34 illustrates an example flowchart of a downlink procedure as per an aspect of an embodiment of the present disclosure. The base station may transmit to the wireless device the one or more configuration parameters (e.g., the first message) comprising the first parameter indicating a retransmission of a transport block (TB) with a different TB size (TBS) than an initial transmission of the TB is a new transmission. The base station may transmit to the wireless device (an initial transmission of) a first TB with a first TBS. Based on the first parameter, the base station may transmit to the wireless device a retransmission of the first TB with a second TBS, wherein the first TBS is different than the second TBS.

In an example embodiment, the base station may transmit to the wireless device the one or more configuration parameters (e.g., the first message) comprising the first parameter indicating a retransmission of a transport block (TB) with a different TB size (TBS) than an initial transmission of the TB is a new transmission. The base station may transmit to the wireless device (an initial transmission of) a first TB with a first TBS. Based on the first parameter indicating the retransmission of the TB with the different TBS than the initial transmission of the TB is the new transmission, the base station may transmit to the wireless device a retransmission of the first TB with a second TBS, wherein the first TBS is different than the second TBS.

In an example embodiment, the base station may transmit to the wireless device the one or more configuration parameters. The base station may transmit to the wireless device (an initial transmission of) a first TB with a first TBS. Based on the one or more configuration parameters not comprising the first parameter, the base station may transmit to the wireless device a retransmission of the first TB with the first TBS.

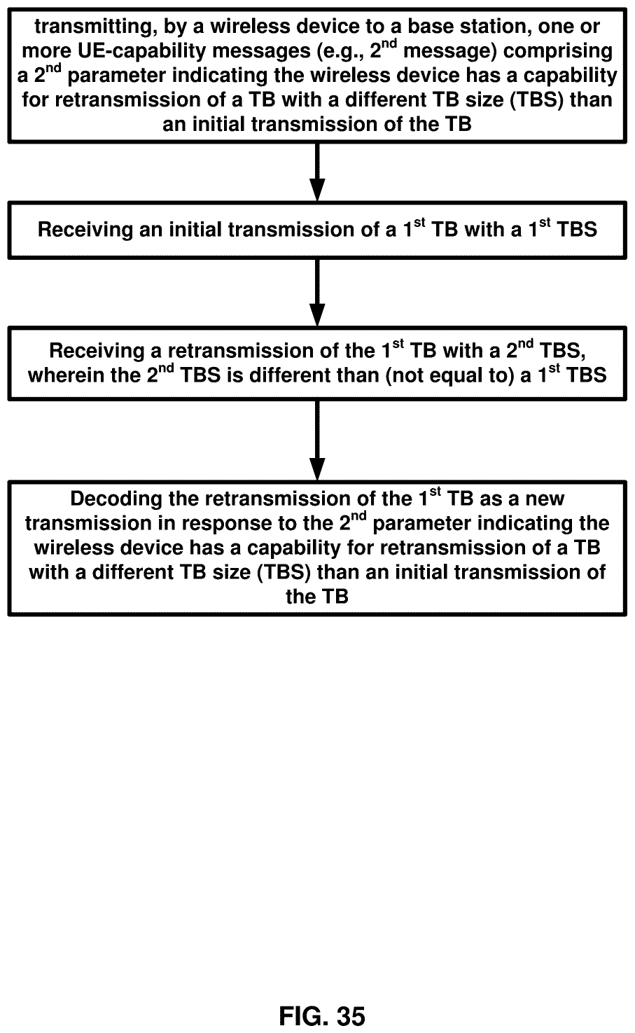

FIG. 35 illustrates an example flowchart of a decoding procedure as per an aspect of an embodiment of the present disclosure. The wireless device may transmit one or more UE-capability messages (e.g., the second message) comprising the second parameter indicating the wireless device has a capability (e.g., the Option1-based Capability) for retransmission of a TB with a different TB size (TBS) than an initial transmission of the TB. The wireless device may receive (an initial transmission of) a first TB with a first TBS. The wireless device may receive a retransmission of the first TB with a second TBS, wherein the first TBS is different than the second TBS. The wireless device may decode the retransmission of the first TB as a new transmission based on the second parameter.

In an example embodiment, the wireless device may transmit one or more UE-capability messages (e.g., the second message) comprising the second parameter indicating the wireless device has a capability (e.g., the Option1-based Capability) for retransmission of a TB with a different TB size (TBS) than an initial transmission of the TB. The wireless device may receive (an initial transmission of) a first TB with a first TBS. The wireless device may receive a retransmission of the first TB with a second TBS. In response to the second TBS being different than the first TBS, the wireless device may decode the retransmission of the first TB as a new transmission based on the second parameter.

In an example embodiment, the wireless device may transmit one or more UE-capability messages (e.g., the second message) comprising the second parameter indicating the wireless device has a capability (e.g., the Option1-based Capability) for retransmission of a TB with a different TB size (TBS) than an initial transmission of the TB. The wireless device may receive (an initial transmission of) a first TB with a first TBS. The wireless device may receive a retransmission of the first TB with a second TBS, wherein the first TBS is different than the second TBS. The wireless device may decode the retransmission of the first TB as a new transmission in response to the second message indicating the Option1-based Capability.

In an example embodiment, the wireless device may transmit one or more UE-capability messages. The wireless device may receive (an initial transmission of) a first TB with a first TBS. The wireless device may receive a retransmission of the first TB with a second TBS. In response to the second TBS being different than the first TBS, the wireless device may discard the retransmission of the first TB based on the UE-capability messages not indicating the wireless device has a capability (e.g., the Option1-based Capability) for retransmission of a TB with a different TB size (TBS) than an initial transmission of the TB.

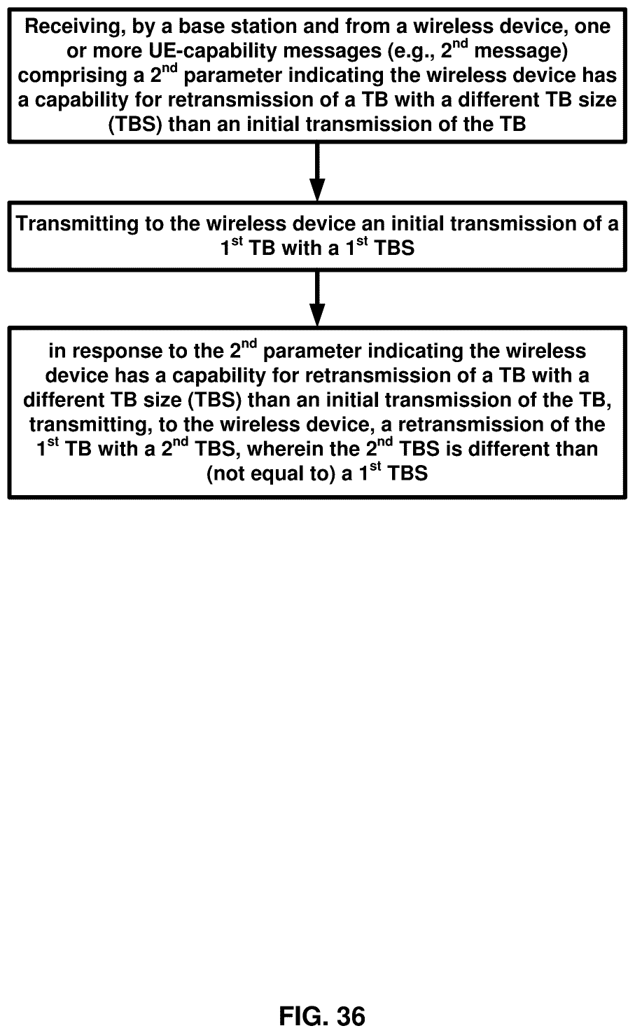

FIG. 36 illustrates an example flowchart of a capability procedure as per an aspect of an embodiment of the present disclosure. The base station may receive from the wireless device the one or more UE-capability messages (e.g., the second message) comprising the second parameter indicating the wireless device has a capability (e.g., the Option1-based Capability) for retransmission of a TB with a different TB size (TBS) than an initial transmission of the TB. The base station may transmit to the wireless device (an initial transmission of) a first TB with a first TBS. Based on the second parameter, the base station may transmit to the wireless device a retransmission of the first TB with a second TBS, wherein the first TBS is different than the second TBS.

In an example embodiment, the base station may receive from the wireless device the one or more UE-capability messages. The base station may transmit to the wireless device a first TB with a first TBS. In response to the one or more UE-capability messages (e.g., the second message) not indicating the wireless device has a capability (e.g., the Option1-based Capability) for retransmission of a TB with a different TB size (TBS) than an initial transmission of the TB, the base station may avoid transmitting to the wireless device the retransmission of the first TB with a second TBS different than the first TBS.

In an example embodiment, the base station may receive from the wireless device the one or more UE-capability messages. The base station may transmit to the wireless device a first TB with a first TBS. In response to the one or more UE-capability messages (e.g., the second message) not indicating the wireless device has a capability (e.g., the Option1-based Capability) for retransmission of a TB with a different TB size (TBS) than an initial transmission of the TB, the base station may transmit to the wireless device the retransmission of the first TB with the second TBS equal to the first TBS.

In an example embodiment, the wireless device may transmit one or more UE-capability messages (e.g., the second message) comprising the second parameter indicating the wireless device has a capability (e.g., the Option1-based Capability) for retransmission of a TB with a different TB size (TBS) than an initial transmission of the TB. The wireless device may receive the one or more configuration parameters (e.g., the first message) comprising the first parameter indicating a retransmission of a transport block (TB) with a different TB size (TBS) than an initial transmission of the TB is a new transmission. The wireless device may receive (an initial transmission of) a first TB with a first TBS. The wireless device may receive a retransmission of the first TB with a second TBS, wherein the first TBS is different than the second TBS. The wireless device may decode the retransmission of the first TB as a new transmission in response to the first parameter indicating the retransmission of the TB with the different TBS than the initial transmission of the TB is the new transmission and/or the second parameter indicating the wireless device has a capability (e.g., the Option1-based Capability) for retransmission of a TB with a different TB size (TBS) than an initial transmission of the TB.

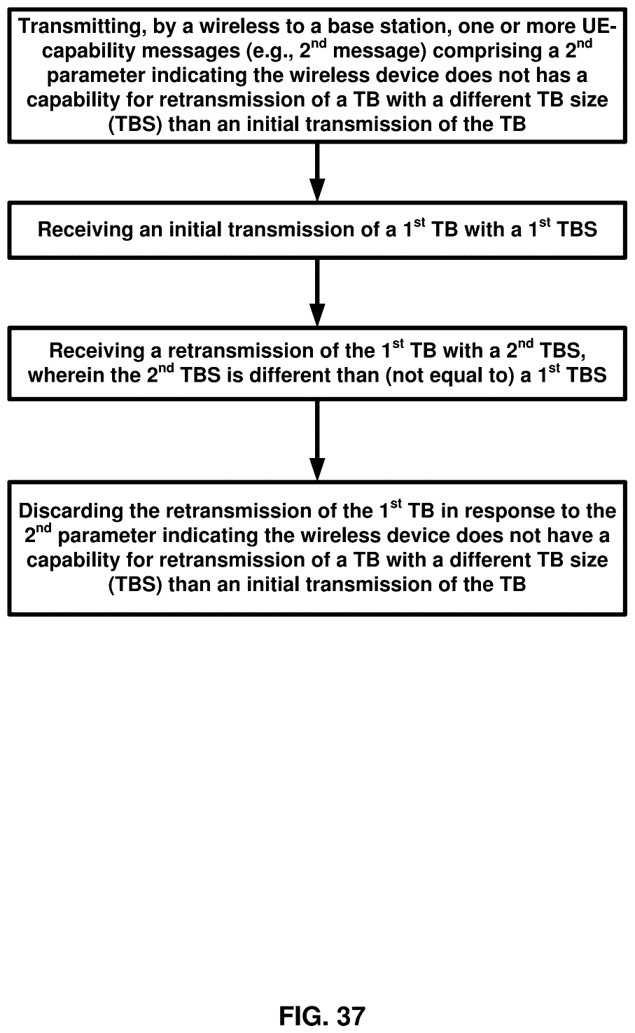

FIG. 37 illustrates an example flowchart of a retransmission procedure as per an aspect of an embodiment of the present disclosure. The wireless device may transmit one or more UE-capability messages (e.g., the second message) comprising the second parameter indicating the wireless device does not have a capability (e.g., the Option1-based Capability) for a retransmission of a TB with a different TB size (TBS) than an initial transmission of the TB. The wireless device may receive (an initial transmission of) a first TB with a first TBS. The wireless device may receive a retransmission of the first TB with a second TBS, wherein the first TBS is different than the second TBS. In response to the second TBS being different than the first TBS and the second parameter not indicating the Option1-based capability, the wireless device may discard the retransmission of the first TB.

In an example embodiment, the wireless device may transmit one or more UE-capability messages (e.g., the second message) comprising the second parameter indicating the wireless device has a capability (e.g., the Option2-based Capability) for discarding retransmission of a TB with a different TB size (TBS) than an initial transmission of the TB. The wireless device may receive (an initial transmission of) a first TB with a first TBS. The wireless device may receive a retransmission of the first TB with a second TBS, wherein the first TBS is different than the second TBS. In response to the second TBS being different than the first TBS and the second parameter indicating the Option2-based capability, the wireless device may discard the retransmission of the first TB.

The wireless device may receive the one or more configuration parameters (e.g., the first message) comprising the first parameter indicating a retransmission of a transport block (TB) with a different TB size (TBS) than an initial transmission of the TB is a new transmission. The wireless device may receive (an initial transmission of) a first TB with a first TBS. The wireless device may receive a retransmission of the first TB with a second TBS, wherein the first TBS is different than the second TBS. The wireless device may decode the retransmission of the first TB as a new transmission in response to the first parameter indicating the retransmission of the TB with the different TBS than the initial transmission of the TB is the new transmission and/or the second parameter not indicating the wireless device has a capability (e.g., the Option1-based Capability) for retransmission of a TB with a different TB size (TBS) than an initial transmission of the TB.

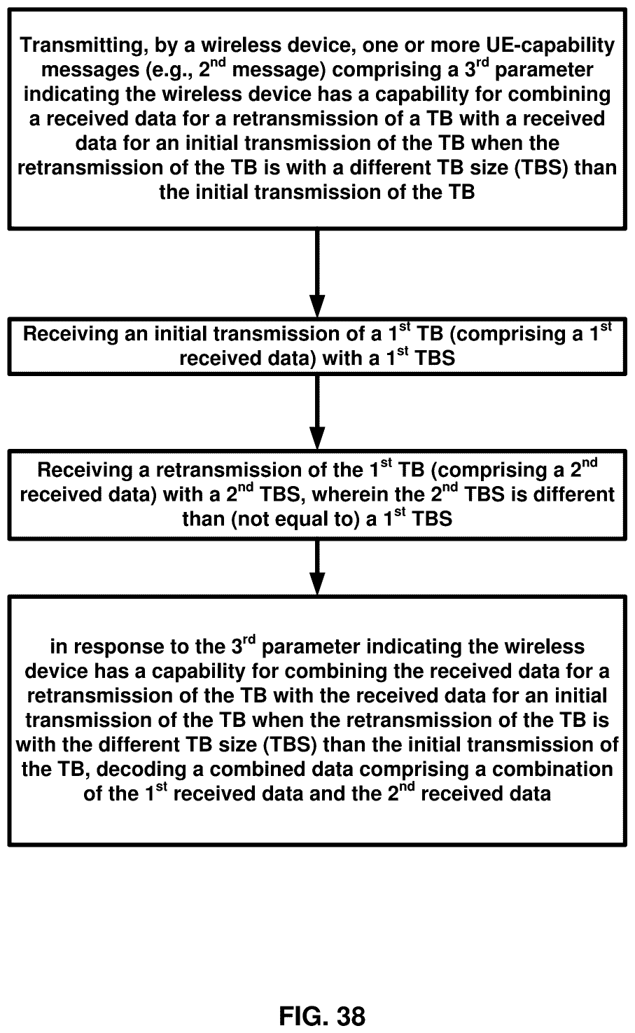

FIG. 38 illustrates an example flowchart of a retransmission procedure as per an aspect of an embodiment of the present disclosure. The wireless device may transmit the one or more UE-capability messages (e.g., the second message) comprising the third parameter indicating the wireless device has a capability (e.g., the fifteenth capability) for combining a received data for a retransmission of a TB with a received data for an initial transmission of the TB when the retransmission of the TB is with a different TB size (TBS) than the initial transmission of the TB. The wireless device may receive the initial transmission of the first TB (comprising the first received data) with the first TBS. The wireless device may receive the retransmission of the first TB (comprising the second received data) with the second TBS, wherein the second TBS is different than (not equal to) the first TBS. In response to the third parameter, decoding a combined data comprising a combination of the first received data and the second received data.

The wireless device may transmit the one or more UE-capability messages (e.g., the second message) comprising the third parameter indicating the wireless device has a capability (e.g., the fifteenth capability) for combining a received data for a retransmission of a TB with a received data for an initial transmission of the TB when the retransmission of the TB is with a different TB size (TBS) than the initial transmission of the TB. The wireless device may receive the initial transmission of the first TB (comprising the first received data) with the first TBS. The wireless device may receive the retransmission of the first TB (comprising the second received data) with the second TBS. In response to the second TBS being different than (not equal to) the first TBS and based on the third parameter, decoding a combined data comprising a combination of the first received data and the second received data.

The wireless device may transmit the one or more UE-capability messages (e.g., the second message) comprising the third parameter indicating the wireless device has a capability (e.g., the fifteenth capability) for combining a received data for a retransmission of a TB with a received data for an initial transmission of the TB when the retransmission of the TB is with a different TB size (TBS) than the initial transmission of the TB. The wireless device may receive the initial transmission of the first TB (comprising the first received data) with the first TBS. The wireless device may receive the retransmission of the first TB (comprising the second received data) with the second TBS, wherein the second TBS is different than (not equal to) the first TBS. In response to the third parameter, combining the first received data and the second received data for decoding the first TB.

The wireless device may transmit the one or more UE-capability messages (e.g., the second message) comprising the third parameter indicating the wireless device has a capability (e.g., the fifteenth capability) for combining a received data for a retransmission of a TB with a received data for an initial transmission of the TB when the retransmission of the TB is with a different TB size (TBS) than the initial transmission of the TB. The wireless device may receive the initial transmission of the first TB (comprising the first received data) with the first TBS. The wireless device may receive the retransmission of the first TB (comprising the second received data) with the second TBS. In response to the second TBS being different than (not equal to) the first TBS and based on the third parameter, combining the first received data and the second received data for decoding the first TB.

The wireless device may transmit the one or more UE-capability messages (e.g., the second message). The wireless device may receive the initial transmission of the first TB (comprising the first received data) with the first TBS. The wireless device may receive the retransmission of the first TB (comprising the second received data) with the second TBS. In response to the second TBS being different than (not equal to) the first TBS and based on second message not indicating the wireless device has a capability (e.g., the fifteenth capability) for combining a received data for a retransmission of a TB with a received data for an initial transmission of the TB when the retransmission of the TB is with a different TB size (TBS) than the initial transmission of the TB, not combining the first received data and the second received data for decoding the retransmission of the first TB.

The wireless device may transmit the one or more UE-capability messages (e.g., the second message) comprising the third parameter indicating the wireless device has a capability (e.g., the fifteenth capability) for handing (e.g., decoding/receiving) a retransmission of a TB with a different TB size (TBS) than the initial transmission of the TB and a maximum TBS difference value corresponding to the retransmission of the TB and the initial transmission of the TB. The wireless device may receive the initial transmission of the first TB (comprising the first received data) with the first TBS. The wireless device may receive the retransmission of the first TB (comprising the second received data) with the second TBS, wherein the second TBS is different than (not equal to) the first TBS. In response to a difference between the first TBS and the second TBS being lower/smaller than the maximum TBS difference value, decoding a combined data comprising a combination of the first received data and the second received data.

The wireless device may transmit the one or more UE-capability messages (e.g., the second message) indicating a capability (e.g., the fifteenth capability) for handing (e.g., decoding/receiving) a retransmission of a TB with a different TB size (TBS) than the initial transmission of the TB and a maximum TBS difference value corresponding to the retransmission of the TB and the initial transmission of the TB. The wireless device may receive the initial transmission of the first TB (comprising the first received data) with the first TBS. The wireless device may receive the retransmission of the first TB (comprising the second received data) with the second TBS. In response to the second TBS being different than (not equal to) the first TBS, decoding a combined data comprising a combination of the first received data and the second received data based on a difference between the first TBS and the second TBS being lower/smaller than the maximum TBS difference value.

The wireless device may transmit the one or more UE-capability messages (e.g., the second message) indicating a capability (e.g., the fifteenth capability) for handing (e.g., decoding/receiving) a retransmission of a TB with a different TB size (TBS) than the initial transmission of the TB and a maximum TBS difference value corresponding to the retransmission of the TB and the initial transmission of the TB. The wireless device may receive the initial transmission of the first TB (comprising the first received data) with the first TBS. The wireless device may receive the retransmission of the first TB (comprising the second received data) with the second TBS, wherein the second TBS is different than (not equal to) the first TBS. In response to a difference between the first TBS and the second TBS being lower/smaller than the maximum TBS difference value, combining the first received data and the second received data for decoding the first TB.

The wireless device may transmit the one or more UE-capability messages (e.g., the second message) indicating a capability (e.g., the fifteenth capability) for handing (e.g., decoding/receiving) a retransmission of a TB with a different TB size (TBS) than the initial transmission of the TB and a maximum TBS difference value corresponding to the retransmission of the TB and the initial transmission of the TB. The wireless device may receive the initial transmission of the first TB (comprising the first received data) with the first TBS. The wireless device may receive the initial transmission of the first TB (comprising the first received data) with the first TBS. The wireless device may receive the retransmission of the first TB (comprising the second received data) with the second TBS. In response to a difference between the first TBS and the second TBS being lower/smaller than the maximum TBS difference value, combining the first received data and the second received data for decoding the first TB.

The wireless device may transmit the one or more UE-capability messages (e.g., the second message) indicating a capability (e.g., the fifteenth capability) for handing (e.g., decoding/receiving) a retransmission of a TB with a different TB size (TBS) than the initial transmission of the TB and a maximum TBS difference value corresponding to the retransmission of the TB and the initial transmission of the TB. The wireless device may receive the initial transmission of the first TB (comprising the first received data) with the first TBS. The wireless device may receive the initial transmission of the first TB (comprising the first received data) with the first TBS. The wireless device may receive the retransmission of the first TB (comprising the second received data) with the second TBS. In response to a difference between the first TBS and the second TBS being greater/larger (not smaller) than the maximum TBS difference value, not combining the first received data and the second received data for decoding the first TB.

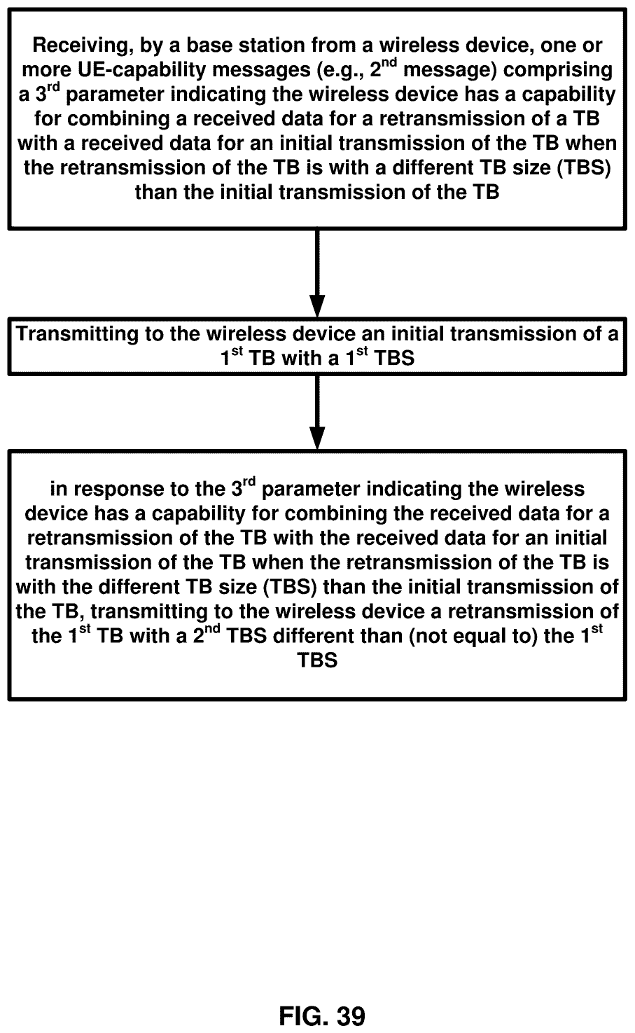

FIG. 39 illustrates an example flowchart of a retransmission procedure as per an aspect of an embodiment of the present disclosure. The base station receives, from the wireless device, the one or more UE-capability messages (e.g., the second message) comprising the third parameter indicating the wireless device has a capability for combining a received data for a retransmission of a TB with a received data for an initial transmission of the TB when the retransmission of the TB is with a different TB size (TBS) than the initial transmission of the TB. The base station may transmit to the wireless device an initial transmission of the first TB with the first TBS. In response to the third parameter indicating the wireless device has a capability for combining the received data for a retransmission of the TB with the received data for an initial transmission of the TB when the retransmission of the TB is with the different TB size (TBS) than the initial transmission of the TB, transmitting to the wireless device a retransmission of the first TB with the second TBS different than (not equal to) the first TBS.

The base station receives, from the wireless device, the one or more UE-capability messages (e.g., the second message). The base station may transmit to the wireless device an initial transmission of the first TB with the first TBS. In response to one or more UE-capability messages not indicating the wireless device has a capability for combining the received data for a retransmission of the TB with the received data for an initial transmission of the TB when the retransmission of the TB is with the different TB size (TBS) than the initial transmission of the TB (e.g., the third message not comprising the third parameter), transmitting to the wireless device a retransmission of the first TB with the second TBS equal to the first TBS.

The base station receives, from the wireless device, the one or more UE-capability messages (e.g., the second message). The base station may transmit to the wireless device an initial transmission of the first TB with the first TBS. In response to one or more UE-capability messages not indicating the wireless device has a capability for combining the received data for a retransmission of the TB with the received data for an initial transmission of the TB when the retransmission of the TB is with the different TB size (TBS) than the initial transmission of the TB (e.g., the third message not comprising the third parameter), not transmitting to the wireless device a retransmission of the first TB with the second TBS not equal to the first TBS.

The base station receives, from the wireless device, the one or more UE-capability messages (e.g., the second message) comprising the third parameter indicating the wireless device has a capability (e.g., the fifteenth capability) for handing (e.g., decoding/receiving) a retransmission of a TB with a different TB size (TBS) than the initial transmission of the TB and a maximum TBS difference value corresponding to the retransmission of the TB and the initial transmission of the TB. The base station may transmit to the wireless device an initial transmission of the first TB with the first TBS. based on the third parameter and the maximum TBS difference value corresponding to the retransmission of the TB and the initial transmission of the TB, transmitting to the wireless device a retransmission of the first TB with the second TBS, wherein a difference between the second TBS and the first TBS is at most the maximum TBS difference value.

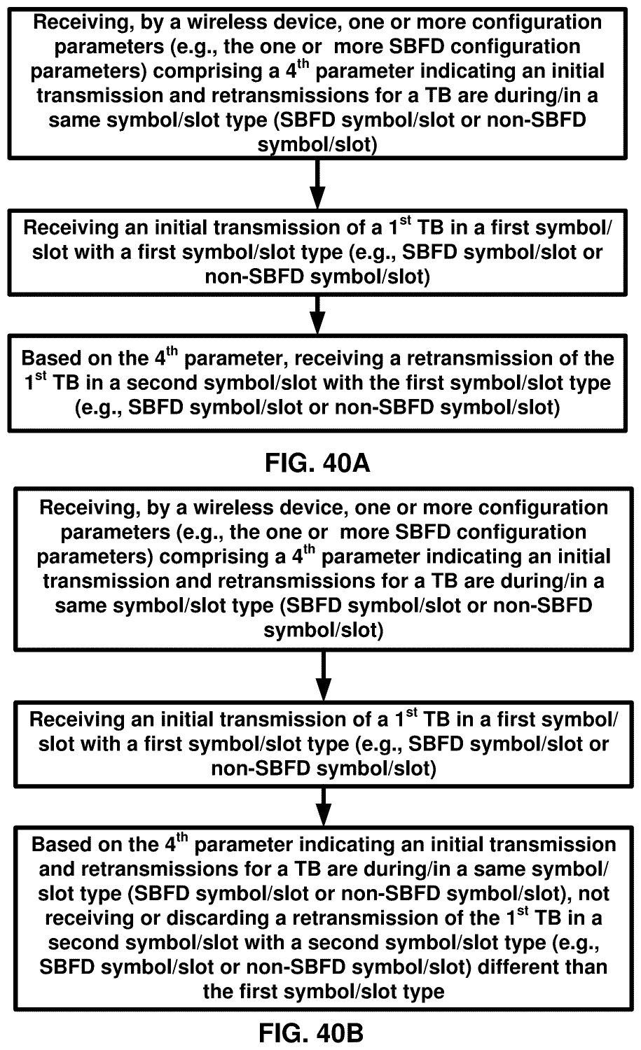

FIG. 40A illustrates an example flowchart of a retransmission procedure as per an aspect of an embodiment of the present disclosure. The wireless device may receive the one or more configuration parameters comprising the fourth parameter indicating an initial transmission and retransmissions for a TB are during/in a same symbol/slot type (a SBFD symbol/slot or a non-SBFD symbol/slot). The wireless device may receive an initial transmission of the TB in a first symbol/slot with a first symbol/slot type (e.g., the SBFD symbol/slot or the non-SBFD symbol/slot). Based on the fourth parameter, the wireless device may receive a retransmission of the first TB in a second symbol/slot with the first symbol/slot type (e.g., the SBFD symbol/slot or the non-SBFD symbol/slot).

The wireless device may receive the one or more configuration parameters comprising the fourth parameter indicating an initial transmission and retransmissions for a TB are during/in a same symbol/slot type (a SBFD symbol/slot or a non-SBFD symbol/slot). The wireless device may receive an initial transmission of the TB in a first non-SBFD symbol/slot. Based on the fourth parameter, the wireless device may receive a retransmission of the first TB in a second non-SBFD symbol/slot.

The wireless device may receive the one or more configuration parameters comprising the fourth parameter indicating an initial transmission and retransmissions for a TB are during/in a same symbol/slot type (a SBFD symbol/slot or a non-SBFD symbol/slot). The wireless device may receive an initial transmission of the TB in a first SBFD symbol/slot. Based on the fourth parameter, the wireless device may receive a retransmission of the first TB in a second SBFD symbol/slot.

The wireless device may receive the one or more configuration parameters comprising the fourth parameter indicating an initial transmission and retransmissions for a TB are during/in a same symbol/slot type (a SBFD symbol/slot or a non-SBFD symbol/slot). The wireless device may receive an initial transmission of the TB in a first SBFD symbol/slot. Based on the fourth parameter and the first condition being satisfied, the wireless device may receive a retransmission of the first TB in a second SBFD symbol/slot.

The wireless device may receive the one or more configuration parameters comprising the fourth parameter indicating an initial transmission and retransmissions for a TB are during/in a same symbol/slot type (a SBFD symbol/slot or a non-SBFD symbol/slot). The wireless device may receive an initial transmission of the TB in a first SBFD symbol/slot. Based on the fourth parameter and the first condition not being satisfied, the wireless device may receive a retransmission of the first TB in a second SBFD symbol/slot.

The base station may transmit to the wireless device the one or more configuration parameters comprising the fourth parameter indicating an initial transmission and retransmissions for a TB are during/in a same symbol/slot type (a SBFD symbol/slot or a non-SBFD symbol/slot). The base station may transmit to the wireless device an initial transmission of the TB in a first symbol/slot with a first symbol/slot type (e.g., the SBFD symbol/slot or the non-SBFD symbol/slot). Based on the fourth parameter, the base station may transmit to the wireless device a retransmission of the first TB in a second symbol/slot with the first symbol/slot type (e.g., the SBFD symbol/slot or the non-SBFD symbol/slot).

The base station may transmit to the wireless device the one or more configuration parameters comprising the fourth parameter indicating an initial transmission and retransmissions for a TB are during/in a same symbol/slot type (a SBFD symbol/slot or a non-SBFD symbol/slot). The base station may transmit to the wireless device an initial transmission of the TB in a first SBFD symbol/slot. Based on the fourth parameter, the base station may transmit to the wireless device a retransmission of the first TB in a second SBFD symbol/slot.

The base station may transmit to the wireless device the one or more configuration parameters comprising the fourth parameter indicating an initial transmission and retransmissions for a TB are during/in a same symbol/slot type (a SBFD symbol/slot or a non-SBFD symbol/slot). The base station may transmit to the wireless device an initial transmission of the TB in a first SBFD symbol/slot. Based on the fourth parameter, the base station may avoid transmitting to the wireless device a retransmission of the first TB in a first non-SBFD symbol/slot.

The base station may transmit to the wireless device the one or more configuration parameters comprising the fourth parameter indicating an initial transmission and retransmissions for a TB are during/in a same symbol/slot type (a SBFD symbol/slot or a non-SBFD symbol/slot). The base station may transmit to the wireless device an initial transmission of the TB in a first non-SBFD symbol/slot. Based on the fourth parameter, the base station may transmit to the wireless device a retransmission of the first TB in a second non-SBFD symbol/slot.

The base station may transmit to the wireless device the one or more configuration parameters comprising the fourth parameter indicating an initial transmission and retransmissions for a TB are during/in a same symbol/slot type (a SBFD symbol/slot or a non-SBFD symbol/slot). The base station may transmit to the wireless device an initial transmission of the TB in a first non-SBFD symbol/slot. Based on the fourth parameter, the base station may avoid transmitting to the wireless device a retransmission of the first TB in a first SBFD symbol/slot.

The base station may transmit to the wireless device the one or more configuration parameters. The base station may transmit to the wireless device an initial transmission of the TB in a first symbol/slot with a first symbol/slot type (e.g., the SBFD symbol/slot or the non-SBFD symbol/slot). Based on the one or more configuration parameters not indicating an initial transmission and retransmissions for a TB are during/in a same symbol/slot type (a SBFD symbol/slot or a non-SBFD symbol/slot), the base station may transmit to the wireless device a retransmission of the first TB in a second symbol/slot with a second symbol/slot type (e.g., the SBFD symbol/slot or the non-SBFD symbol/slot) different than the first symbol/slot type.

The base station may transmit to the wireless device the one or more configuration parameters. The base station may transmit to the wireless device an initial transmission of the TB in a first SBFD symbol/slot. Based on the one or more configuration parameters not indicating an initial transmission and retransmissions for a TB are during/in a same symbol/slot type (a SBFD symbol/slot or a non-SBFD symbol/slot), the base station may transmit to the wireless device a retransmission of the first TB in a first non-SBFD symbol/slot different than the first symbol/slot type.

The base station may transmit to the wireless device the one or more configuration parameters. The base station may transmit to the wireless device an initial transmission of the TB in a first non-SBFD symbol/slot. Based on the one or more configuration parameters not indicating an initial transmission and retransmissions for a TB are during/in a same symbol/slot type (a SBFD symbol/slot or a non-SBFD symbol/slot), the base station may transmit to the wireless device a retransmission of the first TB in a first SBFD symbol/slot different than the first symbol/slot type.

FIG. 40B illustrates an example flowchart of a retransmission procedure as per an aspect of an embodiment of the present disclosure. The wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first symbol/slot with a first symbol/slot type (e.g., the SBFD symbol/slot or the non-SBFD symbol/slot). Based on the parameter indicating an initial transmission and retransmissions for a TB are during/in a same symbol/slot type (SBFD symbol/slot or non-SBFD symbol/slot), the wireless device may not receive or discard/drop a retransmission of the first TB in a second symbol/slot with a second symbol/slot type (e.g., the SBFD symbol/slot or the non-SBFD symbol/slot) different than the first symbol/slot type.

The wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first SBFD symbol/slot. Based on the parameter indicating an initial transmission and retransmissions for a TB are during/in a same symbol/slot type (SBFD symbol/slot or non-SBFD symbol/slot), the wireless device may not receive or discard/drop a retransmission of the first TB in a first non-SBFD symbol/slot.

The wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first SBFD symbol/slot. Based on the parameter indicating an initial transmission and retransmissions for a TB are during/in a same symbol/slot type (SBFD symbol/slot or non-SBFD symbol/slot) and/or the first condition not being satisfied (e.g., corresponding to the initial transmission of the first TB in/during the first SBFD symbol/slot), the wireless device may not receive or discard/drop a retransmission of the first TB in a first non-SBFD symbol/slot.

The wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first SBFD symbol/slot. Based on the parameter indicating an initial transmission and retransmissions for a TB are during/in a same symbol/slot type (SBFD symbol/slot or non-SBFD symbol/slot) and/or the first condition being satisfied (e.g., corresponding to the initial transmission of the first TB in/during the first SBFD symbol/slot), the wireless device may not receive or discard/drop a retransmission of the first TB in a first non-SBFD symbol/slot.

The wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first non-SBFD symbol/slot. Based on the parameter indicating an initial transmission and retransmissions for a TB are during/in a same symbol/slot type (SBFD symbol/slot or non-SBFD symbol/slot), the wireless device may not receive or discard/drop a retransmission of the first TB in a first SBFD symbol/slot.

The wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first non-SBFD symbol/slot. Based on the parameter indicating an initial transmission and retransmissions for a TB are during/in a same symbol/slot type (SBFD symbol/slot or non-SBFD symbol/slot) and/or the first condition not being satisfied (e.g., corresponding to a retransmission of the first TB in/during a first SBFD symbol/slot), the wireless device may not receive or discard/drop the retransmission of the first TB in the first SBFD symbol/slot.

The wireless device may receive the one or more configuration parameters (e.g., the one or more SBFD configuration parameters) comprising the fourth parameter indicating an initial transmission and retransmissions for a TB are during/in a same symbol/slot type (SBFD symbol/slot or non-SBFD symbol/slot). The wireless device may receive an initial transmission of the TB in a first non-SBFD symbol/slot. Based on the parameter indicating an initial transmission and retransmissions for a TB are during/in a same symbol/slot type (SBFD symbol/slot or non-SBFD symbol/slot) and/or the first condition being satisfied (e.g., corresponding to a retransmission of the first TB in/during a first SBFD symbol/slot), the wireless device may not receive or discard/drop the retransmission of the first TB in the first SBFD symbol/slot.

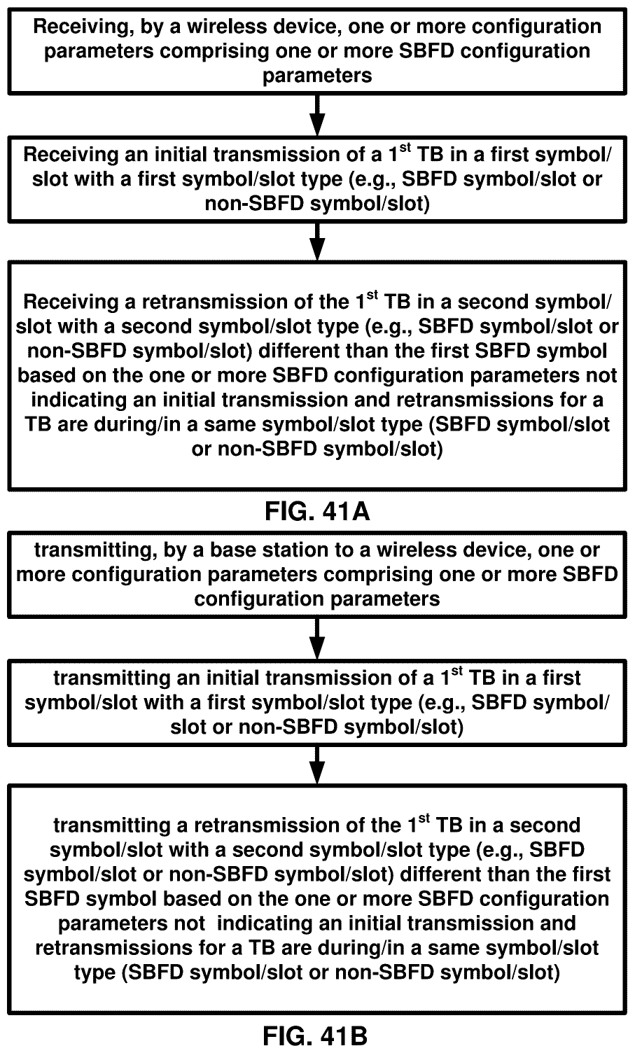

FIG. 41A illustrates an example flowchart of a retransmission procedure as per an aspect of an embodiment of the present disclosure. The wireless device may receive the one or more configuration parameters (e.g., the one or more SBFD configuration parameters). the wireless device may receive an initial transmission of the first TB in/during a first symbol/slot with a first symbol/slot type (e.g., an SBFD symbol/slot or a non-SBFD symbol/slot). The wireless device may receive a retransmission of the first TB in a second symbol/slot with a second symbol/slot type (e.g., the SBFD symbol/slot or the non-SBFD symbol/slot) different than the first SBFD symbol based on the one or more configuration parameters not indicating an initial transmission and retransmissions for a TB are during/in a same symbol/slot type (the SBFD symbol/slot or the non-SBFD symbol/slot).

The wireless device may receive the one or more configuration parameters (e.g., the one or more SBFD configuration parameters). the wireless device may receive an initial transmission of the first TB in/during a first symbol/slot with a first symbol/slot type (e.g., an SBFD symbol/slot or a non-SBFD symbol/slot). The wireless device may receive a retransmission of the first TB in a second symbol/slot with a second symbol/slot type (e.g., the SBFD symbol/slot or the non-SBFD symbol/slot) different than the first SBFD symbol based on the one or more configuration parameters not indicating an initial transmission and retransmissions for a TB are during/in a same symbol/slot type (the SBFD symbol/slot or the non-SBFD symbol/slot) and/or the first condition not being satisfied.

The wireless device may receive the one or more configuration parameters (e.g., the one or more SBFD configuration parameters). the wireless device may receive an initial transmission of the first TB in/during a first symbol/slot with a first symbol/slot type (e.g., an SBFD symbol/slot or a non-SBFD symbol/slot). The wireless device may receive a retransmission of the first TB in a second symbol/slot with a second symbol/slot type (e.g., the SBFD symbol/slot or the non-SBFD symbol/slot) different than the first SBFD symbol based on the one or more configuration parameters not indicating an initial transmission and retransmissions for a TB are during/in a same symbol/slot type (the SBFD symbol/slot or the non-SBFD symbol/slot) and/or the first condition being satisfied.

The wireless device may receive the one or more configuration parameters (e.g., the one or more SBFD configuration parameters). the wireless device may receive an initial transmission of the first TB in/during a first SBFD symbol/slot. The wireless device may receive a retransmission of the first TB in a second non-SBFD symbol/slot based on the one or more configuration parameters not indicating an initial transmission and retransmissions for a TB are during/in a same symbol/slot type (the SBFD symbol/slot or the non-SBFD symbol/slot).

The wireless device may receive the one or more configuration parameters (e.g., the one or more SBFD configuration parameters). the wireless device may receive an initial transmission of the first TB in/during a first non-SBFD symbol/slot. The wireless device may receive a retransmission of the first TB in a second SBFD symbol/slot based on the one or more configuration parameters not indicating an initial transmission and retransmissions for a TB are during/in a same symbol/slot type (the SBFD symbol/slot or the non-SBFD symbol/slot).

FIG. 41B illustrates an example flowchart of a retransmission procedure as per an aspect of an embodiment of the present disclosure. A base station may transmit to a wireless device the one or more configuration parameters (e.g., comprising the one or more SBFD configuration parameters). The base station may transmit to the wireless device an initial transmission of the first TB in a first symbol/slot with a first symbol/slot type (e.g., SBFD symbol/slot or non-SBFD symbol/slot). The base station may transmit to the wireless device a retransmission of the first TB in a second symbol/slot with a second symbol/slot type (e.g., SBFD symbol/slot or non-SBFD symbol/slot) different than the first SBFD symbol based on the one or more SBFD configuration parameters not indicating an initial transmission and retransmissions for a TB are during/in a same symbol/slot type (SBFD symbol/slot or non-SBFD symbol/slot).

A base station may transmit to a wireless device the one or more configuration parameters (e.g., comprising the one or more SBFD configuration parameters). The base station may transmit to the wireless device an initial transmission of the first TB in a first SBFD symbol/slot. The base station may transmit to the wireless device a retransmission of the first TB in a second non-SBFD symbol/slot based on the one or more SBFD configuration parameters not indicating an initial transmission and retransmissions for a TB are during/in a same symbol/slot type (SBFD symbol/slot or non-SBFD symbol/slot).

A base station may transmit to a wireless device the one or more configuration parameters (e.g., comprising the one or more SBFD configuration parameters). The base station may transmit to the wireless device an initial transmission of the first TB in a first non-SBFD symbol/slot. The base station may transmit to the wireless device a retransmission of the first TB in a second SBFD symbol/slot based on the one or more SBFD configuration parameters not indicating an initial transmission and retransmissions for a TB are during/in a same symbol/slot type (SBFD symbol/slot or non-SBFD symbol/slot).

Some embodiments of the present disclosure may improve alignment between the wireless device and/or the base station and/or improve spectral efficiency (e.g., reduce UL/DL resource waste), e.g., for transmitting data to the wireless device as the wireless device may avoid discarding the retransmission of the first TB with the TBS 2≠TBS 1 when the first message comprises the first parameter. According to some embodiments of the present disclosure, instead of leaving handing (e.g., choosing Option 1 or Option 2) of the retransmission of the first TB with the TBS 2≠TBS 1 up to the UE implementation, the wireless device handles the retransmission of the first TB with the TBS 2≠TBS 1 based on whether the message 1 comprise/indicate the first parameter or not.

Some embodiments of the present disclosure may improve alignment between the wireless device and/or the base station and/or improve spectral efficiency (e.g., reduce UL/DL resource waste). For example, the wireless device may report its capability (e.g., the Option2-based Capability or Option1-based Capability) for handling (receiving or discarding) retransmission(s) of a TB with different TBS than the initial transmission of the TB. This allows the base station to determine whether to transmit a retransmission of the TB with different TBS or not.

Some embodiments may improve spectral efficiency/reliability of SBFD operations. For example, the base station may restrict retransmissions/initial transmissions of TBs during a same slot/symbol type (e.g., an SBFD symbol/slot or non-SBFD symbol/slot). This reduces a possibility of discarding retransmissions of the TB at the wireless device (e.g., when the first condition is not satisfied).

What is claimed is:

1. A method comprising:
receiving, by a wireless device, one or more configuration parameters comprising a parameter indicating that a retransmission of a transport block (TB) with a different TB size (TBS) than an initial transmission of the TB are new transmissions;
receiving a first TB with a first TBS; and
receiving a retransmission of the first TB with a second TBS based on:
combining the first TB with the retransmission of the first TB in response to the first TBS being the same as the second TBS; or
decoding the retransmission of the first TB as a new transmission in response to the first TBS being different from the second TBS.

2. The method of claim 1, further comprising transmitting a user equipment (UE)-capability message indicating whether the wireless device considers the retransmission of the TB with the different TBS than the initial transmission of the TB is the new transmission.

3. The method of claim 2, wherein the UE-capability message indicates the wireless device does not discard the retransmission of the TB with the different TBS than the initial transmission of the TB.

4. The method of claim 1, wherein decoding the retransmission of the first TB as the new transmission comprises not combining the first TB with the first TBS and the retransmission of the first TB with the second TBS.

5. The method of claim 1, wherein:
combining the first TB with the retransmission of the first TB comprises not flushing a soft buffer corresponding to the first TB; or
decoding the retransmission of the first TB as the new transmission comprises flushing the soft buffer corresponding to the first TB.

6. The method of claim 5, wherein the decoding the retransmission of the first TB as the new transmission further comprises storing the retransmission of the first TB with the second TBS in the soft buffer corresponding to the first TB.

7. The method of claim 1, wherein the retransmission of the first TB corresponds to a hybrid automatic repeat request (HARQ) process that is used for the receiving the first TB with the first TBS.

8. A wireless device comprising:
one or more processors; and
memory storing instructions that, when executed by the one or more processors, cause the wireless device to:
receive one or more configuration parameters comprising a parameter indicating that a retransmission of a transport block (TB) with a different TB size (TBS) than an initial transmission of the TB are new transmissions;
receive a first TB with a first TBS; and
receive a retransmission of the first TB with a second TBS based on:
combining the first TB with the retransmission of the first TB in response to the first TBS being the same as the second TBS; or
decoding the retransmission of the first TB as a new transmission in response to the first TBS being different from the second TBS.

9. The wireless device of claim 8, wherein the instructions further cause the wireless device to transmit a user equipment (UE)-capability message indicating whether the wireless device considers the retransmission of the TB with the different TBS than the initial transmission of the TB is the new transmission.

10. The wireless device of claim 9, wherein the UE-capability message indicates the wireless device does not discard the retransmission of the TB with the different TBS than the initial transmission of the TB.

11. The wireless device of claim 8, wherein decoding the retransmission of the first TB as the new transmission comprises not combining the first TB with the first TBS and the retransmission of the first TB with the second TBS.

12. The wireless device of claim 8, wherein:
combining the first TB with the retransmission of the first TB comprises not flushing a soft buffer corresponding to the first TB; or
decoding the retransmission of the first TB as the new transmission comprises flushing the soft buffer corresponding to the first TB.

13. The wireless device of claim 12, wherein the decoding the retransmission of the first TB as the new transmission further comprises storing the retransmission of the first TB with the second TBS in the soft buffer corresponding to the first TB.

14. The wireless device of claim 8, wherein the retransmission of the first TB corresponds to a hybrid automatic repeat request (HARQ) process that is used for the receiving the first TB with the first TBS.

15. A non-transitory computer-readable medium comprising instructions that, when executed by one or more processors of a wireless device, cause the wireless device to:
receive one or more configuration parameters comprising a parameter indicating that a retransmission of a transport block (TB) with a different TB size (TBS) than an initial transmission of the TB are new transmissions;
receive a first TB with a first TBS; and
receive a retransmission of the first TB with a second TBS based on:
combining the first TB with the retransmission of the first TB in response to the first TBS being the same as the second TBS; or
decoding the retransmission of the first TB as a new transmission in response to the first TBS being different from the second TBS.

16. The non-transitory computer-readable medium of claim 15, wherein the instructions further cause the wireless device to transmit a user equipment (UE)-capability message indicating whether the wireless device considers the retransmission of the TB with the different TBS than the initial transmission of the TB is the new transmission.

17. The non-transitory computer-readable medium of claim 16, wherein the UE-capability message indicates the wireless device does not discard the retransmission of the TB with the different TBS than the initial transmission of the TB.

18. The non-transitory computer-readable medium of claim 15, wherein decoding the retransmission of the first TB as the new transmission comprises not combining the first TB with the first TBS and the retransmission of the first TB with the second TBS.

19. The non-transitory computer-readable medium of claim 15, wherein:
combining the first TB with the retransmission of the first TB comprises not flushing a soft buffer corresponding to the first TB; or
decoding the retransmission of the first TB as the new transmission comprises flushing the soft buffer corresponding to the first TB.

20. The non-transitory computer-readable medium of claim 19, wherein the decoding the retransmission of the first TB as the new transmission further comprises storing the retransmission of the first TB with the second TBS in the soft buffer corresponding to the first TB.
